(19) United States
(12) Patent Application Publication
(10) Pub. No.: US 2024/0368447 A1
(43) Pub. Date: Nov. 7, 2024

(54) REUSABLE ENVIRONMENTALLY FRIENDLY FOOD COOLING TECHNOLOGY

(71) Applicant: The Regents of the University of California, Oakland, CA (US)

(72) Inventors: Gang SUN, Davis, CA (US); Jiahan ZOU, Davis, CA (US); Luxin WANG, Davis, CA (US)

(21) Appl. No.: 18/572,454

(22) PCT Filed: Apr. 21, 2022
(86) PCT No.: PCT/US2022/025713

§ 371 Date: Dec. 20, 2023

Related U.S. Application Data
(60) Provisional application No. 63/222,772, filed on Jul. 16, 2021.

(51) Int. Cl. C09K 5/06; A23L 3/36; C08H 1/06

(52) U.S. Cl. CPC C09K 5/066; A23L 3/363; C08H 1/06

(57) ABSTRACT

The disclosure provides a method for cooling an object using a jelly ice cube, the method includes providing a chilled or frozen jelly ice cube (JIC), which JIC is an optionally cross-linked protein hydrogel; and contacting the object with the JIC.

### CROSS-REFERENCES TO RELATED APPLICATIONS

This application claims priority to U.S. Provisional Patent Application No. 63/222,772, filed Jul. 16, 2021, the contents of which are hereby incorporated by reference in their entirety for all purposes.

### STATEMENT AS TO RIGHTS TO INVENTIONS MADE UNDER FEDERALLY SPONSORED RESEARCH AND DEVELOPMENT

This invention was made with Government support under Grant No. 2020-67017-31275 awarded by the United States Department of Agriculture (USDA). The Government has certain rights in the invention.

### BACKGROUND OF THE DISCLOSURE

Temperature abuse is one of the critical reasons causing deficiencies in food safety and food quality.¹ Perishable food requires strict cooling conditions to prevent the rapid growth of pathogenic organisms.² According to the United States Department of Agriculture (USDA), cold food, cooked or uncooked, should be stored at temperatures below 4.4° C. (40° F.) to avoid food safety “danger zone” (40° F.-140° F.).³ Unfortunately, unexpected temperature abuses frequently occur at retailers' and customers' levels. The temperature abuses accelerate bacteria growth and spoilage of foods, ultimately resulting in increased health concerns and food waste.⁴⁻⁷ Currently, to control temperature, traditional ice in different shapes (chunks, cubes, or slurries) is the most approachable and common cooling media for customers and retailers. The general preference towards ice is due to its affordability, cooling efficiency, and convenience of use. The high cooling efficiency of ice comes from its considerable heat capacity and latent enthalpy. However, the meltwater of ice is drawing concerns over food cross-contamination.

Microbial cross-contamination caused by meltwater has been a serious food safety and quality concern. A small piece of bacterial-contaminated food is enough to cause the contamination of a widespread area through meltwater. There have been some efforts in substituting regular ice with antimicrobial ice cubes.⁸⁻¹¹ Acidic electrolyzed water (AEW) or essential oil has been added to the regular ice as the antimicrobial agent. Antibacterial effects were shown with controlled bacterial levels in the preserved food. However, concerns about the toxicity and impact on food flavors of these chemicals arise. Commercially available icepacks are also widely used and available in the market. However, the thick plastic shell decreases the cooling efficiency and introduces environmental concerns. The non-biodegradable cooling contents in the packs are environmental concerns. Thus, the demand is high for efficient, reusable, and safe coolant substitutes for ice. The present disclosure satisfies this need and offers other advantages as well.

### BRIEF SUMMARY OF THE DISCLOSURE

Provided herein are compositions and methods comprising a type of “jelly ice cube” (JIC) to replace the traditional ice as food coolants. Characteristic features of the JICs include no meltwater, reduced cross-contamination, no hypo-allergy, zero plastic, affordability, recyclability, sustainability, and biodegradability.

In one embodiment, the disclosure provides a method for making a jelly ice cube (JIC), the method comprising:
dissolving a biodegradable polymer in water to produce a homogenous solution;
injecting or pouring the homogenous solution into a mold to generate a shaped gel; and
freezing the shaped gel to make a jelly ice cube (JIC).

In certain aspects, the biodegradable polymer is a plant-based biopolymer or animal-based biopolymer.

In certain aspects, the biopolymer is a protein.

In another embodiment, the disclosure provides a jelly ice cube (JIC), the JIC comprising:
a cross-linked biodegradable polymer; and
wherein the compressive modulus at break (CMB) increases 1.5 to 10 times by crossing-linking the biodegradable polymer compared to the same JIC without cross-linking the biodegradable polymer.

In yet another embodiment, the disclosure provides a method for cooling an object using a jelly ice cube (JIC), the method comprising:
providing a chilled or frozen jelly ice cube (JIC), which JIC comprises a cross-linked biodegradable polymer, wherein the compressive modulus at break (CMB) increases 1.5 to 10 times by crossing-linking the biodegradable polymer compared to the same JIC without cross-linking the biodegradable polymer; and
contacting the object with the JIC.

In certain aspects, the JIC is chilled before contacting the object.

It is appreciated that the biodegradable or biopolymer hydrogel cooling material can in certain embodiments have a shape or a plurality of shapes other than a cube.

These and other aspects, objects and advantages will become more apparent when read with the detailed description and figures which follows.

### BRIEF DESCRIPTION OF THE DRAWINGS

FIG. 1A shows schematic drawings of the cross-contamination caused by ice meltwater: (i) rotten foods in red contaminate the surrounding ice (into orange color); (ii) the contaminated ice melt, and the meltwater contaminates the rest of the food.

FIG. 1B shows a schematic structure, potential using cycles, and characteristics of JICs.

FIG. 2A shows the appearances of hydrogels with 5% (i), 10% (ii), 15% (iii) and 20% (iv) gelatin under room temperature; (v) The SEM image of freeze-dried 10% JICs.

FIG. 2B shows static compressive stresses and strains at the break of hydrogels with different gelatin concentrations.

FIG. 2C shows the latent heat of prepared hydrogels with various gelatin concentrations. Data are expressed as mean±SD of at least three replicates. Means with different letters on the bars differ significantly at the p≤0.05 level.

FIG. 3A shows appearances of gelatin hydrogel JICs under ambient conditions (C0, no FT treatments; C1, after one FTC; C5, after five FTCs) and frozen status.

FIG. 3B shows a representative DSC curve of regular ice, JIC at FTC0 and FTC 5.

FIG. 3C shows a representative TGA curve (JIC-FTC0) and its first derivative.

FIG. 3D shows a change of latent heat of the fusion of JICs after up to five FTCs. The dashed line with a star mark is the fusion heat of regular ice.

FIG. 3E shows a change of total water content and freezable water content in JICs after FT treatments.

FIG. 3F The inner cavities caused by FT treatments (photo by Dino-Lite microscope).

FIGS. 3G-I show a static compressive stress at the break (FIG. 3G) and strain (FIG. 3H) of prepared JICs after up to five FTCs. (FIG. 31) The SEM image of freeze-dried JIC specimens, with a scale bar of 100 μm. Data are expressed as mean±SD of at least three replicates. Means with different letters on the bars differ significantly at the p≤0.05 level.

FIG. 4A shows a schematic drawing of a prepared cooling efficiency test device: (i) cooling a large PVA hydrogel cube with a large piece ice cube or JIC; (ii) cooling an irregular shape of fruit using large or small size JICs. FIG. 4B show photos of using ice cubes (i and iii) or JICs (ii and iv) to chill a large PVA hydrogel cube: the beginning (i, ice cube at −20° C.; iii, JIC at −20° C.) and the end (ii, ice cube melted; iv, JIC absorbed heat) of the tests. FIG. 4C shows chilling curves of PVA hydrogel cubes cooled by a large ice cube or a large JIC. FIG. 4D shows photos of grapes chilled by small-sized JICs (i) and large-sized JICs (ii). FIG. 4E show chilling curves of grape cooled by various sized JICs. FIG. 4F Water loss of JICs under 20° C., 4° C. and −20° C. FIG. 4G Water loss-rehydrate cycles of JICs (10×10×10 mm) along FTCs. The snow mark represents one FTC, and the blue ribbon represents a 20 min rehydration in 10 mL of DI water at ambient conditions. FIG. 4H The loss of proteins in JIC when immersing and shaking in water. Data are expressed as mean SD of at least three replicates.

FIG. 5A shows schematic drawings of bacterial inoculation and surface washing steps.

FIG. 5B-C shows E. coli and FIG. 5C shows L. innocua and the surface cleaning efficiency with simple water wash or bleach wash concentrations on the surface of JICs after inoculation or after water or bleach wash. Star mark means that the bacterial concentration was below the detection limit of 2.0 log CFU/gel.

FIG. 5D-E shows the compressive properties of JICs after one to five times of bleach wash 35 ppm bleach and FIG. 5E, 50 ppm bleach.

FIG. 5F shows images of JICs before and after 50 ppm bleach wash. Data are expressed as mean±SD of at least three replicates. Means with different letters on the bars differ significantly at the p≤0.05 level.

FIG. 6A shows the normal pressure produced by the food load on top of JICs.

FIG. 6B shows a representative compressive curve of 10% gelatin hydrogel (JIC-FTC0).

FIG. 7 show schematic drawings of the freeze-thaw treatment of JICs.

FIG. 8 shows photos of JICs after five times of 50 ppm bleach wash.

FIG. 9 shows freeze-thaw treatments applied to the JICs to mimic the possible cryogenic and application conditions.

FIG. 10A shows SEM images of the freeze-dried JICs, with a white scale bar of 500 μm and a yellow scale bar of 100 μm.

FIG. 10B shows a photo of the cross-section of JICs after F1T1C5. FIG.

FIG. 10C shows a latent heat of the cryogels frozen multiple times under −20° C. while thawed under different conditions. The dashed line with a star mark represents latent heat value if all water contents in JICs serves as free water.

FIG. 10D shows a change of total water content of JICs along FTCs.

FIG. 10E shows a freezable water to total water ratio in the JICs.

FIG. 10F-G show static compressive stress at break FIG. 10F and strain FIG. 10G of the prepared cryogels after up to five FT cycles. Plot data are expressed as means±SD of three replicates.

FIG. 11A shows SEM images of the freeze-dried JICs, with a white scale bar of 500 μm and a yellow scale bar of 100 μm.

FIG. 11B shows a photo of the cross-section of JICs after F2T1C5.

FIG. 11C shows a latent heat of the cryogels frozen multiple times under −78.5° C. while thawed under different conditions. The dashed line with a star mark represents latent heat value if all water content in JICs serves as free water.

FIG. 11D shows a change of total water content of JICs along FTCs.

FIG. 11E shows a freezable water to total water ratio in the JICs.

FIG. 11F-G Static compressive stress at break FIG. 11F and strain FIG. 11G of the prepared cryogels after up to five FT cycles. Plot data are expressed as means±SD of three replicates.

FIG. 12A shows SEM images of the freeze-dried JICs under different treatments (a yellow scale bar of 100 μm).

FIG. 12B shows a photo image of F3T1C5.

FIG. 12C shows a latent heat of the cryogels frozen multiple times under −198° C. while thawed under different conditions. The dashed line with a star mark represents latent heat value if all water content in JICs serves as free water.

FIG. 12D shows a change of total water content of JICs along FTCs.

FIG. 12E shows freezable water to total water ratio in the JICs. Static compressive stress at break FIG. 12F and strain FIG. 12G of the prepared cryogels after up to five FT cycles.

FIG. 13A-B show the cooling curves of JICs in multiple using cycles under F2T2.

FIG. 14A-G shows a schematic drawing on the freeze-thaw effect to the structures of JICs under different FT conditions. FIG. 14A shows 10% gelatin hydrogels under room temperature before FT treatments; JICs frozen under −20° C. FIG. 14B; JICs frozen under −78° C. FIG. 14C; and JICs frozen under −198° C. FIG. 14D; or thawed in refrigerator 14E; thawed at ambient air FIG. 14F; and thawed in ambient water FIG. 14G.

FIG. 15A-D show the static compressive properties of crosslinked JICs. FIG. 15A shows JICs crosslinked with EDC; FIG. 15B dhows JICs crossed-linked to glutaraldehyde; and FIGS. 15C-D show JICs crossed linked with menadione sodium bisulfite (MSB, a water-soluble form of vitamin K derivatives), and Riboflavin 5′-phosphate sodium (flavin mononucleotide, FMN, a water-soluble form of Vitamin B2).

FIG. 16A-F show ROS generation of JICs (10% gelatin—1% MSB) in water under UVA radiation (FIG. 16A, FIG. 16C and FIG. 16E) or cool-white (CW) radiation (FIG. 16B, FIG. 16D and FIG. 16F): hydroxy radical production (FIG. 16A-B), singlet oxygen production (FIG. 16C and FIG. 16D), and hydrogen peroxide production (FIG. 16E and FIG. 16F).

FIG. 17A shows schematic drawings of the assembly and life cycle of Gel/MSB JICs. FIG. 17B shows proposed photoreaction mechanism of MSB.

FIG. 18A shows calculated Gibbs free energy changes (ΔG) of the generation of major tetrapeptide radicals from the hydrogen abstraction reaction by triplet MSB in water. Radicals on MSB and tetrapeptide are highlighted with yellow masking and arrows. FIG. 18B shows SDS-PAGE of gelatin before and after MSB crosslinking. Lane 0, standard; lane 1, gelatin; lane 2, gelatin/MSB before UV irradiation; lane 3, gelatin/MSB after 10 min UVA radiation. FIG. 18C shows the change of relative viscosity of gelatin/MSB solution after various UVA irradiation time. Data are expressed as mean±SD of three replicates.

FIG. 19A shows the appearances of frozen JICs designed into various shapes, with a blue scale bar of 10 mm. FIG. 19B shows the compressive modulus at break (CMB) of fabricated JICs under various crosslinking conditions (UVA at 365 nm or UVB at 312 nm). The orange stars represent the enhanced percentage under each condition. FIGS. 19C-D show the effect of MSB concentration on the equilibrium irradiation time, shown by the change of CMB. The gray dash line is the CMB of untreated 10% gelatin hydrogels. FIG. 19E shows the CMB of 10% gelatin hydrogel with various MSB concentrations before and after irradiation (for their particular crosslinking equilibrium time) and the corresponding percentages of CMB enhancement. FIG. 19F shows the appearances of 10% gelatin irradiated with 0%, 0.05%, 0.10%, 0.50% and 1.00% MSB (top to bottom) under ambient condition with a white scale bar of 5 mm. Data are expressed as mean±SD of three replicates.

FIGS. 20A-I show functional and structural properties of Gel/MSB-JICs and Gel-JICs. FIG. 20A shows the latent heat of fusion of Gel/MSB-JICs and Gel-JICs after application freeze-thaw cycles (AFTCs). FIG. 20B shows the total water content of Gel/MSB-JICs and Gel-JICs after various numbers of AFTCs. FIG. 20C shows the freezable water content of Gel/MSB-JICs and Gel-JICs after various numbers of AFTCs. FIG. 20D shows the cross-section of Gel/MSB-JICs and Gel-JICs after AFTC5 (C5), with a white scale bar of 5 mm. FIG. 20E The SEM image of lyophilized Gel/MSB-JICs before AFTC (C0) and after AFTC9 (C9), with a yellow scale bar of 200 μm. FIG. 20F shows the CMB of Gel/MSB-JICs and Gel-JICs after various numbers of AFTCs. FIG. 20G shows the cooling curves of Gel/MSB-JICs and Gel-JICs after AFTC1 (C1), AFTC5 (C5) and AFTC10 (C10). FIG. 20H shows the amount of MSB diffused from Gel/MSB to water at ambient conditions. (I) The amount of MSB transferred from Gel/MSB to Gel at 22° C. and −4° C. Data are expressed as mean±SD of at least three replicates.

FIG. 21A-K show microbial-resistant function and biodegradability of Gel/MSB-JICs. The detected generation of hydroxyl radical FIG. 21A, hydrogen peroxide (H₂O₂) FIG. 21B, and singlet oxygen (¹O₂) FIG. 21C of Gel/MSB-JICs and Gel-JICs at their first application cycle under D65 irradiation (300-830 nm). The production of hydroxyl radical FIG. 21D, hydrogen peroxide (H₂O₂) in FIG. 21E, singlet oxygen (¹O₂) in FIG. 21F of Gel/MSB-JICs in repeated application cycles (AFTC1 to AFTC10) under D65 irradiation (300-830 nm). FIG. 21G The antibacterial tests again E. coli under D65 irradiation (limit of detection at 2.00 Log₁₀ CFU gel⁻¹). FIG. 21H The antimicrobial function of Gel/MSB-JICs against E. coli in the first (C1) and the 10^{th} application cycle (C10) under irradiation. The antimicrobial function of Gel/MSB-JICs against P. digitatum FIG. 21I and R. Laryngis. FIG. 21J in the first application cycle (C1, B) and the 10^{th} application cycle (C10, C). Gel-JICs were used as control groups in the anti-fungi and anti-yeast assays FIG. 21A. FIG. 21K shows representative photographs of tomato seedlings after 24 days of growing in soil potting mix (Control), with soil potting mix containing 5% Gel-JICs (Gel-JICs), and soil potting mix containing 5% Gel/MSB-JICs (Gel/MSB-JICs), with scale bars of 20 mm. Data are expressed as mean±SD of six replicates with a P-value ≤0.05.

FIG. 22A-D show the life-cycle of the JIC. FIG. 22A is a hydrogel that undergoes physical and chemical cross-linking; FIG. 22B is a useable gel; FIG. 22C shows it is composable and FIG. 22D shows that it can be mixed with soil.

FIG. 23A-B show the UV-vis absorbance spectrum (200-600 nm) of 40 ppm and 3000 ppm MSB in water FIG. 23A, and 10 ppm gelatin (type A) in water FIG. 23B.

FIG. 24A shows a schematic Jablonski diagram describing the photoreaction of MSB after photoexcitation. FIG. 24B shows the possible photo-crosslinking and healing pathways induced by the presence of MSB under appropriate photo-irradiation. FIG. 24C shows the representative chemical structure of gelatin and the selected tetrapeptide (in grey dash frame).

FIG. 25A shows the computed Gibbs energy changes (ΔG) details of the hydrogen abstraction from the representative radical-1 tetrapeptide molecule of gelatin by triplet state MSB. FIG. 25B shows Radical-2; FIG. 25C shows Radical-3.

FIG. 25D shows the computed Gibbs energy changes (ΔG) details of the hydrogen abstraction from the representative radical-4 tetrapeptide molecule of gelatin by triplet state MSB. FIG. 25E shows Radical-5; FIG. 25F shows Radical-6.

FIG. 25G shows the computed Gibbs energy changes (ΔG) details of the hydrogen abstraction from the representative radical-7 tetrapeptide molecule of gelatin by triplet state MSB. FIG. 25H shows Radical-8; FIG. 25I shows Radical-9.

FIG. 26 shows the fabrication and freeze-thaw treatment of Gel or Gel/MSB JICs.

FIG. 27A-B show the cross-section of Gel-JICs after AFTC1 to AFTC10 (FIG. 27A); and FIG. 27B shows Gel/MSB-JICs after AFTC1 to AFTC10.

FIG. 28A-B shows the SEM images of lyophilized Gel-JICs before AFTC (C0) with a scale bar of 100 μm (FIG. 28A), and after AFTC9 (C9) with a scale bar of 200 μm in FIG. 28B.

FIG. 29A-F shows the detected generation of hydroxyl radical (FIG. 29A), hydrogen peroxide (H₂O₂) in FIG. 29B, singlet oxygen (¹O₂) in FIG. 29C of Gel/MSB and Gel at their first application cycle under UVA irradiation (365 nm). The production of hydrogen radical in FIG. 29D, hydrogen peroxide (H₂O₂) in FIG. 29E, singlet oxygen (¹O₂) in FIG. 29F of Gel/MSB in repeated application cycles (AFTC1 to AFTC10) under UVA irradiation (365 nm). Data are expressed as mean±SD with six replicates.

FIG. 30A shows the antibacterial tests again E. coli. Under UVA radiation (365 nm). Data are expressed as mean±SD with six replicates. FIG. 30B shows schematic drawings on the method of anti-fungi assays against P. digitatum and anti-yeast assay against R. Laryngis.

FIG. 31 shows photos of JICs inoculated with P. digitatum at Day 18.

FIG. 32 shows photos of JICs inoculated with R. laryngis at Day 10.

FIG. 33A-C show measurements of plant growth for each of the treatments (n=6) (A) leaf biomass indicated as dry weight (DW); FIG. 33B shows total plant biomass indicated as DW, and FIG. 33C shows specific leaf area (SLA) calculated as the ratio of leaf area to leaf DW. Letters indicate significant differences among treatments calculated by ANOVA and Tukey HSD (P≤0.05).

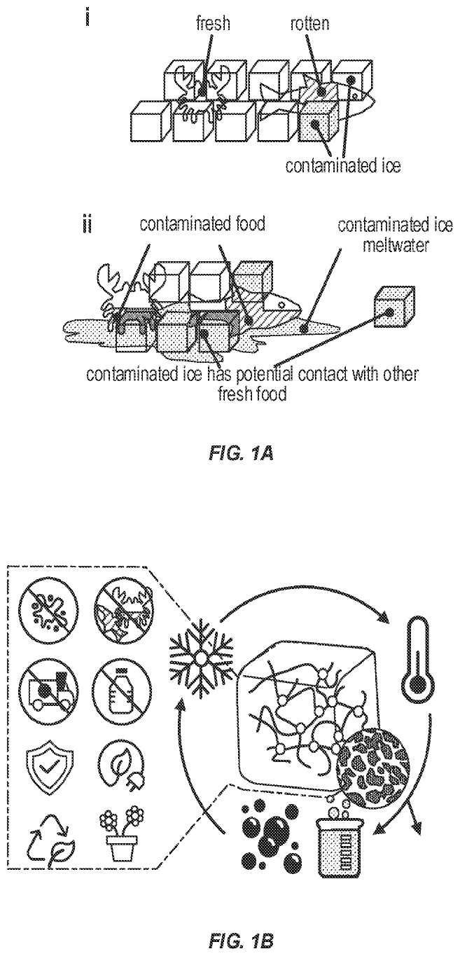

### DETAILED DESCRIPTION

The present disclosure provides a food coolant material or “jelly ice cube” (JIC) based on a biodegradable polymer such as a protein. The JIC diminishes meltwater while still possessing high cooling efficiency of traditional ice. The JICs contain zero-plastic and can prevent meltwater-caused cross-contamination with high affordability, recyclability, sustainability, and biodegradability.

The present disclosure provides a method for making a jelly ice cube (JIC), the method comprising:
dissolving a biodegradable polymer in water to produce a homogenous solution;
injecting or pouring the homogenous solution into a mold to generate a shaped gel; and
freezing the shaped gel to make a jelly ice cube (JIC).

In certain aspects, the biodegradable polymer is a plant-based biopolymer or animal-based biopolymer. For example, the biopolymer can be a plant or animal polysaccharide, protein, biopolymer or combination thereof.

In certain aspects, biopolymer is a member selected from the group consisting of collagen, gelatin, soy protein, whey protein, zein protein, elastin, laminin, fibrin, silk fibroin lysozyme, bovine serum albumin, ovalbumin, alginate, starch, cellulose, modified proteins, carbohydrates, and combinations thereof.

In certain aspects, the biopolymer is gelatin. Gelatin is a product of partial hydrolysis of collagen. During gelatin preparation, collagen is pre-treated under acidic conditions to produce type A gelatin or alkaline conditions to produce type B gelatin. More carboxylic groups are present in type A gelatin than type B gelatin. Either type A or type B is suitable for use in the present disclosure.

The sources of gelatin include bovine skin, bovine hides, cattle, and pork bones, as well as fish and poultry gelatins. Gelatin is a heterogeneous mixture of water-soluble proteins of high average molecular masses, present in collagen. The proteins are extracted by boiling skin, tendons, ligaments, bones, etc. in water.

In certain aspects, the average molecular mass (Da) of the gelatin is about 20,000 to about 100,000 such as 20,000-25,000 (Da), 40,000-50,000 (Da) or 50,000-100,000 (Da). The Bloom number is proportional to MW such as 50-125 (low Bloom) 175-225 (medium Bloom) and 225-325 (high Bloom). These Bloom numbers correspond to 20,000-25,000 (Da), 40,000-50,000 (Da) or 50,000-100,000 (Da), respectively.

Proteins suitable for use in the present disclosure include, for example, natural proteins such as collagen, gelatin, elastin, laminin, fibrin, silk fibroin and globular proteins such as lysozyme, BSA and ovalbumin and combinations of the foregoing. In certain aspects, gelatin is used.

In certain aspects, the biodegradable polymer such as a protein (e.g., gelatin) is at a concentration of about 1% to about 60% w/w such as about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and/or 60% w/w. In certain instances, the biodegradable polymer is made from about 1% to about 30% w/w or about 1% to about 20% w/w. In certain aspects, the biodegradable polymer content is about 8% to about 16% such as 9, 10, 11, 12, 13, 14, 15, 16% w/w.

In certain aspects, the biodegradable polymer is dissolved in water or aqueous mixture to produce a homogenous solution or substantially homogenous solution. The temperature at which the biodegradable polymer (e.g., protein (e.g., gelatin)) is dissolved in water is not particularly limited, but temperatures of room temperature or higher are generally used. Non-limiting dissolution temperatures of 25, 30, 40, 50, 60, 70, 80, 90, 100, 110, 120, 130° C. or higher may be used. In certain aspects, dissolution of the biodegradable polymer can be facilitated with heat. The water or aqueous solution, such as deionized water (DI) or mixed aqueous and organic solvent, can be heated to about 50° C. to about 80° C. or about 65° C. to about 75° C. In certain aspects, the biodegradable polymer is dissolved in water at a temperature between about 10° C. to about 110° C. or between 20° C. to about 70° C.

In certain instance, the biodegradable polymer or biopolymer is “water-swellable” or forms a “hydrogel,” which indicates that the polymer takes on and retains water within a network.

In certain aspects, the biodegradable polymer, which may be a homogenous solution, is injected or poured into a mold to generate a shaped gel. Any suitable shape or geometry is encompassed by the present disclosure (circle, square, rectangle, etc.)

In certain aspects, the shaped gel is thereafter frozen. The shaped gel of the biodegradable polymer undergoes freezing at a temperature between 0° C. to −200° C. such as −5° C., −10° C., −15° C., −20° C., −25° C., −30° C., −35° C., −40° C., −45° C., −50° C., −55° C., −60° C., −65° C., −70° C., −75° C., −80° C., −85° C., −90° C., −95° C., −100° C., −105° C., −110° C., −115° C., −120° C., −125° C., −130° C., −135° C., −140° C., −145° C., −150° C., −155° C., −160° C., −165° C., −170° C., −175° C., −180° C., −185° C., −190° C., −195° C., and/or −200° C. Once ejected from the mold, the JICs can be treated with freeze-thaw treatments to mimic their multiple usage cycles.

In certain aspect, the biodegradable polymer, biopolymer or protein is crosslinked.

In certain aspect, the biopolymer is a protein that forms a protein hydrogel matrix. The biopolymer matrix can be strengthened to reduce the destructive impact of temperature variations and ice crystal formations, by crosslinking the polymer matrix or polymer hydrogel matrix. To make robust JIC systems, the degree of crosslinking is well-controlled to generate stable hydrogels or cryogels.

In certain aspects, the present methods for forming a JIC includes crosslinking of all or a portion of the biopolymer. In various aspects, crosslinking can occur by a chemical agent, radiation crosslinking, physical crosslinking, photo induced cross-linking or combinations thereof.

In certain aspects, the amount of cross-linking of the biopolymer is about 0%, 5%, 10%, 15%, 20%, 25%, 30%, 35%, 40%, 45%, 50%, 55%, 60%, 65%, 70%, 75%, 80%, 85%, 90%, 95%, and/or 100%, based on the total amount of biopolymer.

Various chemical cross-linkers are suitable for the present invention. The cross-linkers can be homobifunctional having two reactive ends that are identical or heterobifunctional having two different reactive ends. Cross-linkers include a chemical cross-linking agent, which is a member selected from the group consisting of menadione sodium bisulfate (MSB), glutaraldehyde (GTA), 1-ethyl-3-(3-dimethylaminopropyl)carbodiimide (EDC), photosensitizers, water soluble vitamin, transglutaminase, genepin, sulfonates, malemide, polyethylene glycol dendrimeric systems, dendritic polymers, hyper-branched dendritic polymers, formaldehyde, enzymatic cross-linker, glycation, glyceraldehydes, cyanamide, diimide, diisocynate, dimethyl adipimidate, carbodiimide and N,N′-carbonyldiimidazole (CDI), N,N′-dicyclohexylcarbonylimide (DCC), N-ethoxycarbonyl-2-ethoxy-1,2-dihydroquinoline (EEDQ), 4-(4,6-dimethoxy-1,3,5-triazine)-4-methylmorpholium (DMT-MM), 2-benzotriazole-1,1,3,3-tetramethyluronium tetrafluoroborate (TBTU), 3,4-dihydro-3-hydroxy-4-oxo-1,2,3-benzotriazine (HODhbt), benzotriazol-1-oxy-tris-pyrrolidone-phosphonium hexafluorophosphate (PyBOP), benzotriazol-1-yl-oxy-tris-dimethylamino-phosphonium hexafluorophosphate (BOP), 1-ethyl-3-(3-dimethylaminopropyl) carbodiimide (EDC), and N-hydroxysuccinimide (NHS).

Other cross-linkers include, transglutaminase, genepin, sulfonates, malemide, polyethylene glycol dendrimeric systems, dendritic polymers, hyper-branched dendritic polymers, formaldehyde, enzymatic cross-linker, glycation, glyceraldehydes, cyanamide, diimide, diisocynate, dimethyl adipimidate, carbodiimide and epoxy.

In addition, other protein cross-linkers include N,N′-carbonyldiimidazole (CDI), N,N′-dicyclohexylcarbonylimide (DCC), N-ethoxycarbonyl-2-ethoxy-1,2-dihydroquinoline (EEDQ), 4-(4,6-dimethoxy-1,3,5-triazine)-4-methylmorpholium (DMT-MM), 2-benzotriazole-1,1,3,3-tetramethyluronium tetrafluoroborate (TBTU), 3,4-dihydro-3-hydroxy-4-oxo-1,2,3-benzotriazine (HODhbt), benzotriazol-1-oxy-tris-pyrrolidone-phosphonium hexafluorophosphate (PyBOP), benzotriazol-1-yl-oxy-tris-dimethylamino-phosphonium hexafluorophosphate (BOP), 1-ethyl-3-(3-dimethylaminopropyl) carbodiimide (EDC), and N-hydroxysuccinimide (NHS).

Examples of radiation cross-linking includes exposing the hydrogel to at least one of visible light radiation, infrared radiation, ultraviolet radiation, electron beam radiation, gamma radiation, or x-ray radiation. An example of physical crosslinking is exposing the hydrogel article to freezing and thawing.

In certain instances, the JIC possesses biocidal functionality. Advantageously, in order to address concerns regarding biological contamination and/or microbial growth of JICs during use, a photosensitizer can be used to provide light-induced antimicrobial functions under store lighting conditions. Biocidal reactive oxygen species (ROS), including hydroxyl radicals, hydrogen peroxide, and singlet oxygen, produced by the JICs containing different amounts of photosensitizer (e.g., MSB) can be used to eliminate microorganisms.

Crosslinking may be carried out after forming the hydrogel structure, after shaping the hydrogel into a desired shape, after in situ formation, or at any other suitable point during processing.

In certain aspects, the biodegradable polymer is cross-linked in two steps, a physically cross-linking and a photoinduced cross-linking. For example, the photo-induced cross-linking agent MSB, on top of physical cross-linking, introduces robust mechanical properties to a JICs that act against the temperature variations and phase changes. Meanwhile, the employment of MSB in the hydrogel provides antimicrobial functions, giving the JICs microbial-resistant properties under daylight.

In certain aspects, the physically cross-linking is performed by one or more freeze-thaw cycles.

In certain aspects, the photoinduced cross-linking occurs by an ultra-violet (UV) radiation of thawed JIC. In certain instances, the photoinduced cross-linking occurs with UV light at 280-400 nm under an inert atmosphere. Inert atmosphere includes nitrogen, argon, helium and other inert gases.

In certain aspects, the cross-linking is performed while the biodegradable polymer is in a frozen state or a thawed state.

The freezing temperature of the hydrogel is not particularly limited, so long as it is suitable to freeze or solidify the biopolymer. For example, temperatures of 0° C. or lower may be suitably employed. In one aspect, a temperature of 0 to −20° C. is employed to freeze the hydrogel. In one aspect, a temperature of −20° C. is used.

Once thawed, it is better to handle JICs with a minimum exposure time of temperatures above 0° C. After each use, freezing temperature, i.e., −20° C., is suitable for storage to retain water content in JICs.

The time of freezing, i.e., time of storage at freezing temperature, is not particularly limited and may range from a few hours or less to 24 hours or more. This range includes all values and subranges therebetween, including 1, 2, 3, 4, 5, 6, 7, 8, 9, 10, 11, 12, 13, 14, 15, 16, 17, 18, 19, 20, 21, 22, 23, and 24 hours. Generally, overnight storage at freezing temperature is suitable, but other times may also be suitable.

After each freeze-thaw cycle, JICs can be effectively rehydrated, cleaned or sanitized with brief water or diluted bleach rinse. The application of JICs can reduce water consumption in the food supply chain and food waste by controlling microbial contaminations.

In a hydrogel, water, as the solvent in the precursor solution systems, associates in different ways with the matrix materials through the sol-gel transformation and forms free water, freezable bound water, and non-freezable bound water.¹²⁻¹⁴ The freezable bound water has a weaker bounding towards the matrix structure through H-bonds compared to the non-freezable bound water. Free water and freezable bound water, undergoing phase change at or slightly below 0° C. in the freeze-thaw cycles, are referred together as freezable water herein. The thermal behavior of hydrogels is important to the feasibility of applying hydrogels as coolants. Around the food coolant functioning temperature range, −20° C. to 4° C., ice formed by freezable water is the principal heat-absorbing composition in hydrogels due to its ultra-high latent heat (334 J/g near 0° C.) and high heat capacity in a broad range. Moreover, the latent heat of free water and freezable bound water in a hydrogel is predominant over the heat absorbed by ice without phase change. The dominating factor in designing JICs is to increase the composition of freezable water composition in the total water content.

Gelatin has been widely used as the matrix material of hydrogels because of its high hydrophilicity. The genetic advantages, including sustainability, biodegradability, and high biocompatibility, made gelatin hydrogels great candidates in biomedical materials and tissue engineering.¹⁵⁻¹⁸ However, no study has been conducted to apply protein-based hydrogels as food cooling media. In the examples described herein, the feasibilities and challenges of applying gelatin-based hydrogels as a new type of food cooling media, JICs, are tested and discussed.

JICs based on 10% gelatin hydrogels achieved 265.35 J/g latent heat of fusion and comparable cooling efficiency with traditional ice. JICs survived the normal pressure equivalent to the food load as tall as 1 m throughout the repeated freeze-thaw cycles.

In certain aspects, the disclosure provides jelly ice cube (JIC) made by the methods disclosed herein.

In another embodiment, the present disclosure provides a jelly ice cube (JIC), the JIC comprising:
a cross-linked biodegradable polymer; and
wherein the compressive modulus at break (CMB) increases 1.5 to 10 times by crossing-linking the biodegradable polymer compared to the same JIC without cross-linking the biodegradable polymer.

In certain aspects, the CMB is calculated according to as equation (S2), where CMB has a unit of kPa, σ is the compressive stress at break in kPa, and ε is the compressive strain at break in %:

$$CMB = σ / ε \times 100 \qquad ( Equation S 2 )$$

In certain aspects, the CMB increases with increased amount cross-linking. The CMB of the cross-lined biodegradable polymer increases by about 1.5, 2, 2.5, 3, 3.5, 4, 4.5, 5, 5.5, 6, 6.5, 7, 7.5, 8, 8.5, 9, 9.5, and/or 10, or 10 or more times compared to the un-crosslinked JIC.

In certain aspects, the degree of crosslinking can be gravimetrically determined according to the methods proposed by Pulat et al. and equation (S3). Biodegradable polymers or biopolymers form hydrogels, which are dried in a vacuum oven at before immersion in water for 72 h extraction. The extracted gels were dried again and tested for the final dried weight, m in mg.

$$Degree of Crosslinking = \frac{m}{{m}_{o}} \times 100 \% \qquad ( Equation S3 )$$

In certain aspects, the degree of cross-linking is between 1% to 100%, such as 5% to 95% or 5% to about 80%, or 10% to about 80%, or 10% to about 70%, or about 20% to 80% or 10% to about 50%, or 30% to 60% or 1% up to about 5%, 10%, 15%, 20%, 25%, 30%, 35%, 40%, 45%, 50%, 55%, 60%, 65%, 70%, 75%, 80%, 85%, 90%, 95%, and/or 100%.

In certain aspects, the molecular weight of the JIC increases 100% to 1000% by crossing-linking the biodegradable polymer compared to the same JIC without cross-linking the biodegradable polymer.

In another embodiment, the present disclosure provides method for cooling an object using a jelly ice cube (JIC), the method comprising:
providing a chilled or frozen jelly ice cube (JIC), which JIC comprises a cross-linked biodegradable polymer, wherein the compressive modulus at break (CMB) increases 1.5 to 10 times by crossing-linking the biodegradable polymer compared to the same JIC without cross-linking the biodegradable polymer; and
contacting the object with the JIC.

In certain aspects, the JIC is chilled before contacting the object.

In certain aspects, the cooling material or JIC is suitable for maintaining temperature-sensitive items, e.g., medicinal or unstable compounds, cell or tissue samples, or other biologically or chemically active substances, at reduced temperatures.

In certain aspects, the phrase “non-meltable” refers to the ability of the hydrogel material to substantially maintain its overall shape, size, and/or mass when heated from a temperature below the freezing point of water to a temperature above the freezing point of water. It is appreciated that at least a portion of the internal water content of the hydrogel material can undergo a phase transition from ice to water as the hydrogel material is thus heated, and that such a phase transition does not impact the “non-meltable” property of the overall hydrogel material.

### EXAMPLES

Example 1 illustrates hydrogels made of varying amounts of protein.

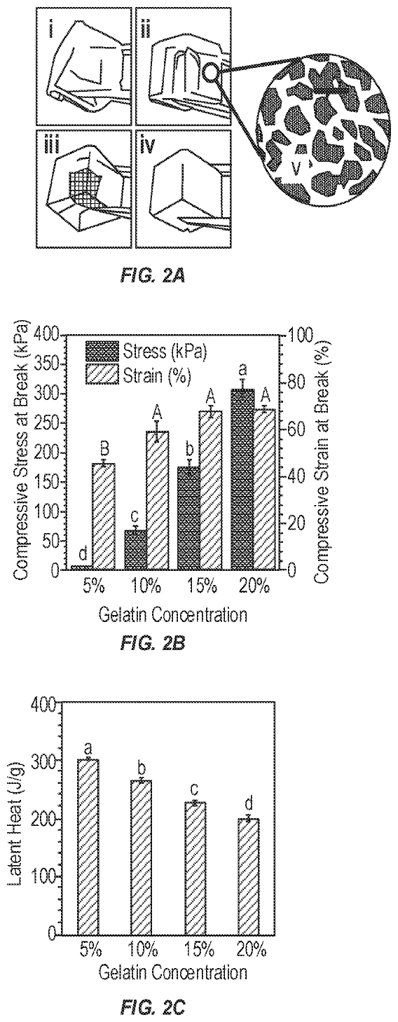

Hydrogels made of 5% (i), 10% (ii), 15% (iii) and 20% (iv) gelatin were prepared and tested, as shown in FIG. 2A. The 5% hydrogel was very soft and easy to be peeled off by sharp edges, whereas the hydrogels with 10%, 15%, and 20% gelatin were less fragile and easier to be released from the silicon mold.

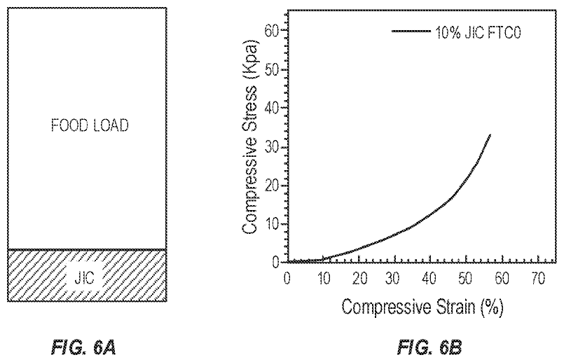

As shown in FIG. 2B and FIG. 6B, 10% gelatin hydrogels demonstrated average compressive stress at the break of 67.95 kPa with a strain of 58.95%, which was higher than the required 10 kPa with allowed space for possible materials degradations during using cycles, making 10% gelatin hydrogels a good base material of JICs. For other examples discussed herein, the hydrogels prepared, tested, and analyzed were JICs based on 10% gelatin hydrogels. FIG. 2C confirms that higher water content ensures higher heat absorbing abilities. The average latent heat of fusion of 10% gelatin hydrogels was 265.4 J/g, 79.3% of the latent heat of regular ice. Although it may require a larger amount of JICs to achieve the equivalent cooling effect of regular ice, with multiple using cycles, the use of JICs can still reduce the overall water usage and significantly increase food safety by reducing cross-contamination caused by ice meltwater.

The gelatin-water ratio JICs was determined. Two important evaluating factors should be considered throughout the feasibility analysis of JICs—freezable water content and mechanical strength. Freezable water content should be as high as possible for promising heat-absorbing ability, which requires high total water content. Meanwhile, the mechanical strength of JICs is contributed by the gelatin matrix structures and should be high enough to bear the pressure from food loads without any plastic shell.

As shown in FIG. 6, if JIC survives a normal pressure of 10 kPa, it will not be crushed by a food load as tall as 1 m. Hence, desired performance of JICs is related to an appropriate gelatin content that provides a compressive strength higher than 10 kPa and the highest water content allowed.

Example 2 illustrates reusability of JICs was evaluated through repeated freeze-thaw (FT) treatments.

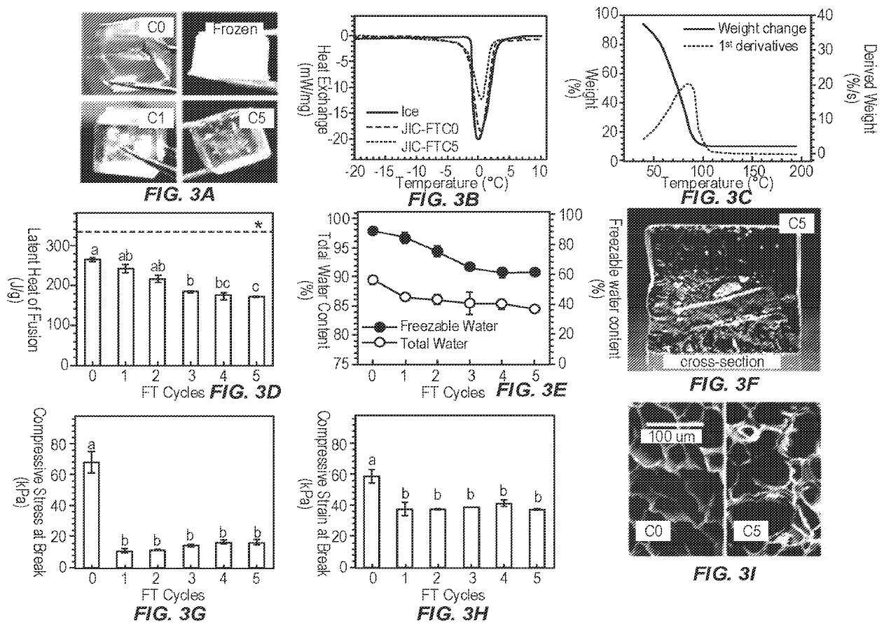

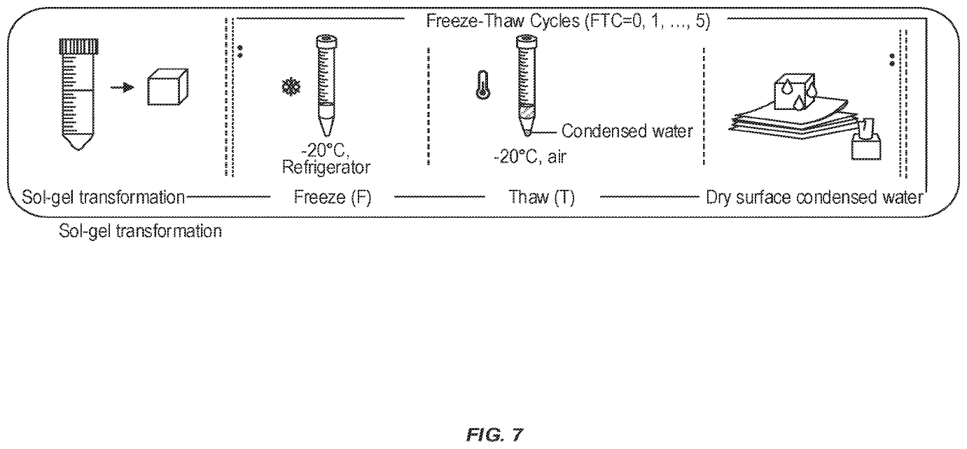

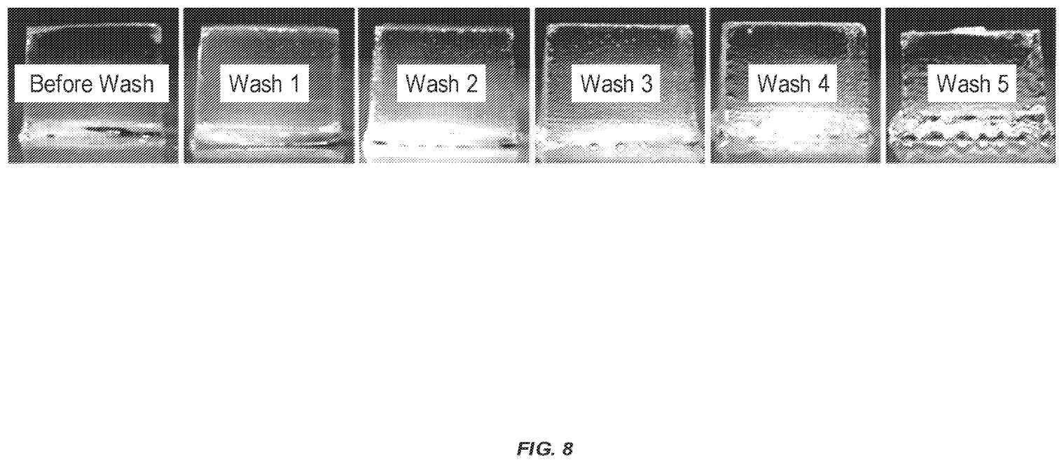

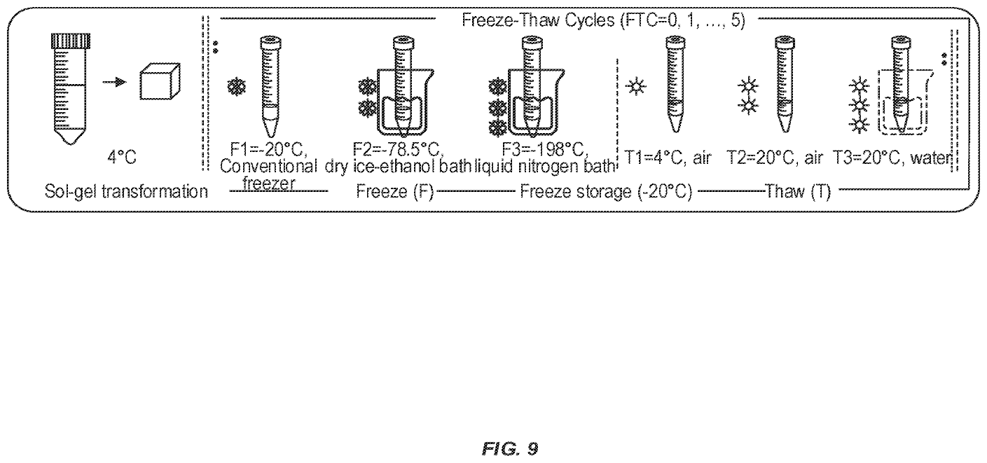

The reusability of JICs was evaluated through repeated freeze-thaw (FT) treatments, as shown in FIG. 7. For each freeze-thaw cycle (FTC), JICs were frozen (F) at −20° C. for 18 h and thaw (T) at ambient conditions for six hours. After each FTC, a minor amount of water formed on the surfaces of hydrogels, coming from either the condensed water or the water loss of JICs. The water was wiped dry gently with a Kimwipe. The appearances of JICs before freezing (C0), under frozen status (Frozen), after one FTC (C1), and after five FTCs (C5) are presented in FIG. 3A. Before FT treatment, the gelatin hydrogel was transparent and uniform, whereas under frozen status, JICs formed a large number of opaque aggregations of ice crystals. Differential scanning calorimetry (DSC) was used to study the changes of latent heat of fusion of JICs after each FTC, shown in FIG. 3B. The fusion heat near 0° C. (ice-water transition) was used to evaluate the heat-absorbing abilities of JICs since it contributes the most significant part in keeping the food below critical temperatures. To study the possible water content changes and explain the fusion heat changes in detail, JICs were analyzed with thermogravimetric analysis (TGA).

As shown in FIG. 3C, TGA curves accompanied with their first derivative curves were obtained. Three characteristics can be observed by combining the results of two thermal analyzing methods. First, multiple FTCs reduced the latent heat of fusion of JICs and decreased its heat-absorbing abilities. As shown in FIG. 3D, the average latent heat of JICs near 0° C. was initially 265.35 J/g and gradually dropped to an average of 171.93 J/g after five FTCs.

Secondly, from FIG. 3B, the heat exchange tendency of JICs and regular ice aligned well around 0° C., except that the phase change of JICs started at a slightly lower temperature than regular ice. The broad endothermic part at lower temperatures could be contributed by the freezable bound water in hydrogels.¹² Interestingly, by comparing the thawing curve of FTC0 and FTC5 in FIG. 3B, the heat absorbed in the ice-melting region reduced significantly after 5 FTCs, while the heat absorbed at the lower temperature stayed steady, which indicates that the loss of heat-absorbing ability along FTCs was mainly due to the loss of free water in hydrogel structures.¹⁹⁻²¹ Also, a small amount of sweat appeared on the surface of JICs and at the bottom of the containers after each FTC, confirming the free water loss occurred during the FT process.^{10, 22-24} Thirdly, in FIG. 3C, it is fair to consider the weight loss from ambient conditions to 110° C. represented the total water content in JICs since the dominant peak of the first derivative curve ends at 110° C.²⁵ The overall water loss and the change in freezable water content were calculated accordingly, shown in FIG. 3E. Consistent with the earlier discussion, the average total water content decreased from 89.38% to 84.46% after five FTCs. The average freezable water content, defined as the ratio of freezable water over the total water content, decreased from 88.76% to 60.86%, which indicates the increasing ratio of non-freezable bound water to freezable water during repeating FTCs, agreeing with the results reported by Liu et al.¹⁹ When the freezable water forms ice crystals during the freezing step, the polymer chains were packed and oriented due to the expansion of ice, which may have caused conformational changes of some curved polymer chains, exposing more hydrophilic points to water. Once thawed, the newly exposed points formed H-bonding with water molecules and changed the free water-bound water content ratio.

It is not surprising to see numerous cavities in the cross-section photos of JICs after five FTCs in FIG. 3F. In FIG. 3A, the inner structure of JICs after C1 and C5 was intensely destroyed by the ice crystals formed during freezing status. Morelle et al.²⁶ studied the effect of freezing on hydrogel structures and found a large number of micro-sized cavities distributing throughout the specimens once frozen. Here, the mechanical properties of JICs after multiple FTCs were also tested and shown in FIG. 3G and FIG. 3H. Before FT treatments, JICs had average compressive stress at the break of 67.95 kPa. After one FTC, due to the generated cavities, the stress at the break dropped to 11.03 kPa with a reduction in the strain. However, with more FTCs, the strength of JICs showed a slight increase, which attributed to the physical crosslinking effect generated by the multiple FT treatments.²¹ Besides, scattered crystallites formed and started to grow as crystalline domains with the H-bonding strengthening.¹⁹⁻²⁰ The rise in the number of both disulfide bonds and H-bonding increased the stiffness of the polymer chains. FIG. 3(i) showed the SEM images of freeze-dried JICs after C0 and C5. The increase in apparent pore size and unevenness of the sponge-like structures after five FTCs can be observed from the image, validating the destructive effect of ice crystals on the polymer framework during FT treatments. The oblate surface of JICs after C5 agrees with the above analysis showed that the expansion of ice crystals exerted a laminating effect on the polymer matrix structures.

Example 3 illustrates cooling performance of JICs compared to regular ice.

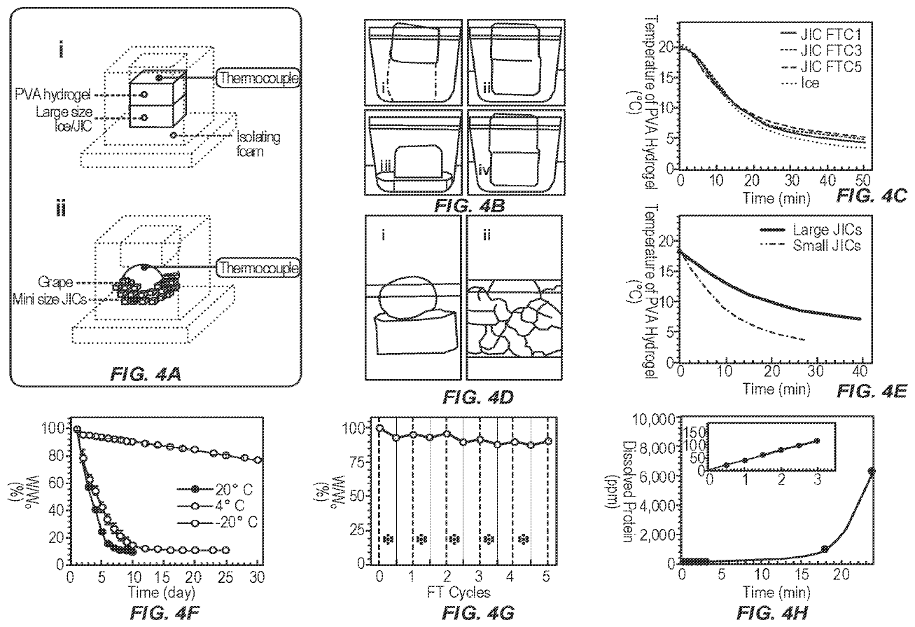

As shown in FIG. 4A (i), a testing device was prepared to mimic the practical situation and compare the overall cooling performance of JICs with regular ice. The thermal insulation well is made of Styrofoam with a top cover designed to reduce air circulation and heat exchange between inner and outer environments. Inside the well, PVA hydrogels (30×30×20 mm) photo-crosslinked by extra Riboflavin 5′-phosphate sodium (RBPS) were used to simulate a piece of food to be chilled, and the RBPS, used as a photosensitizer to crosslink proteins, served as a yellow colorant to simulate the microorganisms on food. The migration of yellow colorants showed the possible cross-contamination during the food cooling process. Underneath the PVA hydrogel, large-sized regular ice or JICs (30×30×20 mm) served as the coolant. A thermocouple was used to record the temperature change at the top center point of the PVA hydrogel.

FIG. 4B shows the actual status of the inner objects at the start (i and iii) and the endpoint (ii and iv) of the cooling test. For (i) and (iii), the PVA hydrogel was chilled by regular ice, whereas in (ii) and (iv), the cooling medium was JICs. The meltwater of ice was conspicuous, as well as the spread of yellow colorant in water. In contrast, there was no visible water leak from JICs, none as the spread of the colorant. After the cooling test, only the contact surface of JICs with the PVA hydrogels was stained with the yellow colorant, which shows a substantial effect of controlling cross-contamination across the food surface by eliminating meltwater from ice. FIG. 4C is the cooling curves obtained by the thermometer buried in the center of the top surface of PVA hydrogels. Here, to simplify the situation, we studied the cooling efficiency of different coolants by comparing the temperature changes in “food” over the cooling period. At 0 min, the PVA hydrogels were placed in contact with the cooling media. Ice, as predicted, showed the best cooling efficiency with the fastest cooling speed and the lowest ending temperature of the “food”. In comparison, the cooling efficiency of JICs during FTC1, FTC3 and FTC5 was slightly lower than ice but still promising. At 50 min, the final temperature of cooling objects was 3.4° C. (cooled by ice), 4.4° C. (cooled by JIC FTC1), and 5.1° C. (cooled by JIC FTC3 and FTC5). The repeated FTCs slightly reduced the cooling ability of JICs, as discussed earlier, while the impact was acceptable and could be compensated with excessive coolants.

Compared with the commercially available icepacks, besides the sustainable features with no plastic shells, another distinctive advantage of JICs is that the coolant's size can be adjusted flexibly per demand. For example, as shown in FIG. 4A (ii), to fit the shape of a grape, which has no flat contacting surface with the cooling media, JICs can be customized into mini sizes (5×5×5 mm), thus increasing the contacting surface area with objects and elevating the overall cooling efficiency. An experimental setup is shown in FIG. 4D. Grapes (around 9 g) at ambient conditions were placed either on top of a large chunk JIC (17.5 g) or surrounded by mini JIC pieces of the same mass. Temperatures of the central point at the upper surface of the grape were recorded with a thermocouple, and the cooling curves are shown in FIG. 4E. The distinction in the efficiency of heat absorptions between different sizes of JICs was obvious. It took the large JIC 10 min while the mini-sized JICs only 5 min to decrease the grape's temperature by 5.2° C. To bring the grape's temperature to below 4° C. (critical temperature), it took the mini-sized JICs 26 min. In contrast, the large JIC chunk could not chill the grape to a temperature below 7.3° C. after 39 min. Reduction in the size of JICs significantly boosted their cooling efficiency. Size flexibility of JICs allows customization of coolants towards food in different shapes.

Since JICs are designed with no plastic shells, it is a significant challenge to maintain their water content for satisfying cooling performance. The percent weight change represents the water loss rate of JICs under various working conditions. In FIG. 4F, large JIC chunks were tested under 20° C., 4° C. and −20° C., to demonstrate dehydration performance under various working conditions over an extended period. When stored at −20° C., JICs have 89.7% weight left after 10 days and 77.5% weight left after 30 days. At 4° C., around 19.4% weight was lost after one day of storage, and 43.0% remained after the first five days. When stored at 20° C., 22.9% of the weight loss was observed after the first day of storage, and 75.0% of the weight loss occurred in 5 days. As expected, without plastic shells, the dehydration of JICs was rapid, especially under ambient conditions. Evaporation of JICs' water content damages their cooling performance for the subsequent FTCs, as discussed earlier. Thus, once thawed, it is better to handle JICs with a minimum exposure time under a temperature above 0° C. After each use, freezing temperature, i.e., −20° C., is preferable for storage to retain water content in JICs.

As mentioned earlier, less than 8% of water might be lost during each FTC. Thus, a quick rehydration process may compensate for the water loss and maintain the performance of JICs at a satisfying level. FIG. 4G elaborates the FT—rehydration repeat using cycles of JICs. Each FTC caused around 2.5-7.5% of weight drop, and the rehydration process could restore the weight by approximately 3%. After five FT—rehydration cycles, the weight only decreased by around 10%, which means that the overall cooling performance of JICs can be mostly preserved by a rehydration process.

In a JIC piece, the matrix structures constructed by proteins are the other vital components for coolant performance. Since gelatin is water-soluble, protein dissolution was also studied. With the Bradford test, the concentration of protein dissolved in water was tested and plotted in FIG. 4H. In the initial three hours, the dissolved protein concentration showed a positive linear pattern. No visible collapse of the hydrogels, but only slight swelling was observed in the first three hours. Within 18 h on the shaking bed, materials broke up into small irregular pieces. Also, it should be mentioned that without continuous shaking, JICs can maintain their structures in water for a much more significant amount of time. Overall, if JICs need to work in a water-rich environment, their physical stability within three hours is reliable.

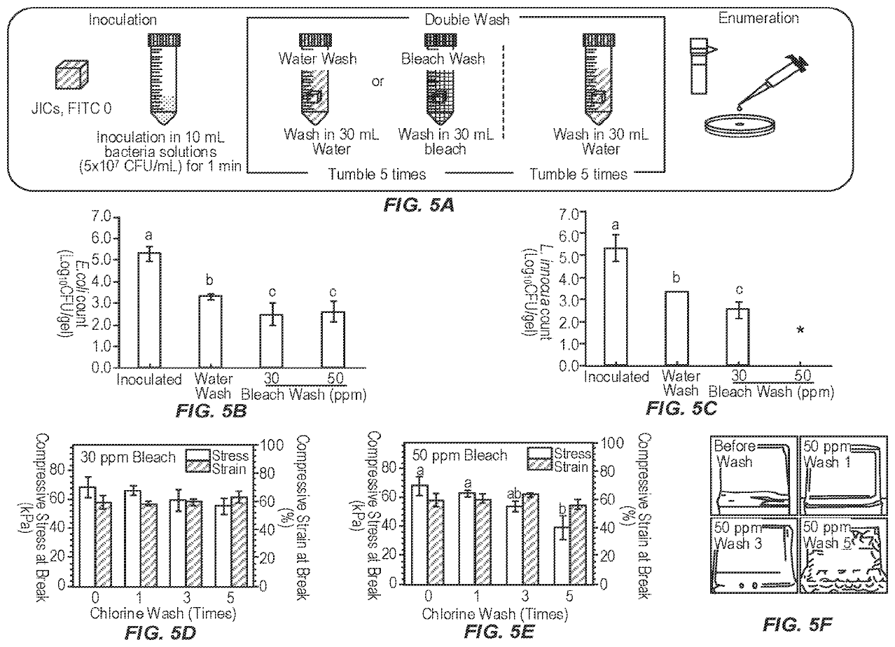

As a reusable coolant, it is vital to control microorganisms present on the surface of materials to ensure food safety. The surface cleaning efficacy of JICs through water or diluted bleach rinse was tested following the steps shown in FIG. 5A, as described in the Materials and Methods section. Two types of bacteria, Escherichia coli (E. coli, gram-negative) and Listeria innocua (L. innocua, gram-positive), were tested. As shown in FIG. 5B and FIG. 5C, water rinse decreased the concentration of E. coli and L. innocua by 2.0 log CFU/gel. In comparison, the concentration of E. coli was reduced by around 2.8 log CFU/gel with the rinse of diluted bleach solution. The difference between 30 ppm and 50 ppm bleach solution was not significant, which might be due to the short contact time not being enough for disinfecting the gram-negative bacteria. For L. innocua, 30 ppm bleach rinse reduced the bacteria concentration by 2.8 log CFU/gel, whereas 50 ppm bleach solution rinse reduced the concentration to below 2.0 log CFU/gel. The results proved the effectiveness of surface cleaning with water or bleach rinse. It is worthy of noting that the water or bleach rise can also rehydrate JICs.

The oxidizing properties of chlorine solutions might cause structural damages to JICs during the cleaning process. Static compression tests were applied towards JICs after up to five cleaning cycles with bleach solutions. As shown in FIG. 5D, with 30 ppm bleach solutions, the mechanical strength of JICs was not significantly damaged. After five cleaning cycles, 80% of the compressive strength was maintained. However, with 50 ppm bleach solutions, as shown in FIG. 5E, the structural damage was apparent. With only three bleach rinse cycles, 20% of the strength was lost, while only half of the strength was left after five cycles. The surface of JICs was significantly damaged after five cleaning cycles with 50 ppm bleach solutions, as shown in FIG. 5F and FIG. 8. Chlorine bleach could convert peptide bonds in proteins to N-chloramine structures, which reduced hydrogen bond interactions of JICs. However, the chloramine structures in JICs may help the self-cleaning of the cubes.²⁷ From the above tests, water or bleach rinse may be applied in practice to clean the surface of JICs after each use. Meanwhile, to build a more robust coolant, the structural stability of JICs in different environments is essential for further improvement.

The feasibility of applying renewable and environmentally friendly JICs as a new type of food coolants was proven through tests and analysis. The cross-contamination concerns caused by meltwater from traditional ice could be reduced with the use of novel JICs. Meanwhile, the overall cooling efficiency was maintained at high levels with a stable solid structure and a freezable water content of over 85%. The properties of JICs were kept in a relatively stable status for at least five reusing cycles, which guarantees its sustainability and reduces the total water demand in food supply chains. After each using cycle, a brief rinse with water or diluted bleach solutions was proven to be an effective way to rehydrate JICs and reduce the surface bacteria concentrations. The biodegradable and plastic-free material minimizes the environmental burden. Robust hydrogel structures with higher stability against temperature variations or phase changes of water can be potentially achieved through crosslinking. The increase in freezable water content in JICs is also expected to bring their heat-absorbing ability closer to traditional ice.

Example 4 illustrates Jelly Ice Cubes having different characteristics based on various concentrations (5 wt. %, 10 wt. %, 15 wt. %, 20 wt. % of gelatin).

Homogeneous gelatin solutions in various concentrations (5 wt. %, 10 wt. %, 15 wt. %, 20 wt. %) were prepared by dissolving gelatin in DI water in a 70° C. water bath overnight with continuous stirring. The homogeneous solutions were then settled in silicon molds (mostly in 10×10×10 mm mold unless specified) and completed the sol-gel transition under 4° C. overnight. Once ejected from the mold, JICs with 10% gelatin concentration were treated with freeze-thaw treatments to mimic their multiple usage cycles. Each freeze-thaw cycle consisted of 18 h of freeze at −20° C. and six hours of thawing at ambient conditions (21° C.) in the air. Up to five freeze-thaw cycles (FTC0, FTC1, FTC2, FTC3, FTC4, FTC5) were performed and tested. Samples were stored at 4° C. after treatments and conditioned to ambient conditions before tests.

Gelatin (Type A, 225 bloom food grade) was purchased from MP Biomedicals, LLC (Solon, OH). Poly (vinyl alcohol) (PVA, Mn 85,000-146,000, 99+%, hydrolyzed) was purchased from Sigma Aldrich (Milwaukee, WI). Riboflavin 5′-phosphate sodium (dihydrate, RBPS) was purchased from Spectrum Chemical (Gardena, CA). Coomassie (Bradford) assay, Luria-Bertani (LB) broth, and Tryptic soy broth (TSB) were purchased from Thermo Scientific (Rockford, IL). SuperPremix Miller's Luria-Bertani (LB Agar) was purchased from U.S. Biotech Sources, LLC (Richmond, CA). Tryptic Soy Agar (TSA) was purchased from Bio-world (Dublin, OH). Bleach solution was a product of Clorox Co., Ltd. (Oakland, CA). Deionized (DI) water was used to prepare the gelatin solutions.

Gelatin hydrogels at different concentrations and JICs after various FTCs were tested with an Instron 5566 tester (Norwood, MA) for the static compressive properties. Static loading cells of 10 kN or 5 kN were used according to the specific sample strength. Samples in size of 10×10×10 mm were tested with a rate of 10%/min. The stress and strain at the break were calculated and plotted as results.

The latent heat of different gelatin-based hydrogels and JICs after various FTCs was measured using a differential scanning calorimeter (DSC-60, Shimadzu Corporation, Pleasanton, CA). The heat absorbing-releasing profiles of JICs were obtained from −30° C., supported by liquid nitrogen, to 10° C. with a 1° C./min heating rate under a 50 mL/min protective nitrogen flow. The latent heat of fusion around 0° C. of JICs was calculated by integrating the heat flow (W/g)—time (s) curve. Latent heat of fusion of regular ice at 334.5 J/g was used as the reference. The freeze-thaw process during the DSC test was not counted as an FTC since both freezing and thawing conditions were different from the FT treatment defined earlier.

The water contents of JICs were tested using the thermogravimetric analysis (TGA, SDT-Q600, TA Instrument, New Castle, DE). The TGA curve's first derivative was taken to assist the identification of water loss. As shown in FIG. 3D, the prominent peak of TGA curves for water ends around 110° C. The total water loss was calculated according to Eq. (1), and the freezable water content was calculated according to Eq. (2), where w is the weight of JICs at 110° C., w₀ is the initial weight of JICs in TGA tests, H is the fusion heat of JICs at the specific FTC.

$$Total water content ( \% ) = \frac{{w}_{0} - w}{{w}_{0}} \times 100 \% \qquad Eq . ( 1 )$$

$$Freezable water content ( \% ) = ( \frac{H}{334.5} ) \div ( \frac{{w}_{0} - w}{{w}_{0}} ) \times 100 \% \qquad Eq . ( 2 )$$

The cross-section of JICs was observed using a Dino-Lite digital microscope (Dunwell Tech. Inc, Torrance, CA). The internal microscopic structures of freeze-dried JICs were observed using a Quattro environmental scanning electron microscope (ESEM, Thermo Fisher Scientific, USA). Samples were first sliced into small pieces with disposable scalpels and freeze-dried using a Benchtop K lyophilizer (VirTis, Los Angeles, CA).

The overall cooling efficiency of ice and JICs was tested with a designed device shown in FIG. 4A. The isolating foams generated a 35×35×80 mm well with a flexible cap. Two types of comparisons were delivered. The first was to compare the cooling efficiency of ice and JICs. Large ice chunks or JIC chunks (30×30×20 mm) were prepared and conditioned at −20° C. Large PVA hydrogels (15%) prepared with 0.5% RBPS were used as the cooling objects (30×30×20 mm). The PVA-RBPS hydrogel was photo-crosslinked via a Spectrolinker XL-1000 equipped with five 8 W UVA (365 nm) light tubes (Spectronics Corporation, Lumberton, NJ). The second group of comparisons was on the size effect of JICs. Mini JICs (0.1 g/piece) in a total of 15 g and a large JIC chunk (single piece, 15 g) were prepared and conditioned at −20° C. Grapes (9.0±0.5 g) were used as irregular-shaped cooling objects. In both comparisons, a thermocouple (type K, Omega Engineering Inc., Stamford, CT) with a 4-channel handheld data logger (Omega Engineering Inc., Stamford, CT) was attached to the top surface's central point of the objects (either PVA-RBPS hydrogel or grapes) to record temperature changes from the moment the object touched the coolant.

The water-withholding ability of prepared JICs was tested by measuring the mass change of JICs along time under different temperatures. Their weight changes under 20° C., 4° C. and −20° C. were monitored with analytical balances (0.1 mg detection limit). The initial samples were around 15.000±1.000 g.

The rehydration tests were conducted with cubic samples around 1 g. Weight change after each complete FTC (snow marks) or rehydration in the excess amount of water (30 mL, 20 min, with minor stirrings, blue ribbons) was tested and calculated for the weight change ratios.

Protein dissolution of JICs was tested by immersing 5 g (5 cubes) of JICs in 25 mL DI water with continuous shaking (200 r/min) at ambient conditions. The concentration of proteins dissolved in water was tested using the Bradford micro method (working range 1 to 25 μg/mL). Per 1 mL of diluted (1:1, 1:10 or 1:100 diluting ratio) sample was added into 1 mL of the Coomassie reagent. The absorbance signal at 595 nm under a UV spectrophotometer (Evolution 600, Thermo) was recorded to calculate the protein concentration according to the standard curved constructed with bovine serum albumin (BSA).

To characterize the surface cleaning efficiency of regular water wash or bleach (sodium hypochlorite) wash on JICs, antimicrobial assays were applied towards generic E. coli LJH1247 (gram-negative) and L. innocua (gram-positive). Diluted bleach solutions (30 ppm and 50 ppm) were prepared from diluted Clorox with no additional pH adjustment. The detailed procedure is shown in FIG. 5A. A JIC piece (10×10×10 mm) was first inoculated in bacteria solutions (5×10⁷ CFU/mL) for one minute. After inoculation, the artificially contaminated JICs were washed with water or bleach. For the water rinse group, contaminated JICs were washed twice in 30 mL of DI water with five times of tumble (gently turn the tube upside-down twice, total around 10 s). For the bleach rinse group, JICs were first washed with diluted bleach solutions (either 30 ppm or 50 ppm) for five tumbles, transferred into 30 mL of DI water and then tumbled for additional five times to rinse off the extra chlorine residue and avoid extra contacting time. The survived bacteria on the surface of JICs were recovered by rinsing the “washed” JICs with 10 mL of sterile Phosphate Buffered Saline (PBS) buffer and enumerated by plating onto plate count agar (detection limit=2.0 log CFU/gel).

All experiments were performed for at least three times, and the results are presented as mean value±standard deviation. Statistical analyses were conducted using one-way analysis of variance (ANOVA). Mean values were compared using Tukey's test to identify significant differences between each treatment group (P≤0.05).

Assume the food load has a uniform density (ρ) with cuboid shape. h (m) represents the height of the food load

$$ρ = 1000 ( \frac{kg}{{m}^{3}} )$$

$$g = 9.8 ( \frac{N}{kg} )$$

$$P = \frac{F}{A} = \frac{m g}{A} = \frac{ρ Vg}{A} = \frac{ρ A hg}{A} = ρ gh = 9800 h ( \frac{N}{{m}^{3}} ) \approx 10 h ( \frac{k Pa}{m} )$$

Reducing food loss and waste is one of the global challenges in enhancing food security and environmental sustainability. (Adamashvili et al., 2020; Wang et al., 2021; Karunasagar et al., 2016; Shafiee-Jood et al., 2016) During the preservations of perishable food, temperature abuse falling in the range of 4.4° C.-60° C. is one of the critical reasons jeopardizing the food safety and quality. (Ndraha, 2018; Shirone, 2017; USDA) In food supply chains, traditional ice is extensively used as a food cooling medium due to its high latent heat of fusion near 0° C. However, concerns arouse on microbial cross-contaminations resulting from ice meltwater. As potential replacements, ice packs and new types of antimicrobial ice have been developed and studied. (Lin, 2013; Wang, 2014; Zhao 2018; Shin, 2004) Despite the efforts, there is still a vacancy for an ideal food coolant that comprehensively features high cooling efficiency, no meltwater, sustainability, reusability, biodegradability, biocompatibility, safety and zero plastics. Thus, studies in the field are urgently needed.

In the above examples, “jelly ice cubes” (JICs) based on 10% gelatin hydrogels were tested as a new type of environmentally friendly food cooling media that could effectively prevent bacterial cross-contamination by constraining the cooling water component within the hydrogel structures. Nevertheless, two important challenges remained to be solved for the improved practicality of JICs in food cooling applications. First, to achieve the features of a reusable cooling medium, the thermal properties of JICs should preferably be stable throughout multiple freeze-thaw cycles (FTCs) with minimum depression in the heat-absorbing abilities to be observed. Second, hydrogel systems with robust mechanical properties should be built with minimal structural changes and material flaws under the repeated phase changes of water in the hydrogels through FTCs. To build the robust systems, the degree of physical and chemical crosslinking should be well-controlled for stable hydrogels or cryogels. It is of great interest to study the impact of preparation and practical cryogenic conditions on the structures, properties and functions of JICs for the optimization of the stability of JICs.

Hydrogels are polymer matrix-supported networks filled with water molecules. When hydrogels go through repeated cycles of freezing steps, freezing storage steps, and thawing steps, it is also referred to as cryogels. (Lozinsky, 2003; Lozinsky, 2020; Okay, 2014) The differences in water molecules interactions with protein polymers in the hydrogel divide the water in the cryogel system into three categories: free water, freezable bound water, and non-freezable bound water. Upon freezing, the phase change of freezable water, including free water and freezable bound water, induces potential disruptions or damages to the polymeric structures due to uncontrollable growth of ice crystals during freezing. To control the impact of the freeze-thaw process on the polymer network structures, an important factor is to master the shape and size of the formed ice during freezing. The freezing rate of water determines the ice crystal size by changing the nucleation rate. (Ickes, 2014) Inspired by the flash-freezing technique proposed in food engineering, extremely fast freezing conditions can potentially be applied to the JICs to achieve rapid freezing, reduce the size of ice crystals formed, and minimize the destructive impact of phase change of the water to the polymer matrix structures. (Li, 2002) In food engineering, similar situations have been extensively studied. Fresh meat and seafood, similar to hydrogels, have 60%-80% water in their structures. (William, 2018; Petzold, 2009) The storage condition of meat and various seafood has been highly optimized to determine the best freezing conditions for promising food qualities. Both freezing and thawing conditions are tightly associated with the potential dehydration, cell wall deformation, intercellular adhesion weakening, intercellular space enlargement, cell shrinkage of biospecimens. (Li, 2002; Tan, 2018; Li, 2018; Boonsumrej, 2007; Zhang, 2017) Also, with cryogels, scattered studies on the effect of various freezing and thawing conditions were conducted. However, there is lack of comprehensive studies that guide the fabrication and application conditions of JICs by discussing the effect of freezing and thawing conditions on the microstructures of cryogels, as well as the relationship between the resulting structures to the water content, heat-absorbing ability, and the mechanical properties of the cryogels.

Example 5 illustrates Jelly Ice Cubes based on 10% gelatin, which were prepared and tested for various properties against three levels of freezing rate and three levels of thawing rate. Supercooling conditions provided by dry ice-ethanol bath or liquid nitrogen were employed to find the ideal fabrication and application conditions for JICs.

Gelatin (Type A, 225 bloom food grade) was purchased from MP Biomedicals, LLC (Solon, OH). Poly (vinyl alcohol) (PVA, Mn 85,000-146,000, 99+%, hydrolyzed) and ethyl alcohol (pure, 200 proof) were purchased from Sigma Aldrich (Milwaukee, WI). Riboflavin 5′-phosphate sodium (dihydrate, RBPS) was purchased from Spectrum Chemical (Gardena, CA). Deionized (DI) water was used to prepare the gelatin solutions. Liquid nitrogen and dry ice were used to prepare the freezing bath.

Homogeneous 10 wt. % gelatin solutions were prepared by dissolving gelatin (type A, 225 bloom food-grade, MP) in deionized water at 70° C., and settled in silicon molds (10×10×10 mm, unless specified) overnight under 4° C. to complete the sol-gel transition. The prepared hydrogels were called JICs at C0 before any further FT treatments.

Freeze-thaw methods were applied to the prepared gelatin hydrogels to mimic their multiple freeze-thaw usage cycles under different conditions. The detailed conditions of multiple FT treatments are shown in FIG. 9. Each FTC consisted of initial freezing at various temperatures, 18 h of rate, storage at −20° C., and six hours of thawing at various rates, in consequence. Various freezing temperatures and thawing rates were F1=−20° C., F2=−78.5° C., F3=−196° C., representing three levels of possible cryogenic conditions in practice, and T1 (4° C., air; 0.05° C./min), T2 (21° C., air; 0.25° C./min), and T3 (21° C., air; 2.5° C./min), simulating three possible application conditions of the JICs in refrigerators, in the air under ambient conditions, or immersed in water under room temperature. Multiple freeze-thaw cycles (C1, C2, C3, C4, C5) were also performed to mimic multiple usage cycles.

The heat absorbed by the phase change of freezable water in JICs was tested using differential scanning calorimetry (DSC-60, Shimadzu Corporation, Pleasanton, CA). The heat-absorbing profiles of JICs were obtained in a temperature range of −30° C. to 10° C. with a 1° C./min heating rate under a 50 mL/min protective nitrogen flow. The latent heat of fusion around 0° C. was calculated by integrating the heat flow (W/g)−time (s) curve.

The total water content was tested using thermal gravimetric analysis (TGA, SDT-Q600, TA Instrument, New Castle, DE) from ambient temperature to 150° C. with a 10° C./min heating rate. The total water loss was calculated according to Eq. (1), and the freezable water content was calculated according to Eq. (2), where w is the weight of JICs at 110° C., w₀ is the initial weight of JICs in TGA tests, H is the fusion heat of JICs at the specific FTC.

The testing method for obtaining cooling curves was as described above. The designed device fabricated with Styrofoam was used to provide a stable and isolated environment. Large PVA (15%) hydrogels (30×30×20 mm) photo-crosslinked with 0.5% RBPS conditioned at 20° C. were used as the cooling objects. Large JICs of 30×30×20 mm were prepared and conditioned at −20° C. for the test. A thermocouple (type K, Omega Engineering Inc., Stamford, CT) with a 4-channel handheld data logger (Omega Engineering Inc., Stamford, CT) was attached to the top surface's central point of the cooling object to record temperature changes from the moment the object touched the coolant.

The static compressive properties of JICs were obtained using an Instron 5566 tester (Norwood, MA). Static loading cells of 5 kN and 10 N were used with a compressive rate of 10%/min. Samples in size of 10×10×10 mm were tested for their compressive stress and strain at the breakage point, and the compressive modulus was calculated accordingly.

The cross-section of JICs, sliced with disposable feather scalpels (Feather Safety Razor Co., LTD. Japan), was observed using a Dino-Lite digital microscope (Dunwell Tech. Inc, Torrance, CA). The internal microscopic structures of lyophilized JICs were observed using a Quattro environmental scanning electron microscope (ESEM, Thermo Fisher Scientific, USA). Specimens for SEM images were sliced into small pieces, frozen under −198° C. and lyophilized by a Benchtop K lyophilizer (VirTis, Los Angeles, CA).

All experiments were performed at least three times, and the results are presented as mean value±standard deviation. Statistical analyses were conducted using a one-way analysis of variance (ANOVA).

Because freezing conditions of JICs during the fabrication and application stage greatly impact the structure and cooling efficiency, freezing temperatures of fabrication JICs, thawing temperatures of potential applications, and cycles of uses on their related properties and functions were systematically studied. Three levels of cryogenic conditions were employed to discuss the impact of freezing rate on the internal structures of JICs. Three different thawing rates were investigated corresponding to each freezing condition.

JICs were first tested for repeated freezing cycles at −20° C. (F1) and thawed at various rates. Freezing condition provided by a conventional freezer at −20° C. is the most accessible and affordable one for the food supply chain and customers among the three tested conditions. To mimic different possible thawing situations, thawing in a refrigerator (T1, 4° C. air), in ambient air (T2), or room temperature water (T3) was performed.

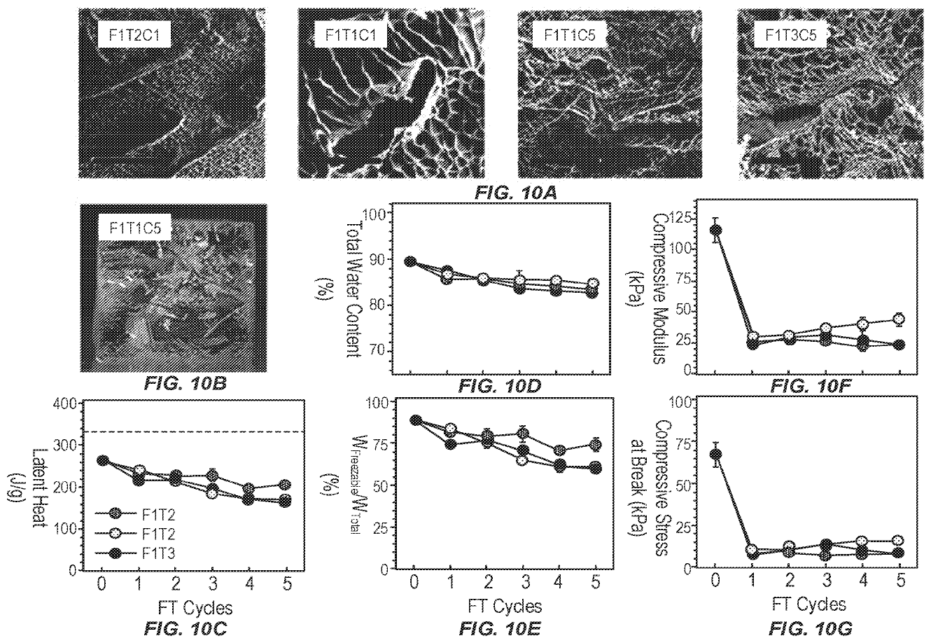

Photos of JICs and cross-section of JICs after one or five cycles, and SEM images of the lyophilized JICs before and after FT treatments are shown in FIG. 10A and FIG. 10B. As with the previously described examples, severe damage of hydrogel matrix structures after F1TCs was observed. Visible cavities and defects were formed after only one FTC for F1T1, F1T2 and F1T3. Significant uneven surfaces of the JICs with very different sizes of cells were present throughout the matrix structures for all thawing conditions after frozen under F1. Long and deep divides dispersed through the clusters of smaller cells. The size variations within and among each specimen were quite significant and unpredictable. Here, the dominant disruption of the polymer matrix network was created by the large and irregular ice crystals formed under −20° C. (Lozinsky, 2014) At −20° C., the ice formation inside the JICs was a slow process. Due to the low nucleation rate at −20° C., a small number of supercooled droplets were formed.

The considerable amount of freezable water molecules aggregates around the formed nucleus and grow the size of ice crystals. Because of the mild freezing condition, the heat distribution inside the JICs during the freezing process could have caused the size distribution of the final ice crystals varies on a large scale depending on the dispersion of the nucleus. Although, the average size of the formed ice was large at F1 due to its lower total nucleus numbers. (Ickes, 2014) The expansion of the solvent (H₂O) volume from liquid water to solid ice encroached the space of the solute (protein-polymer chains) and created cells and flaws across the JICs. Meanwhile, the expansion of the solvent shortened the distance of inter- and intra-protein macromolecular chains, which first significantly enlarged the possibilities of forming inter-macromolecular H-bonds and increased the degree of physical crosslinking of the polymer network; second, it increases the possibilities of forming disulfide bonds between hydrosulfur groups. Once stabilized by H-bonds and disulfide bonds, the non-uniform hollow structures with many material flaws stay even after the solvent (ice) thaw back to the liquid status.

Here, it is important to identify the relationship between the morphological change and performance of JICs after repeated FT treatments. Heat-absorbing ability near 0° C. is the critical indicator for the food cooling functions. FIG. 10C shows the change of fusion heat of JICs from FTC0 to FTC5. The average latent heat of fusion at C0 was 265.35 J/g, and after several FTCs, it showed apparent decreasing tendencies for under all three thawing rates. For F1T1, the average fusion heat dropped by around 14% after three FTCs and more than 20% after five FTCs. For F1T2 and F1T3, there was more than a 25% decrease after three FTCs and more than a 35% decrease after five FTCs. The latent heat of fusion of JICs around 0° C. is associated with the freezable water in the hydrogel structures. Thus, the change of water content in the structure was also tested. In FIG. 10D, the total water content in JICs showed steady decreasing tendencies under all three thaw rates. The water loss difference induced by different thawing rates was not significant (P<0.05). However, it should be noted that the first three FTCs introduced the most significant losses in total water content for all groups, especially for F1T3, while afterward, the water content was maintained in a steady status. FIG. 10E describes the percentage change of the freezable water in the total water content. With very similar trends found in FIG. 10F, after one FTC, the average freezable water reduced from 88.8% (C0) to 81.6% (F1T1C1), 83.8% (F1T2C1) and 77.4% (F1T3C1). Moreover, after five cycles, JICs retained only 74.3% (F1T1C5), 60.9% (F1T2C5) and 59.6% (F1T3C5) freezable water in the total water contents, respectively. The loss of freezable water content should be closely associated with the morphological change of the polymer network structures induced by the FT treatments. Many large ice crystals were generated under −20° C., making it difficult for the H₂O molecules in the middle of the ice crystals to interact with the polymer chains through H-bonds due to the excessively long distance. With fewer H-bonding interactions, those H₂O molecules became unconstrained water and could be lost once thaw.

Meanwhile, as shown in FIGS. 10F and G, the compressive mechanical properties were significantly damaged after FT treatments due to the generated cavities and flaws described in the earlier discussions. Compressive modulus in FIG. 10F shows the hardness of the JICs, while the compressive stress at break indicates the highest pressure the hydrogels can bear. From C1 to C5, crosslinking effect induced by FT treatments was observed with increased mechanical strength. The increase of H-bonds and the possible increase of disulfide bonds contributes to strengthening the hydrogel matrix structures. However, even with the strengthening, the overall mechanical strength was around 10-16 kPa after FTC5, around 76-85% of loss compared to C0.

In summary, the deformation impact of ice crystals formed under −20° C. was quite impressive on the structures compared with that on various functions of JICs. With F1TCs, the morphology of the polymer networks of JICs was significantly disrupted by various sizes of irregular ice crystals. The average large cell size of the JICs reduced the possibility of freezable water interacting with the protein macromolecules, thus increased the loss of freezable water in the repeated FTCs. There was an apparent decrease in the heat-absorbing ability, and a striking decrease in the mechanical properties of JICs treated with all F1TCs at various thawing rates. Differences were observed showing that slower thawing rate (T1) mildly lessened the performance degradation of JICs. Overall, to advance the performance and prolong the lifecycles of JICs, extra modifications can be done to stabilize the structure of the polymer network against the deformation forces of ice crystals observed under the F1 condition.

To increase the freezing rate, a dry ice-ethanol bath was used to create a fast freezing environment at −78.5° C., which generally causes less damage to the JIC structures because of smaller sizes of the created ice crystals. (Petzold, 2009). Here, the cryogenic condition F2 was employed to provide a more rapid cooling rate compared to F1 to study the differences among polymer network morphology and the corresponding properties.

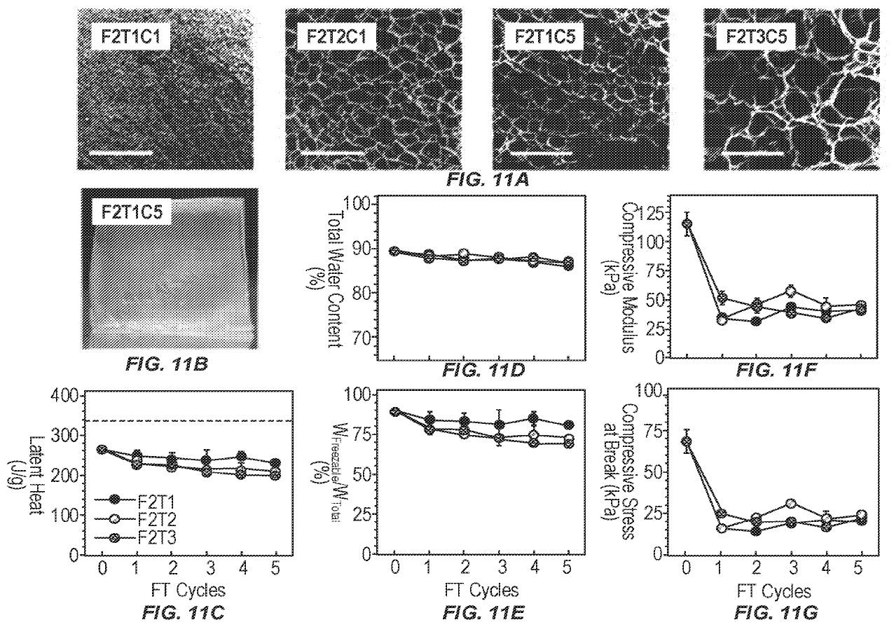

The appearances, lyophilized specimens, and the cross-section structures of JICs after one or five cycles of F2T1, F2T2 and F2T3 treatments are shown in FIG. 11A and. FIG. 11B. It can be observed that the damages produced inside the JICs were much less significant than those in the F1 series. Compared to F1TCs, specimens from F2TCs showed much dense, uniform and regular structures with no visible large crack, but minor ditches, indicating smaller but higher amount of the ice crystals generated in the protein matrix suspensions. Moreover, the effect of various thawing rates on the structural shaping of hydrogels was more clearly illustrated with the SEM images of F2T1C5 and F2T3C5. The average cell size of JICs after F2T3C5 was much larger than that of F2T1C5, which might be related to a higher degree of physical crosslinking of the protein network at high thawing rate. (Lin, 2013; Boonsumrej, 2007; Li, 2002)

Tests on the properties and functions of JICs were also done to find if a more uniform morphology of JICs contributes to stabilize the function and prolong the lifecycle of JICs. FIG. 11C shows the change of latent heat of fusion along the FTCs (F2). The latent heat of fusion for JICs went through F2T1 treatments were very stable. The average latent heat dropped from 265.35 J/g (C0) to 246.89 J/g at F2T2C1. After F2T1C5, the average latent heat of fusion only dropped by 13%, which was much less than that of F1T1, F1T2 and F1T3. Meanwhile, the slowest thawing rate, F2T1, also showed the best stability in maintaining the heat-absorbing ability among all thawing conditions under the F2 treatments. The average fusion heat around 0° C. dropped by 13% and 15% compared to C0 for F2T2C1 and F2T3C1, respectively. After five cycles of the FT treatments, JICs treated with F2T2C5 and F2T3C5 have 209.17 J/g and 198.57 J/g fusion heat, which were much higher than that of F1T2C5 and F1T3C5, respectively. Apparently, higher freezing rate stabilized the heat-absorbing abilities in JICs, and slower thawing rate tended to reduce the loss of fusion heat around 0° C. better than the faster thawing rate.

A similar pattern was observed in the change of total water content and freezable water ratio, as shown in FIGS. 11D and E. The overall changes in the total water content were not quite significant, as seen in the F1 series. After one FTC, JICs treated under F2T1C1, F2T2C1 and F2T3C1 conditions have an average of 88.7%, 88.3% and 87.8% of total water contents in the original hydrogel structures. After five FTCs, 86.1% (F2T1C5), 86.9% (F2T2C5) and 87.0% (F2T3C5) of total water remained in the JICs, which were higher than all the JICs treated with five cycles of F1 under any thawing conditions. The freezable water content was also maintained stably under the F2T1 treatment. After F2T1C5, there was only an 8% drop in the ratio of freezable water over the total water content. For samples of F2T2C5 and F2T3C5, the ratio dropped by 16% and 17% compared to C0, but still much less than that of F1T2C5 and F1T3C5. By incorporating a lower temperature bath and a faster freezing rate, the heat-absorbing ability of JICs along multiple FTCs was improved with much less water loss, especially on the freezable water content, from the hydrogel structures.

FIGS. 11F and G show the compressive modulus and compressive stress at the break of the JICs prepared under FTCs. Similar to what was observed in the F1 series, the modulus of JICs dropped sharply after the first FTC under all thawing conditions (F2T1C1, F2T2C1 and F2T3C1). For F2T3, the modulus showed a continuous decreasing tendency along five FTCs, while the modulus of the JICs treated by F2T1 showed an increasing trend from F2T1C2 to F2T1C5, which were also similar to what was observed in the F1 series. However, the overall loss of mechanical strength of the JICs due to the repeated FTCs under F2 condition was not as significant as the ones treated under the F1 condition. After five FTCs, the average compressive stress at break for all JICs treated under the F2 was higher than 20 kPa, which doubles the stress of the JICs treated with five cycles under the F1 condition, and still meets the required 10 kPa strength limit for over 10 m of overhead food load.

Overall, the F2 rapid freezing cycles provided by the ethanol-dry ice bath significantly reduced the morphological disruption of the JICs, in comparison with those under the F1 condition. The uniform and fine porous morphology of the gel structures resulted from the F2 condition improved freezable water content, and consequently the compressive mechanical stability of the JICs.

To maximize the possible advantages of applying rapid freezing rate in the repeated FTCs, cryogenic conditions at −198° C. provided with a liquid nitrogen bath were used in this section as the F3 series.

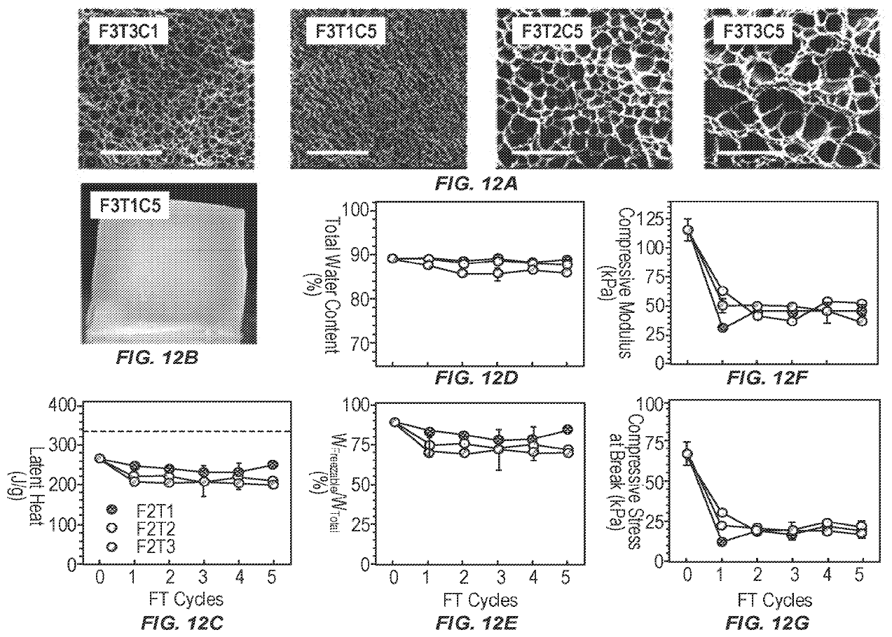

FIGS. 12A and B together shows the appearances, cross-sectional images of JICs after F3TCs, as well as the lyophilized specimens after F3TCs. Multiple changes were observed from F3TC specimens compared to that from F1TCs and F2TCs. First, the overall structures became in an opaquer status compared to F1 and F2, indicating more polymer crystalline domains formed through five FTCs. Second, the overall hydrogel structure was still intact, with tiny cracks caused by the phase change of water. Most importantly, the cell size of the JICs after F3T1C5 was intensively smaller than specimens treated with F1TCs and F2TCs. Also, similar pattern was observed in the samples treated under the F2, led to larger average cell size of the lyophilized JICs. Since the JICs were casted out of the homogeneous gelatin solutions, it is fair to say to F3T1 preserved the original morphology of the JICs to the best degree among all the tested FT conditions.

Similar to the F2 series, the change of latent heat of fusion shown in FIG. 12C became very steady compared to the F1 series. After five FTCs, the average latent heat of JICs was around 248.8 J/g, 209.7 J/g and 199.9 J/g for F3T1C5, F3T2C5 and F3T3C5, respectively. The total water content in JICs was also tested and shown in FIG. 12D. Specimens treated with F3T1 and F3T2 did not lose a significant amount of water during five FTCs, compared to C0 (P<0.05). The JICs treated under F3T3 condition, however, showed some water loss during the repeated FT treatment. Also, in FIG. 12E, the ratio of freezable water in the total water content revealed that F3T1 maintained the higher freezable water content in the structure, whereas F3T3 maintained the least. Combining the results from F1 and F2, the slowest thawing rate, T3, preserved the most portion of the freezable water content, contributing to the heat-absorbing abilities of JICs near 0° C.

The mechanical properties shown in FIGS. 12F and G illustrate the impact of multiple F3TCs on the hardness and compressive strength at break of JICs. Similar to F2, rapid freezing reduced the damage of ice crystals to the polymer network. Agreed with what were seen in the SEM images, the structure of the JICs after F3TCs had much less flaws compared to the specimen treated with F1TCs. Plus, the effectiveness of the reducing structural flaws in the JICs treated under the F3 was more significant than that treated under the F2, with the average compressive modulus stayed at 46 kPa, 52 kPa and 37 kPa for F3T1C5, F3T2C5 and F3T3C5, respectively. After five cycles of F3TCs, the average compressive stress at break were around 20 kPa for the JICs treated all three thawing rates.

Plot data are expressed as means±SD of three replicates. The latent heat of the cryogels frozen multiple times under −198° C. while thawed under different conditions. The dashed line with a star mark represents latent heat value if all water content in JICs serves as free water. FIG. 12B The first derivative curves of the JIC mass change under continuous heat, tested by TGA. The static compressive stress at break FIG. 12C and strain FIG. 12D of the prepared cryogels after up to 5 FT cycles. FIG. 12E The appearances of gelatin hydrogel JICs under ambient conditions. FIG. 12F The SEM image of the freeze-dried JICs, with a scale bar of 100 μm. In FIGS. E and F, the graphs are arranged with the order of JICs after one FT cycles (i, iii, and v) and after five FT cycles (ii, iv and vi), and JICs treated with F3T1 (i and ii), F3T2 (iii and iv) and F3T3 (v and vi). Plot data are expressed as mean±SD of three replicates.

In summary, the morphologies of JICs were preserved in the best shape with F3TCs among all tested FT conditions. Specifically, F3T1 treatment generated the most uniform structures with tiny microcells. In agreement with the morphology characteristics, the freezable water content of JICs treated with F3T1 was maintained in a pretty stable status through five FTCs, as were the heat-absorbing abilities. The decline of the gel strength through repeated using cycles was much more controlled and lowered compared to the JICs prepared in a conventional freezer.

Example 6 illustrates the cooling ability of the Jelly-Ice Cubes

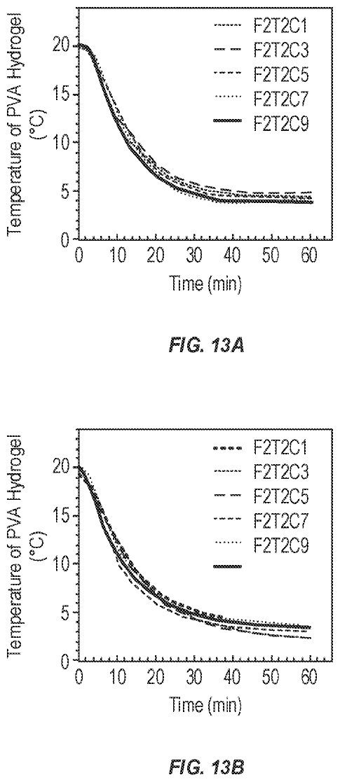

JICs were also tested for their cooling ability towards food subjects, where PVA/RBPS hydrogels were used to demonstrate food objects as demonstrated in the previous examples. The cooling efficiencies of the JICs were compared by applying JICs under room temperature in the air (T2). In the previous examples, the cooling efficiency of JICs was reported with noticeable decrease under F1T2 conditions, where the final temperature of cooling objects increased from 4.4° C. (cooled by JIC FTC1) to 5.1° C. (cooled by JIC FTC5). To compare, FIG. 13 shows the cooling curves of the JICs in repeated F2T2 A or F3T2 B using cycles. Impressively, when used under F2T2 or F3T2 conditions, there was no apparent change in the final temperature of the cooled object even after 9 or 10 FTCs. After 60 min cooling with the JICs treated with F2T2 treatments, the temperature of the cooled object remained in the range of 4.0±0.3° C. within the nine cycles of applications. When cooled with the JICs treated under F3T2 conditions, the final temperature of the cooled objects were always below 3.6° C. within the 10 application cycles. The cooling efficiency test confirmed the finding that lower temperature and more rapid freezing speed could build JICs with more controlled and finer 3-D network structures with more effective heat-absorbing ability and long durability as a new cooling medium.

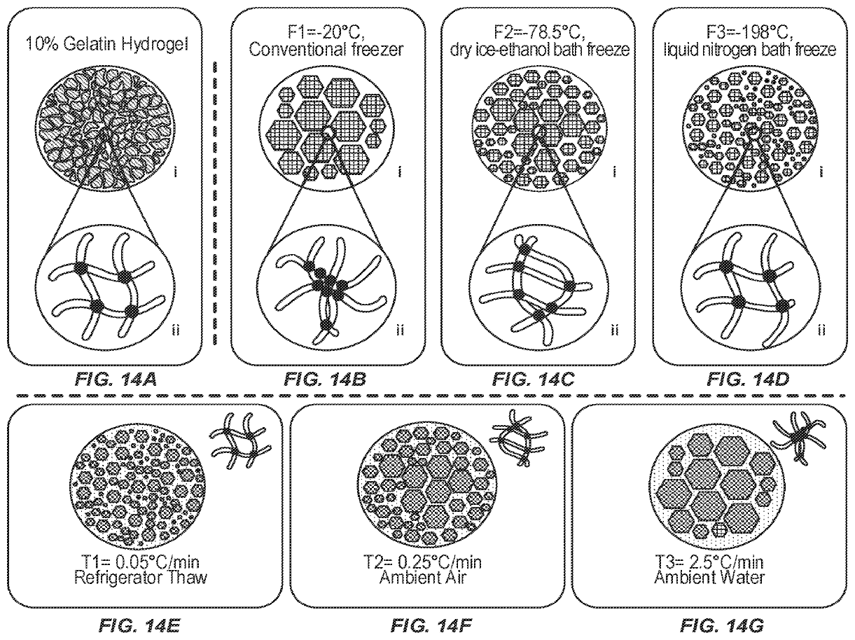

To summarize the observed structural changes, FIG. 14 illustrates the structural features JICs and effect of three types of freezing conditions and three thawing rates on the formation of the JICs. Rapid freezing condition promotes formation of fine ice crystals, a result of fast phase change of liquid to solid. The phase change of water from liquid to solid has significant effect on the protein polymer 3-D networks with large or small irregular cells disrupting the original homogenous status of the 3-D networks in hydrogels. Also, the generated cells retain the 3-D structure after the ice thawing process, which is stabilized by the physical crosslinking of the protein caused by H-bonds. Specifically, the smaller ice crystals created by the rapid freezing process cause less damages to the polymer network of the JICs, and slow thawing rate milden the destructive effect generated during the freezing stage. These two major factors can be used in guiding the fabrication and application condition of JICs and other water-rich systems.

JICs, as a type of reusable cooling medium, can possess robust properties against the phase change of the water in the hydrogel matrix materials and provide consistent cooling functions during repeated uses. The previous examples demonstrated the gigantic influence of ice crystals formed during the FT treatment in the overall shaping of structure and function of JICs. Here, various FT conditions have been systematically studied to control the disruption of the polymer network. The combination of rapid freezing and slow thawing treatment conditions generates uniform polymer network structures after FTCs. With F3T1 treatment, stabilized freezable water content, constant cooling efficiency, and relative stable mechanical strength were observed, which properties was significantly improved compared to F1T2 treatment. Stable cooling efficiency of JICs was observed under F3T2 treatment for up to ten cycles. However, it should be noted that the structural control during FTCs requires demanding conditions (with the aid of liquid nitrogen or dry ice+anhydrous ethanol), which might not be broadly applicable in the customers' level. In the future, to stabilize the initial internal structures of the JICs and form a denser polymer network with high degree of physical crosslinking, it is reasonable to add several cycles of fast cooling FTCs (F3T1) to the fabrication stage after the sol-gel transformation.

Jelly ice cubes (JICs) based on 10% gelatin hydrogels were proposed as a new type of food coolant. One of the challenges of practical use of the JICs was the structural stability against temperature variations during phase changes of water in the hydrogels since freezing and thawing rate endorse enormous impact on the properties of JICs. Here, systematic studies were delivered with various freezing and thawing rates applied on JICs to explore the ideal application conditions. Three freezing conditions, −20° C. (F1), −78.5° C. (F2) and −198° C. (F3), and three thawing rate, 0.05° C./min (T1), 0.25° C./min (T2), or 2.5° C./min (T3) were applied to the JICs in multiple cycles to test the changes of JICs in the latent heat of fusion, water content, mechanical properties, cooling efficiencies and hydrogel inner structures. The JICs treated with selected conditions showed much improved stability in water content, structural uniformity, heat-absorbing abilities, and lifecycles. With the treatment, the cooling efficiency of JICs remained stable after at least 10 times of use. Both rapid freezing rate and slow thawing rate assist the formation of uniform polymer networks under repeated freeze-thaw treatment.

JICs have shown very promising properties to be employed as a reusable, water-saving, safe, and environmentally friendly food cooling medium.

Example 7 illustrates the effects of cross-linking the hydrogel.

Due to the fact of crosslinking in the hydrogel 3-D network JIC structures affect the stability during repeated freezing and thawing, especially under F1 freezing condition, we believe if the JICs are made under F3 conditions with chemically crosslinked 3-D network structures form, additional repeated freezing operations under F1 conditions would not be able to easily damage the existing network and ice crystals in small sizes will be retained through the uses of the JICs. Thus, JICs made by a commercial provider will be conveniently used as a cooling medium and easily refrozen using their regular freezer.

Chemical crosslinking JIC has been tested with several benchmark chemical crosslinkers, glutaraldehyde (GTA) and 1-Ethyl-3-(3-dimethylaminopropyl)carbodiimide (EDC), and edible photosensitizers, water soluble vitamin B2 (flavin mononucleotide, FMN) and a water-soluble vitamin K3 (Menadione sodium bisulfite, MSB).

To address the concern of biological contamination and microbial growth of JICs during uses, two photosensitizers (MSB and FMN) were used to provide daylight-induced antimicrobial functions under store lighting conditions. Results show the amounts of biocidal reactive oxygen species (ROS), including hydroxyl radicals, hydrogen peroxide, and singlet oxygen, produced by the JICs containing different amounts of MSB.

Various crosslinking agents can be included to stabilize the structure of JICs and maximize the lifecycles of JICs. Here, we demonstrate the use of various types of crosslinkers in the JICs individually, which can also be used in a combination when needed. The static compressive modulus is used as the indicator for the hydrogel hardness and structural stability of JICs.

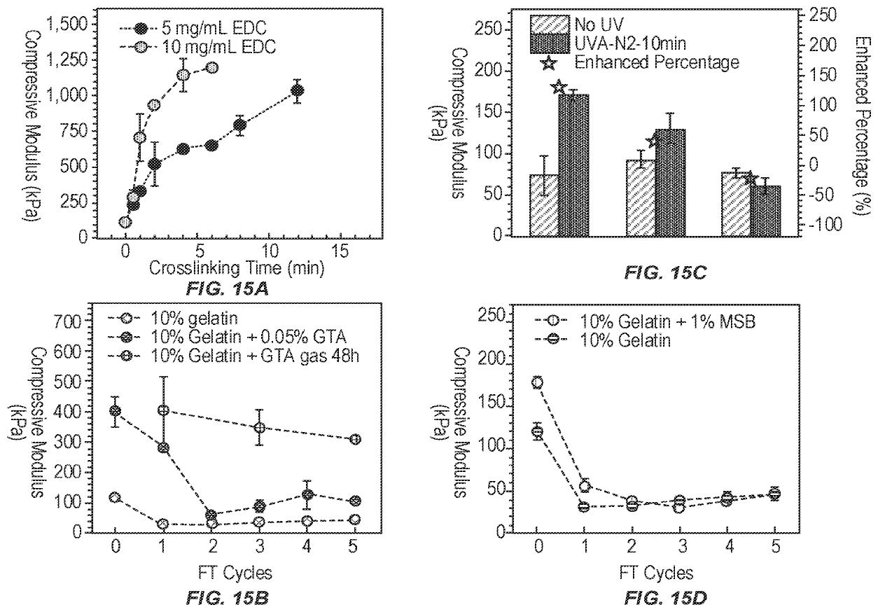

As shown in FIG. 15A, 1-Ethyl-3-(3-dimethylaminopropyl) carbodiimide (EDC), a widely used protein crosslinker in bioengineering, enhanced the compressive modulus of JICs by more than ten times, which presents high potential in increasing the maximum using cycles of JICs.

Glutaraldehyde, another broadly used crosslinker in the food and drug industry, also showed a promising mechanical strengthen effect on JICs in FIG. 15B. After five cycles of F1T2 (freeze under −20° C. and thaw at the ambient condition) treatment, the strength of JICs after crosslinking was twice (10% gelatin crosslinked with 0.05% GTA solution) or six times (10% gelatin crosslinked with GTA vapor) that of the JICs without crosslinking (10% gelatin).

Photo-sensitizers are another category of chemicals crosslinking proteins with higher sustainability and lower toxicity. Menadione sodium bisulfite (MSB, a water-soluble form of Vitamin K derivatives), and Riboflavin 5′-phosphate sodium (flavin mononucleotide, FMN, a water-soluble form of Vitamin B2) both show good crosslinking effect towards 10% gelatin hydrogels, as shown in FIG. 15C and FIG. 15D.

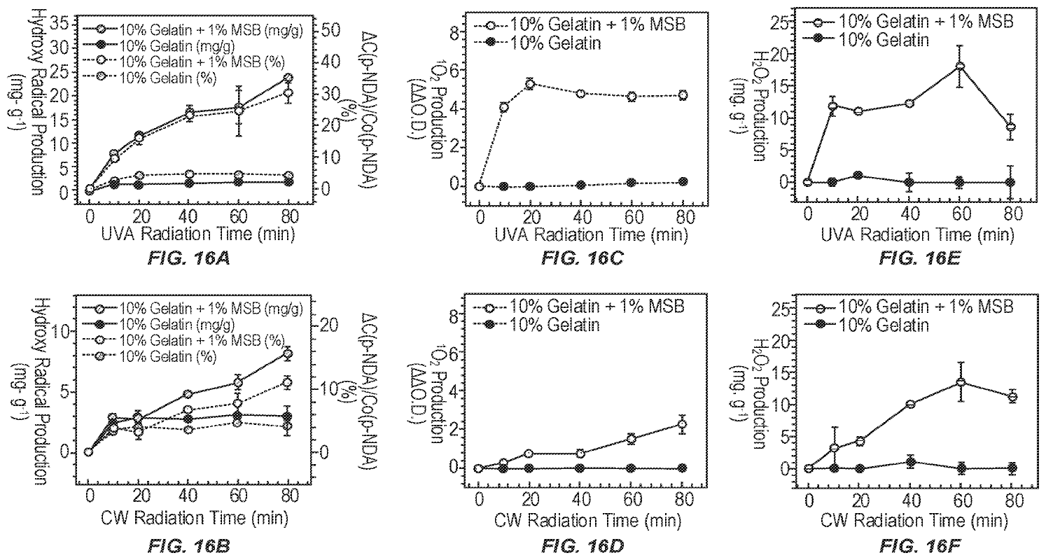

Photo-sensitizers included in the JICs not only functions as the photo-initiator of crosslinking reactions. MSB also functions as the antimicrobial compound providing JICs with self-cleaning functions during repeated using cycles. As shown in FIG. 16, under both UVA radiation and cool-white radiation, JICs prepared with 10% gelatin and 1% MSB generated considerable amount of reactive oxygen species (ROS) including hydroxyl radicals, singlet oxygen, and hydrogen peroxide. All of the presented ROS have antimicrobial functions and are able to equip JICs with self-cleaning functions.

### Example 8

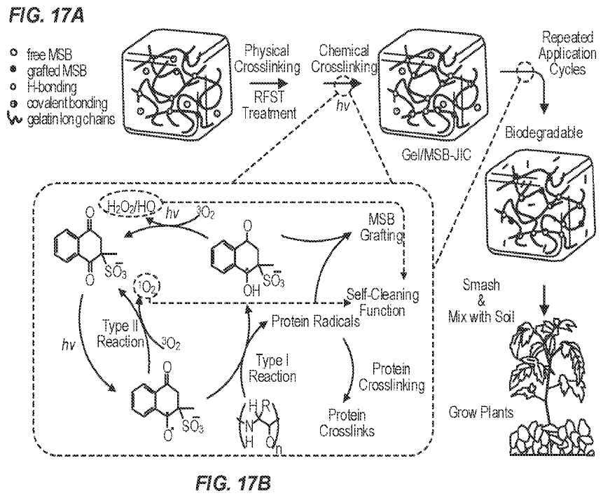

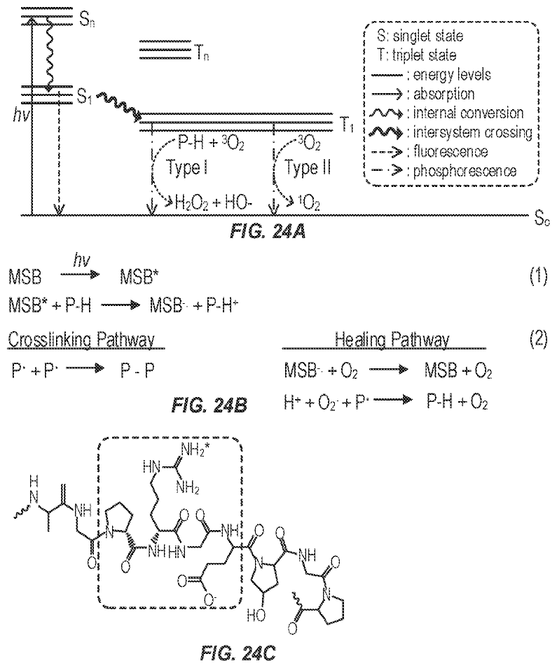

MSB is a food-grade chemical with proven photo-activity under UVA (315-400 nm) or UVB (285-315 nm) irradiation, a UV range with relatively high penetration power in protein media for photo-induced crosslinking. (See, Z. Zhang, N. Wisuthiphaet, N. Nitin, L. Wang, R. Kawakita, T. Jeoh, G. Sun, ACS Sustain Chem Eng 2021. DOI:10.1021/acssuschemeng.1c0269; Ö. Hakli, C. Karapire, Y. Posokhov, S. Içli, J Photochem Photobiology Chem 2004, 162, 283.) As shown in FIG. 17B and FIG. 24A-B, ground state MSB can be excited to its singlet excited state under proper photo-irradiation, which then spontaneously transferred to the triplet excited state via internal conversion and intersystem crossing consecutively. Because of the oxidative property and relatively long lifetime, MSB at the triplet excited states can afterwards initiate a series of photoreactions through either a type I (electron/hydrogen transfer) or type II (energy transfer) reaction, both of which can play a role in protein photo-crosslinking reactions with multiple photosensitizers. (See, C. M. Wertheimer, C. Elhardt, S. M. Kaminsky, L. Pham, Q. Pei, B. Mendes, S. Afshar, I. E. Kochevar, Invest Ophth Vis Sci 2019, 60, 1845; M. B. Applegate, B. P. Partlow, J. Coburn, B. Marelli, C. Pine, R. Pineda, D. L. Kaplan, F. G. Omenetto, Adv Mater 2016, 28, 2417; C. E. Catalano, Y. S. Choe, P. R. O. de Montellano, J Biol Chem 1989, 264, 10534; M. J. Davies, Photochem Photobio S 2003, 3, 17; M. Dizdaroglu, E. Gajewski, P. Reddy, S. A. Margolis, Biochemistry-us 1989, 28, 3625; Y. Kato, K. Uchida, S. Kawakishi, Photochem Photobiol 1994, 59, 343.) The type II reaction between oxygen and triplet MSB has been proven theoretically and experimentally by Zhang et al. (See, Z. Zhang, N. Wisuthiphaet, N. Nitin, L. Wang, R. Kawakita, T. Jeoh, G. Sun, ACS Sustain Chem Eng 2021. DOI: 10.1021/acssuschemeng.1c0269). Despite reports on protein crosslinking induced by singlet oxygen or hydroxyl radicals, researchers proposed that a type II reaction might not be the primary mechanism. (See, M. B. Applegate, B. P. Partlow, J. Coburn, B. Marelli, C. Pine, R. Pineda, D. L. Kaplan, F. G. Omenetto, Adv Mater 2016, 28, 2417; Y. Kato, K. Uchida, S. Kawakishi, Photochem Photobiol 1994, 59, 343.) In this article, we focus on the protein crosslinking induced by type I reactions of MSB in the triplet state. A type I reaction requires proper hydrogen donors for a satisfying reaction rate at the hydrogen abstraction step. Thus, to validate the feasibility of protein photo-crosslinking using MSB, the Gibbs free energy changes (ΔG) in the hydrogen abstraction steps of type I reaction were calculated regarding different situations.

FIG. 17A shows the assembly and life cycle of the JICs. JICs are based on a chemically and physically crosslinked gelatin hydrogel system with microbial-resistant, reusable, and biodegradable functions to serve as a highly efficient stationary coolant. The repeated RFST treatment of hydrogels enhances the physical crosslinking of the polymeric 3D framework during multiple fabrication-freeze-thaw cycles (FFTCs). Chemical crosslinking was introduced following the RFST treatment to stabilize the delicate 3D structure formed and inhibit reduction of physical crosslinking caused by the swelling of gelatin chains during thawing. More importantly, chemical crosslinking of gelatin at the stage of preformed polymer network structures is assumed to be ideal for fixing the gelatin frameworks and retaining the mechanical strength and structural stability of JICs during the following application freeze-thaw cycles (AFTCs). The designed photo-induced crosslinking of the preformed gelatin network structure by MSB is a concept-proving work. After AFTCs, the used JICs can be smashed and composted in potting soil. The following sections discuss the fabrication, application, and composting of JICs stepwise.

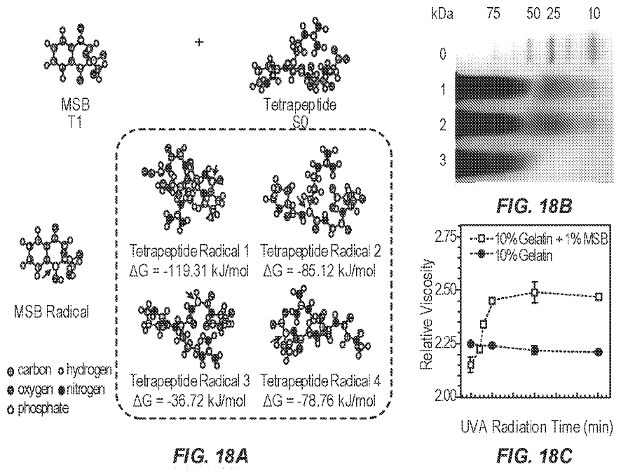

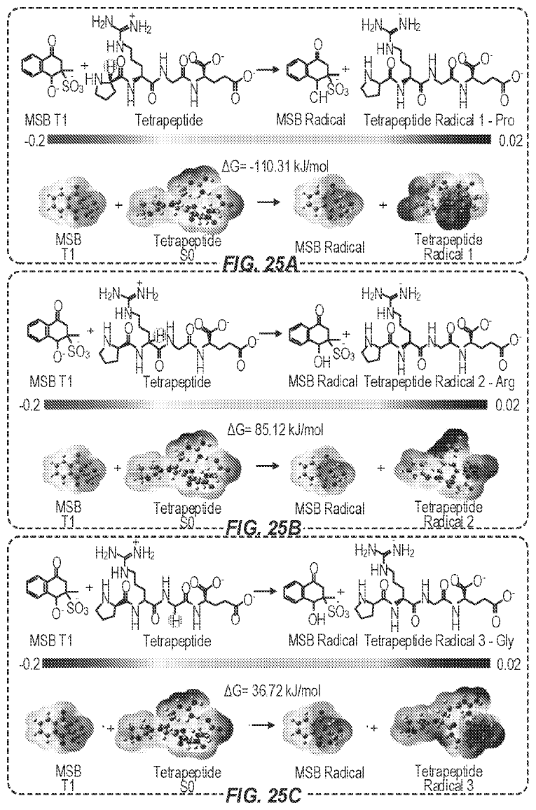

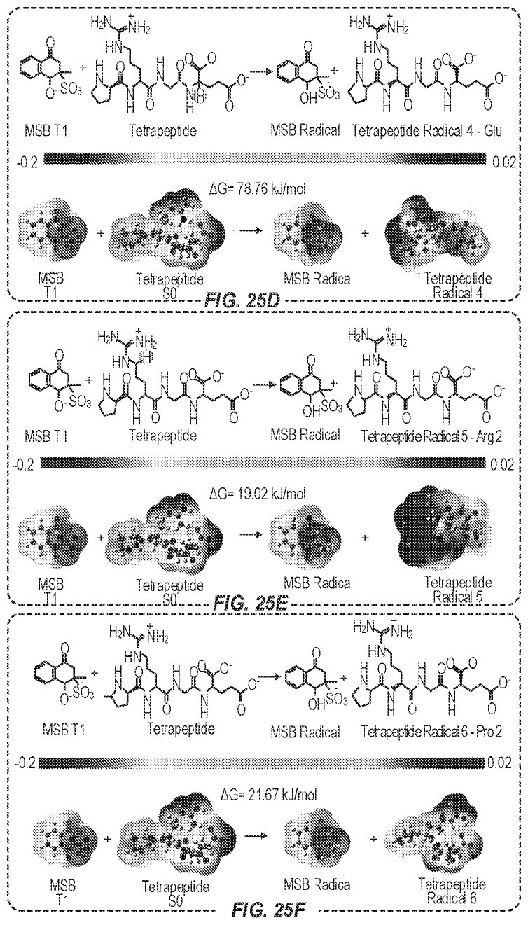

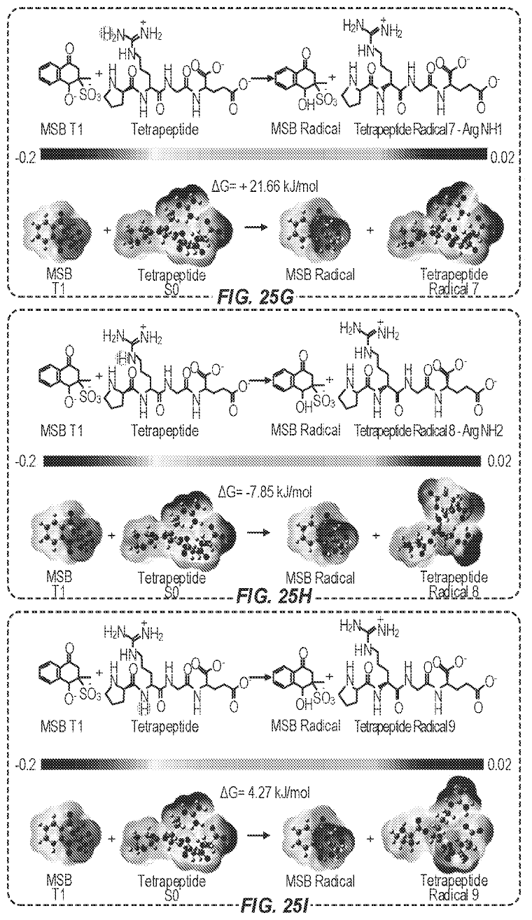

Gaussian modeling package was used to compute the ΔG values of potential reactions between MSB and gelatin in water. A gelatin molecule was represented by a tetrapeptide unit consisting of the four primary types of amino acids in gelatin, in the sequence of proline (Pro)—arginine (Arg)—glycine (Gly)—glutamic acid (Glu), according to the reported amino acid profiles and representative structures of gelatin shown in FIG. 24C. (See, S. Kommareddy, D. B. Shenoy, M. M. Amiji, 2003; Y. Pranoto, M. Istigani, U. Santoso, L. A. Lestari, Y. Erwanto, A. Rohman, Kne Life Sci 2016, 3, 92.) Multiple hydrogens in the tetrapeptide structure can be potential hydrogen donors reacting with the triplet MSB. The intricate situations are depicted in FIG. 25. According to previous studies, the hydrogen abstraction most readily happens on the α-C—H bond. (See, E. R. Stadtman, R. L. Levine, Amino Acids 2003, 25, 207; E. R. Stadtman, Free Radical Res 2009, 40, 1250; E. R. Stadtman, B. S. Berlett, Chem Res Toxicol 1997, 10, 485.) Meanwhile, hydrogens on peptide N—H bonds may also be hydrogen donors, considering bond energies. FIG. 25(A-D) presents the ΔG values for the abstraction of hydrogens attached to the α-carbons of Pro (ΔG=−119.31 kJ·mol⁻¹), Arg (ΔG=−85.12 kJ·mol⁻¹), Gly (ΔG=−36.72 kJ·mol⁻¹), and Glu (ΔG=−78.76 kJ·mol⁻¹), respectively. Other patterns of hydrogen abstraction are less thermodynamically possible according to their ΔG values, including the one on the α-carbons of the guanidino group (FIG. 25(E), ΔG=−19.02 kJ·mol⁻¹), the one on the C4 of the pyrrolidine ring (FIG. 25(F), ΔG=21.67 kJ·mol⁻¹), the ones in the guanidino group (FIG. 25 (G-H) ΔG=21.66 kJ·mol⁻¹ or −7.85 kJ·mol⁻¹), and a representative amide hydrogen (FIG. 25 (I), ΔG=4.27 kJ·mol⁻¹). The ΔG values of hydrogen abstraction from α-carbons are highly negative, whereas those not from α-carbons show ΔG around or above zero. Specifically, the hydrogen abstraction from N—H bonds is above zero (ΔG=4.27 kJ·mol⁻¹), presenting low thermodynamic possibility. The computational results indicate that the most likely thermodynamic path in the reaction is the abstraction of the hydrogens from α-carbons in gelatin by the triplet MSB molecule, such as proline sites, as summarized in FIG. 18A. However, kinetically speaking, the polymeric radicals generated on the protein backbones are sterically hindered for effective crosslinking of gelatin molecules, and the radicals on side chains of gelatin (on the side groups of Pro, Arg or other amino acids) might have higher possibilities to participate in the protein crosslinking.

Measurements of protein molecular weight and solution were employed to verify the MSB-induced photo-crosslinking. (See, J. Zou, N. Nguyen, M. Biers, G. Sun, ACS Sustain Chem Eng 2019, 7, 8117; J. Zou, N. T. H. Nguyen, M. D. Biers, G. Sun, ACS Agric Sci Technology 2021, 1, 11; ASTM D446-12(2017), Standard Specifications and Operating Instructions for Glass Capillary Kinematic Viscometers.) Solutions of 10% gelatin containing 0% or 1% MSB were prepared, irradiated under UVA (365 nm), and diluted for electrophoresis tests. FIG. 18B shows that compared to the pure gelatin solution (lane 1), the addition of MSB (lane 2) did not cause an observable change in the molecular weight of gelatin macromolecules. However, after 60 min of UVA irradiation, the molecular weight of gelatin increased significantly, with the lowest weight range increasing from around 10 kDa to about 50 kDa. A generous portion of the macromolecules with even higher molecular weights stacked at the separation band (outside of the picture shown in FIG. 18B), resulting in a lighter color in lane 3. Also, a significant increase in the viscosity of the gelatin/MSB solution was observed, as shown in FIG. 18C. The viscosity increases mirror the findings reported by Shen et al., reflecting the effectiveness of the photo-crosslinking reaction. (See, H. R. Shen, J. D. Spikes, P. Kopečeková, J. Kopeček, J Photochem Photobiology B Biology 1996, 34, 203.)

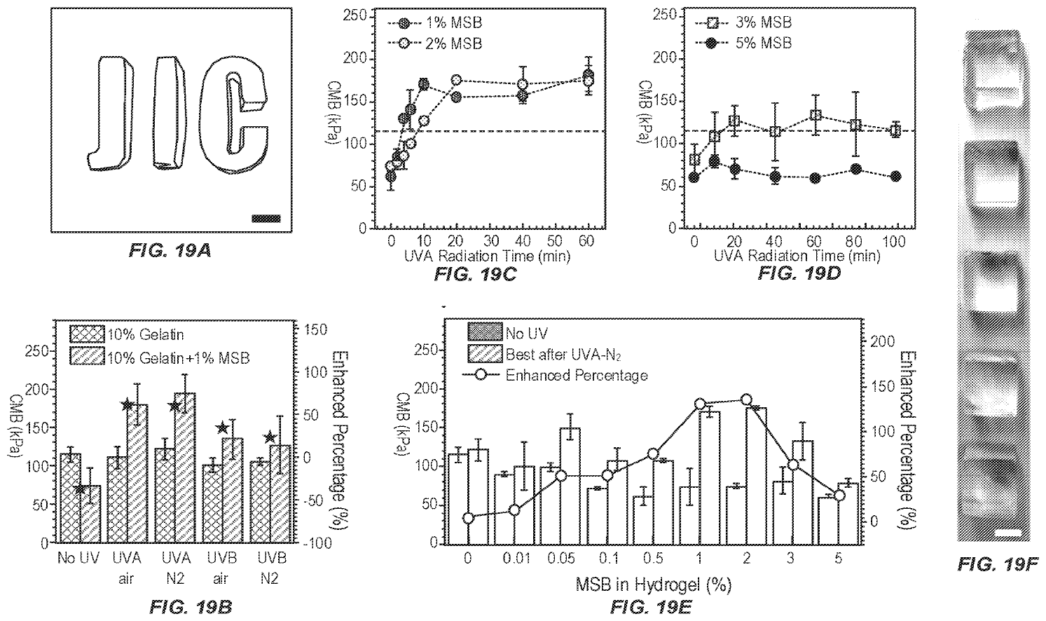

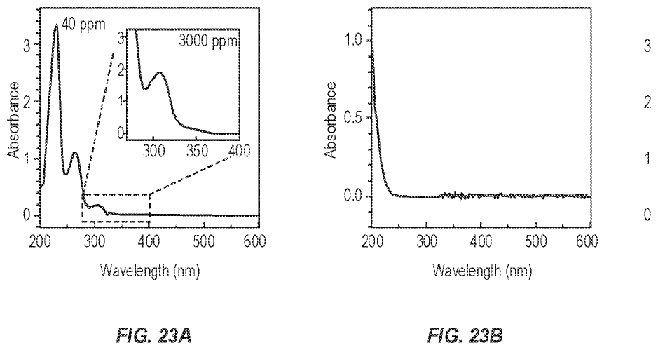

The fabrication of the chemically crosslinked JICs was based on radical reactions of gelatin induced by MSB under UV irradiation. UVA (365 nm) and UVB (312 nm) for were selected to be studied because of their high energy to excite the MSB molecules and strong absorbance on the UV-Vis spectrum of MSB, as shown in FIG. 23A. (See, Z. Zhang, N. Wisuthiphaet, N. Nitin, L. Wang, R. Kawakita, T. Jeoh, G. Sun, ACS Sustain Chem Eng 2021. DOI: 10.1021/acssuschemeng.1c0269) Nevertheless, their performance in photo-crosslinking may be different, as UVB has higher energy (FIG. 23A), whereas UVA has better penetrating ability (FIG. 23B). Homogeneous gelatin/MSB solutions were prepared in a warm water bath (40° C.), poured into silica molds of any desired shape for gelation, demolded and photo-crosslinked under various conditions, as detail described in Experimental Section. FIG. 19A shows prepared frozen JICs in multiple shapes and sizes, demonstrating the flexibility of prepared frozen JICs in various shapes and sizes of JICs. For the simplicity of experiments and theoretical analysis, 10 mm×10 mm×10 mm cubic samples were used for most of the tests and characterizations described in this article.

First, to explore the best light source and gaseous environment for crosslinking, hydrogels with 10% gelatin and 1% MSB without any treatment were used as the control group. UVA or UVB irradiation under N₂ protection or in the air were applied to the hydrogels. Extended irradiation time (60 min) was used to ensure the reaction reached equilibrium. The compressive modulus at break (CMB) was used as the indicator of the hardness and mechanical strength of the hydrogel. Meanwhile, 10% gelatin hydrogels treated under the corresponding conditions were used as reference. As shown in FIG. 19B, the CMB of 10% gelatin+1% MSB hydrogels was 73.8 kPa on average before irradiation, 180.1 kPa without N₂ protection and 194.3 kPa with N₂ protection after 60 min of UVA irradiation, and 134.7 kPa without N₂ protection and 127.0 kPa with N₂ protection after 60 min of UVB irradiation. Both UVA and UVB irradiation triggered effective crosslinking reactions, but higher-energy UVB might also have damaged protein chains and networks with a long exposure time. UVA irradiation might have caused less damage to the proteins in the hydrogels, explaining the better result in crosslinked products. Meanwhile, the N₂ protection showed a slight enhancement in CMB under UVA. This finding agrees well with what was reported by Applegate et al. and Kato et al. (See, M. B. Applegate, B. P. Partlow, J. Coburn, B. Marelli, C. Pirie, R. Pineda, D. L. Kaplan, F. G. Omenetto, Adv Mater 2016, 28, 2417; Y. Kato, K. Uchida, S. Kawakishi, Photochem Photobiol 1994, 59, 343.) According to Kato et al., superoxide anion radicals (·O₂⁻) generated in the photochemical reaction in an aerobic environment strongly inhibit the crosslinking efficiency by providing a healing pathway, as shown in FIG. 24B. (See, Y. Kato, K. Uchida, S. Kawakishi, Photochem Photobiol 1994, 59, 343.) An N₂ gaseous environment reduces the protein degradation that occurs with the presence of oxygen under UV light. On the other hand, based on the results, the elimination of 02 in the reaction environment reduced singlet oxygen formation and promoted protein crosslinking. Therefore, gelatin hydrogels with or without the addition of MSB were irradiated using only UVA radiation under the protective N₂ environment in the following tests.

Next, the irradiation time necessary for the photo-crosslinking reaction and the appropriate MSB concentration to crosslink a 10% gelatin hydrogel system were studied. From 0% to 5% MSB was mixed into the 10% gelatin hydrogel precursor solution. FIG. 19C-D shows the mechanical strengthening trend against UVA irradiation time of 10% gelatin hydrogels containing 1%, 2%, 3% or 5% MSB. As a reference, gray dash lines present the CMB of a 10% gelatin hydrogel before irradiation (115.4 kPa). When 1% MSB was added to the 10% gelatin system, the hardness of the hydrogel increased quickly in the first 10 min of UVA radiation, reaching an average of 170.6 kPa CMB at 10 min, and varied little with prolonged irradiation time, which agrees with the results in Table S1.

| | |
|---|---|
| UVA Radiation Time | Degree of Crosslinking |
| (min) | (%) |

| | | |
|---|---|---|
| 0 | min | 78.67 ± 0.27 |
| 2 | min | 82.58 ± 0.93 |
| 4 | min | 83.73 ± 0.54 |
| 6 | min | 84.83 ± 1.47 |
| 10 | min | 85.47 ± 2.09 |
| 30 | min | 84.78 ± 1.14 |
| 60 | min | 84.55 ± 1.14 |

For hydrogels with 2% MSB, a longer irradiation time was needed to reach the highest value of CMB at 175.8 kPa at 50 min. When the concentration of MSB was increased to 3% or 5%, the change in mechanical strength after photo-crosslinking was much less significant or even deleterious. After 60 min of UVA radiation, the average CMB of the 10% gelatin+3% MSB hydrogel was 133.1 kPa, and the CMB of 10% gelatin+5% MSB hydrogel never reached the CMB of the reference (10% gelatin hydrogel).

Several factors might have resulted in the observed phenomena. First, before the photo-irradiation, the presence of small MSB molecules could disturb the original physical crosslinking of the homogenous gelatin hydrogel. Second, upon UVA irradiation, excited MSB molecules abstracted hydrogen from protein molecules, forming a variety of protein radical species, which could induce subsequent chemical crosslinking among protein chains. An appropriate increase in the MSB concentration could lead to a higher degree of chemical crosslinking of gelatin during the process. However, the excessively high concentration of MSB might lead to aggregation-caused self-quenching, significantly reducing the generation of protein radicals. Apart from the quenching effect, the steric hindrance of protein chains might be another factor reducing the effectiveness of photo-crosslinking of the proteins. Also, the large amount of MSB on the surface of the JICs could have absorbed and shielded the UV light and reduced the light penetration depth. With a higher concentration of MSB in the system (10% gelatin+5% MSB), the amount of MSB that appeared on the surface of the hydrogel quintupled, as in hydrogels with 10% gelatin+1% MSB. The MSB on the surface could absorb UV light, crosslink protein, and block UV irradiation, greatly reducing the intensity of UV light penetrating into the inner part of the hydrogel and consequently decreasing the degree of crosslinking in the core of the hydrogel. The high MSB concentration on hydrogel surfaces may also result in a surface hardening effect due to the predominant surface crosslinking.

FIG. 19E presents a more detailed study of the effects of MSB concentration on the 10% gelatin hydrogel system. Hydrogels with MSB concentrations below 1% were irradiated for 60 min to ensure that the reaction reached equilibrium. Those with MSB concentrations higher than 1% were treated under specific concentrations and times (1% at 10 min, 2% at 30 min, 3% at 60 min and 5% at 60 min) to achieve the best CMB values. The percentage of enhancement in the CMB was calculated following Equation (S2) in the Experimental Section. Since material's weakest spot determines the breaking point, hydrogels with the highest MSB concentration ended up with low CMB in the tests even though they might have harder surfaces. With low MSB concentration (<1%) in the hydrogel system, the mechanical enhancement due to the photo-crosslinking by UV irradiation was not significant. Although the CMB of the crosslinked hydrogels with 0.05% MSB was high, it might have been caused by the heat-induced crosslinking as the hydrogel before the irradiation also showed a relatively high CMB while the increase in the CMB after irradiation was weaker compared to other samples. The degree of crosslinking is shown in Table S1 with the 10% gelatin+1% MSB hydrogels after various irradiation durations. Based on FIG. 19E and Table S1, 1% MSB and UVA irradiation time of 10 min were selected as the preferred conditions in the photo-crosslinking of 10% gelatin hydrogel. FIG. 19F shows the appearances of the gelatin hydrogels with MSB in concentrations of 0%, 0.05%, 0.10%, 0.50%, and 1.00% (top to bottom), respectively. One of the advantages of MSB as a new type of photo-crosslinker of proteins is the minor color alteration observed in the base materials, compared to many other photosensitizers. (See, C. M. Wertheimer, C. Elhardt, S. M. Kaminsky, L. Pham, Q. Pei, B. Mendes, S. Afshar, I. E. Kochevar, Invest Ophth Vis Sci 2019, 60, 1845; S. Hayes, C. S. Kamma-Lorger, C. Boote, R. D. Young, A. J. Quantock, A. Rost, Y. Khatib, J. Harris, N. Yagi, N. Terrill, K. M. Meek, PLoS ONE 2013, 8; R. W. Redmond, I. E. Kochevar, Photochem Photobiol 2019, 95, 1097; M. B. Applegate, B. P. Partlow, J. Cobum, B. Marelli, C. Pirie, R. Pineda, D. L. Kaplan, F. G. Omenetto, Adv Mater 2016, 28, 2417.)

Overall, in this section, 10% gelatin with 1% MSB irradiated under UVA light for 10 min under the protection of N₂ was selected as the optimized photo-crosslinking condition of JICs. In the following discussions, the JICs crosslinked under the above conditions are referred to as Gel/MSB hydrogel. For reference, 10% gelatin hydrogels without any modifications were also fabricated and referred to as Gel hydrogel.

The Impact of Chemical Crosslinking and Improved Performance of JICs

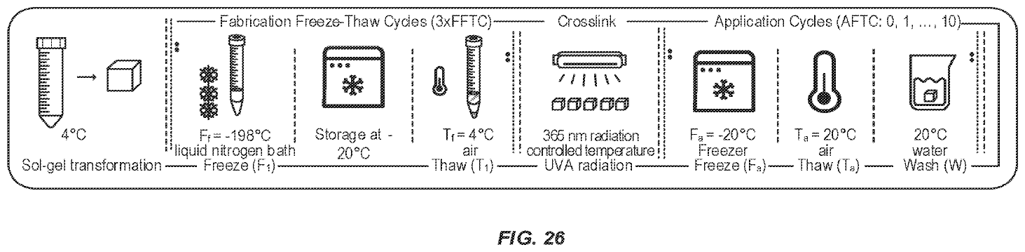

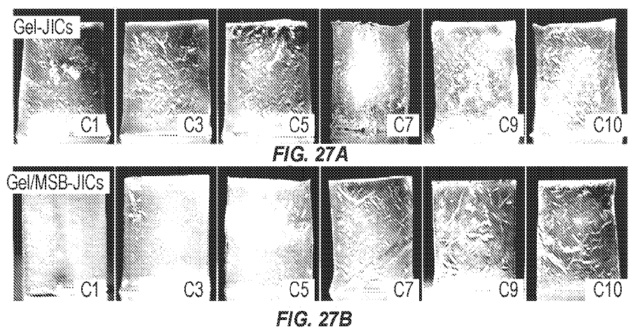

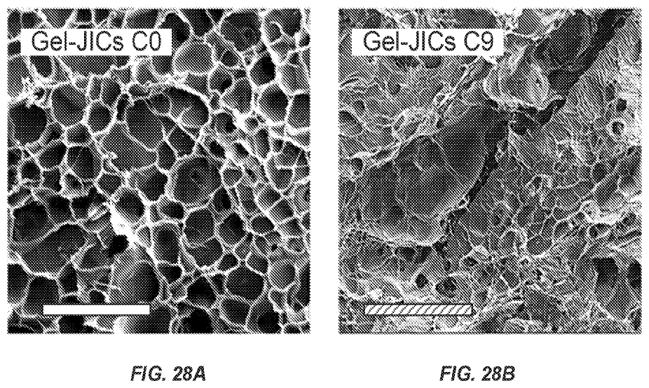

Previous studies found that cyclic FT treatments significantly damaged the 3D structure of JICs based on 10% gelatin hydrogels when subjected to a freezing temperature of −20° C. and a thawing temperature of 20° C. Rapid-freezing-slow-thawing (RFST) treatment with the aid of liquid nitrogen stabilizes the hydrogel structures by rapid nucleation of ice grains in smaller sizes, which alters the physical crosslinking of the gelatins to form delicate network structures. (See, J. Zou, L. Wang, G. Sun, ACS Sustain Chem Eng 2021, 9, 15357; J. Zou, L. Wang, G. Sun, ACS Sustain Chem Eng 2021, 9, 15365.) Photo-induced chemical crosslinking can be employed subsequently to consolidate the established delicate structures. Based on the assumptions, a detailed proof-of-concept hydrogel assembling method is demonstrated in FIG. 26. The crosslinking of Gel/MSB-JICs includes two steps: 1) the solidified hydrogel containing 10% gelatin and 1% MSB first went through three fabrication-freeze-thaw cycles (3×FFTCs) to refine the polymer network stabilized by H-bonds; 2) the formed hydrogels were photo-irradiated under UVA (365 nm) with the N₂ gaseous protection for 10 min. A control group of Gel-JICs was also prepared using the same fabrication strategy. After the two fabrication steps, we named the tuned materials Gel/MSB-JICs or Gel-JICs, as contrasted to Gel or Gel/MSB, which was prepared without RFST treatment.

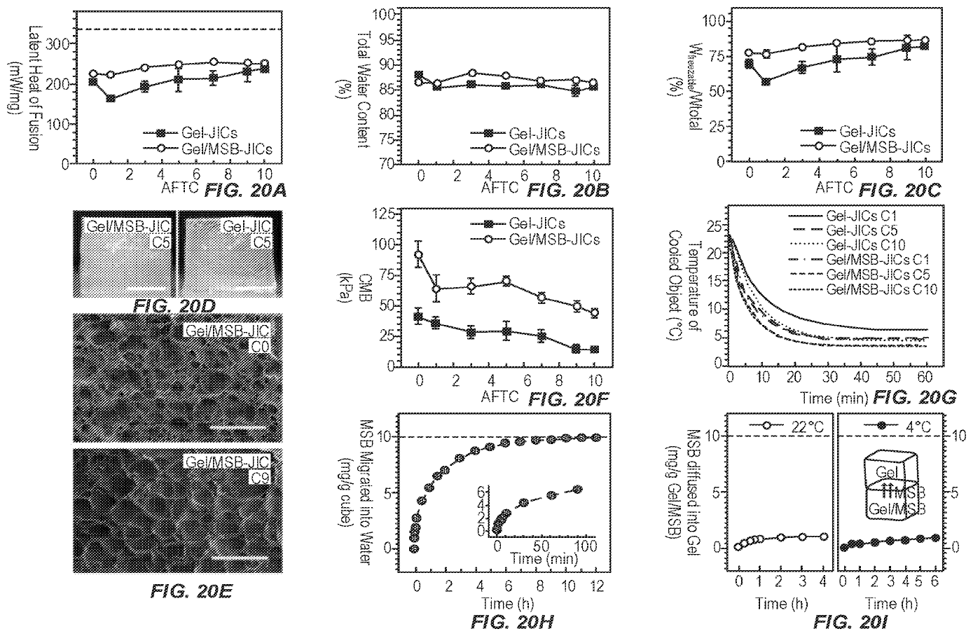

FIG. 20 shows functional and structural properties of Gel/MSB-JICs and Gel-JICs. (A) The latent heat of fusion of Gel/MSB-JICs and Gel-JICs after application freeze-thaw cycles (AFTCs). (B) The total water content of Gel/MSB-JICs and Gel-JICs after various numbers of AFTCs. (C) The freezable water content of Gel/MSB-JICs and Gel-JICs after various numbers of AFTCs. (D) The cross-section of Gel/MSB-JICs and Gel-JICs after AFTC5 (C5), with a white scale bar of 5 mm. (E) The SEM image of lyophilized Gel/MSB-JICs before AFTC (C0) and after AFTC9 (C9), with a yellow scale bar of 200 μm. (F) The CMB of Gel/MSB-JICs and Gel-JICs after various numbers of AFTCs. (G) The cooling curves of Gel/MSB-JICs and Gel-JICs after AFTC1 (C1), AFTC5 (C5) and AFTC10 (C10). (H) The amount of MSB diffused from Gel/MSB to water at ambient conditions. (I) The amount of MSB transferred from Gel/MSB to Gel at 22° C. and −4° C. Data are expressed as mean±SD of at least three replicates.

In the experiment, we found that the CMB of Gel dropped from 115.38 kPa to 41.25 kPa after 3×FFTCs and before the photo-crosslinking step. This observation is consistent with what was found in the earlier study. (See, J. Zou, L. Wang, G. Sun, ACS Sustain Chem Eng 2021, 9, 15365.) The CMB remained nearly unchanged after the subsequent photo-irradiation. In comparison, Gel/MSB had an initial CMB of 61.97 kPa before FFTC. The CMB increased to 73.37 kPa after 3×FFTCs and further raised to 91.93 kPa after photo-irradiation. It is speculated that the photo-crosslinking of Gel/MSB could have started since the MSB was mixed into the gelatin solution and during gelation. Though amber tubes and aluminum foil were used to reduce light exposure during FFTCs, slight photoexcitation was inevitable during the complex operations. It should also be noted that the addition of MSB to the hydrogel was not able to prevent the formation of ice grains; after 3×FFTCs, the polymer network of Gel/MSB was still damaged by ice grains formed during phase changes. This outcome is also why the Gel/MSB-JICs (with RFST treatment) had a lower CMB than the Gel/MSB hydrogel (without RFST treatment).

Different from previous studies, we included a 10-min water rinsing at the end of each application freeze-thaw cycle (AFTC) considering the impact of water rinsing on cooling efficiency and mechanical properties of the JICs in this study. The water rinsing step brought our experiment closer to the recommended actual application conditions of JICs since a cleaning step is necessary for the reuse of JICs. FIG. 20 demonstrates the primary functions and properties of Gel/MSB-JICs before and after AFTCs compared with Gel-JICs. The latent heat of fusion, total water content, and the percentage of freezable water in the total water content of both types of JICs were studied. Because of the water rinsing steps, the latent heat of fusion of both Gel-JICs and Gel/MSB-JICs did not decrease but rather slightly increased after 10 AFTCs, as shown in FIG. 20A. The latent heat of fusion of Gel/MSB-JICs was on average 225.13 J/g at AFTC0, and gradually increased to 250.38 J/g (equivalent to 74.9% of the latent heat of traditional ice) after 10 AFTCs. Interestingly, the latent heat increase of Gel-JICs across 10 AFTCs was more significant than the Gel/MBS-JICs, which might result from the reduced hydrophilicity of the polymer framework of the Gel/MSB-JICs after chemical crosslinking. FIG. 20B-C show that the total water content of Gel/MSB-JICs was similar to Gel-JICs, while the freezable water content of Gel/MSB-JICs was noticeably higher than that of the Gel-JICs. The total water content of both JICs fluctuated in the range of 84.9%-88.6%. However, the ratio between freezable water and the total water content of the Gel/MSB-JICs was at 77.7% at AFTC0, a considerably higher level than the Gel-JICs at 70.0%. After AFTC10, the percentage of freezable water was maintained at 86.5% for Gel/MSB-JICs and 82.3% for Gel-JICs. From the results above, the water rinsing step is proven effective in retaining the freezable water content in both Gel/MSB-JICs and Gel-JICs, compared to the results in our previous studies.

The observed changes in latent heat and water profile validates the assumptions that chemical crosslinking stabilizes the heat-absorbing ability of JICs. After photo-crosslinking by MSB, the polymer framework of Gel/MSB-JICs became less hydrophilic and less swellable, as the newly formed covalent bonds take the places of the original H-bonds in the gelatin hydrogels. This change reduces the interaction between water molecules and the polymer chains, reducing the percentage of combined non-freezable water in the hydrogel and increasing the freezable water content. Since the latent heat of fusion around 0° C. is contributed by the free water and freezable combined water, the latent heat of fusion of Gel/MSB-JICs was also higher than Gel-JICs at AFTC0 because of its higher freezable water content.

FIG. 20D and FIG. 27 show the cross-sectional images of a Gel/MSB-JIC and a Gel-JIC and after AFTCs. After AFTC5, Gel/MSB-JICs had less visible damage to the naked eyes caused by the ice grains formed during the cyclic AFTCs. The SEM images of the lyophilized hydrogels are shown in FIG. 20E and FIG. 28, consistent with what is found in FIG. 20D. Unlike the behavior of the original JICs, the polymeric framework of Gel/MSB-JICs had much less damage and fewer major long cracks. (See, J. Zou, L. Wang, G. Sun, ACS Sustain Chem Eng 2021, 9, 15357.) The microstructure changes explain the mechanical properties presented in FIG. 20F, where significant differences can be observed between Gel-JICs and Gel/MSB-JICs. At AFTC0, the CMB of the Gel/MSB-JICs was on average 91.93 kPa, more than twice the CMB of Gel-JICs (41.25 kPa). Although the mechanical strengths of both Gel-JICs and Gel/MSB-JICs were reduced during the cyclic AFTCs, the CMB of Gel/MSB-JICs was almost twice that of the Gel-JICs at the same AFTC. At AFTC5, the CMB of the Gel/MSB-JICs was 69.92 kPa, whereas the CMB of Gel-JICs was 29.31 kPa. At AFTC10, the CMB was 44.05 kPa for the Gel/MSB-JICs and 14.58 kPa for Gel-JICs. These results prove that the photo-crosslinking of gelatin network structures enhanced the mechanical stability and reduced structural damage to Gel/MSB-JICs during application cycles (FIG. 20D). Also, the chemical crosslinking prevents additional physical crosslinking of gelatin molecules during the AFTCs. With the generation of a more rigid polymer framework, the growth of ice grains during each freezing step in AFTCs was limited in a defined space within the polymer network. Meanwhile, the effect of RFST treatment in stabilizing the polymer network can be observed by comparison with what was found in our previous study on hydrogels without RFST treatment or photo-crosslinking, where the CMB dropped from 115.37 kPa to 23.34 kPa after AFTC1 and remained below 30 kPa afterward. (See, J. Zou, L. Wang, G. Sun, ACS Sustain Chem Eng 2021, 9, 15357.) The RFST treatment could produce delicate network structures and increased physical crosslinking of gelatin, though the networks were still less stable than the chemically crosslinked ones. With the combination of RFST treatment and photo-crosslinking, JICs were transformed into a much more robust PCM compared than reported in earlier studies. (See, J. Zou, L. Wang, G. Sun, ACS Sustain Chem Eng 2021, 9, 15365.)

To study the performance of JICs when cooling other objects, the temperature profile at the center of the upper surface of the object cooled (PVA hydrogels) was recorded in the same manner described in Zou et al. (See, J. Zou, L. Wang, G. Sun, ACS Sustain Chem Eng 2021, 9, 15357; J. Zou, L. Wang, G. Sun, ACS Sustain Chem Eng 2021, 9, 15365.) As shown in FIG. 20G, the cooling efficiency of the Gel/MSB-JICs was much higher than the cooling efficiency of Gel-JICs at various AFTCs. After being cooled by the Gel-JICs for 60 min, the temperature of the cooled object dropped from around 22.5° C. to 6.3° C. at AFTC1, 4.9° C. at AFTC5, and 4.7° C. at AFTC 10, whereas when the same object was cooled by Gel/MSB-JICs, the final temperature reached 4.8° C. at AFTC1 and 3.6° C. at AFTC5 and AFTC 10. The temperature profiles of the cooled objects demonstrated the heat-absorbing ability of both JICs, agreeing well with their water profile and latent heat of fusion.

Another concern regarding employing Gel/MSB-JICs is the potential diffusion of MSB into the surrounding environment or cooled objects. Based on the photo-crosslinking reaction, most MSB still exists as free molecules dispersed in the polymer network of JICs. Restraining MSB within the hydrogel structure is essential for material safety while providing a microbial-resistant function throughout the lifetime of JICs. Due to the high hydrophilicity of MSB, it was assumed that the fastest mass transfer of MSB happened in hydro-rich environments. Water bath and Gel-JICs were used to study the migration of MSB from Gel/MSB-JICs to the surrounding water or a contacting hydro-rich object, respectively, as depicted in FIG. 20H and FIG. 20I. Interestingly, FIG. 20H shows that after extensively long immersion in water (12 h), 99.6% of added MSB in Gel/MSB-JICs was released into the water bath, indicating that only a negligible amount of MSB was grafted or consumed during the photo-crosslinking step. At the same time, considering the application of JICs, sanitization rinse of JICs should not exceed 10 min per application cycle unless extreme conditions are required. The diffusion of residual MSB from the Gel/MSB-JICs into water was slow, and only around 2.67 mg·g⁻¹ could be washed off in 10 min and around 5.40 mg·g⁻¹ in 1 h. Another potential loss of MSB is caused by diffusion through direct solid-solid contact, as shown in FIG. 20I. Results show that the diffusion of MSB from Gel/MSB-JICs to Gel was minimal. Under the ambient condition, 0.70 mg·cm⁻² MSB was transferred to Gel after 1 h, and 0.93 mg·cm⁻² after 4 h. At 4° C., 0.26 mg·cm⁻² was transferred to Gel after 1 h and 0.57 mg·cm⁻² after 4 h, and 0.83 mg·cm⁻² after 6 h. When the temperature of the Gel/MSB-JICs is lower, the molecular movement will be limited, as will the diffusion rate. Also, if the Gel/MSB-JICs were applied to cool less hydro-rich objects, the major parts of MSB leaving Gel/MSB-JICs will be through the water rinsing steps, in which case at AFTC 10, around 3.55 mg·g⁻¹ MSB should remain within Gel/MSB-JICs for potential microbial-resistant functions.

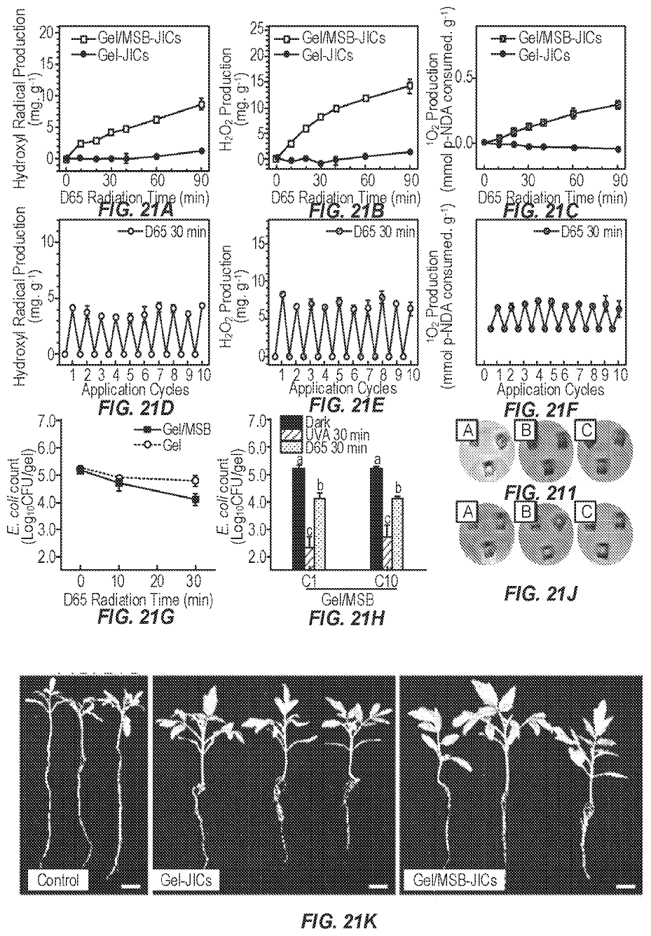

FIG. 21 shows microbial-resistant function and biodegradability of Gel/MSB-JICs. The detected generation of hydroxyl radical (A), hydrogen peroxide (H₂O₂) (B), and singlet oxygen (¹O₂) (C) of Gel/MSB-JICs and Gel-JICs at their first application cycle under D65 irradiation (300-830 nm). The production of hydroxyl radical (D), hydrogen peroxide (H₂O₂) (E), singlet oxygen (¹O₂) (F) of Gel/MSB-JICs in repeated application cycles (AFTC1 to AFTC10) under D65 irradiation (300-830 nm). (G) The antibacterial tests again E. coli under D65 irradiation (limit of detection at 2.00 Log₁₀ CFU·gel⁻¹). (H) The antimicrobial function of Gel/MSB-JICs against E. coli in the first (C1) and the 10^{th} application cycle (C10) under irradiation. The antimicrobial function of Gel/MSB-JICs against P. digitatum (I) and R. Laryngis. (J) in the first application cycle (C1, B) and the 10^{th} application cycle (C10, C). Gel-JICs were used as control groups in the anti-fungi and anti-yeast assays (A). (K) Representative photographs of tomato seedlings after 24 days of growing in soil potting mix (Control), with soil potting mix containing 5% Gel-JICs (Gel-JICs), and soil potting mix containing 5% Gel/MSB-JICs (Gel/MSB-JICs), with scale bars of 20 mm. Data are expressed as mean±SD of six replicates with a P-value ≤0.05.

The application environment of coolants could be rich with nutrients and oxygen for microorganisms' growth, especially with the nature of proteins in all JICs. Mold can proliferate in and on JICs during usage and storage, especially on the surface. Thus, a surface antimicrobial function is necessary for promising reusability of JICs. In this study, the photo-induced microbial-resistant functions of the Gel/MSB-JICs against microorganisms are expected, with the ability of MSB to generate ROS under exposure to daylight. (See, E. Cabiscol, J. Tamarit, J. Ros, Int Microbiol Official J Span Soc Microbiol 2000, 3, 3.0 According to Zhang et al., MSB could produce hydroxyl radicals and hydrogen peroxide (H₂O₂) through a type I reaction and singlet oxygen (¹O₂) through a type II reaction, both of which could occur in a water solution or aerobic environment under UVB (285-315 nm), UVA (315-400 nm), or D65 (300-830 nm) irradiation. (See, Z. Zhang, N. Wisuthiphaet, N. Nitin, L. Wang, R. Kawakita, T. Jeoh, G. Sun, ACS Sustain Chem Eng 2021. DOI: 10.1021/acssuschemeng.1c0269) Here, the three types of ROS species, hydroxyl radicals, hydrogen peroxide, and singlet oxygen generated under daylight exposure, were characterized in a similar manner presented by Si et al. and demonstrated in FIG. 21. (See, Y. Si, Z. Zhang, W. Wu, Q. Fu, K. Huang, N. Nitin, B. Ding, G. Sun, Sci Adv 2018, 4, eaar5931.) In this study, JICs in sizes of 10 mm×10 mm×10 mm were immersed in 20 mL of water or characterizing agents to detect the ROS generated on or migrated to the surface of JICs. Because of the relatively short lifetime of ROS, the long-distance migration from the core to the surface may not be likely. (See, M. Tim, J Photochem Photobiology B Biology 2015, 150, 2; J. R. Hurst, J. D. McDonald, G. B. Schuster, J Am Chem Soc 1982, 104, 2065; P. Attri, Y. H. Kim, D. H. Park, J. H. Park, Y. J. Hong, H. S. Uhm, K. N. Kim, A. Fridman, E. H. Choi, Sci Rep-uk 2015, 5, 9332.) Though a minor amount of MSB might migrate into water, according to the earlier discussions, H₂O is not a suitable hydrogen donor for generating hydroxyl radicals and hydrogen peroxide. (See, Z. Zhang, N. Wisuthiphaet, N. Nitin, L. Wang, R. Kawakita, T. Jeoh, G. Sun, ACS Sustain Chem Eng 2021. DOI: 10.1021/acssuschemeng.1c0269) Singlet oxygen is the only possible product generated by the MSB in water besides on the surface of JICs, while the amount can also be negligible because of the slow diffusion rate of MSB from Gel/MSB-JICs to water and the short diffusing time available before detection. Thus, we can conclude that most of the ROS that exert antimicrobial functions are those generated on the surface, which can be fully accounted for by the detection.

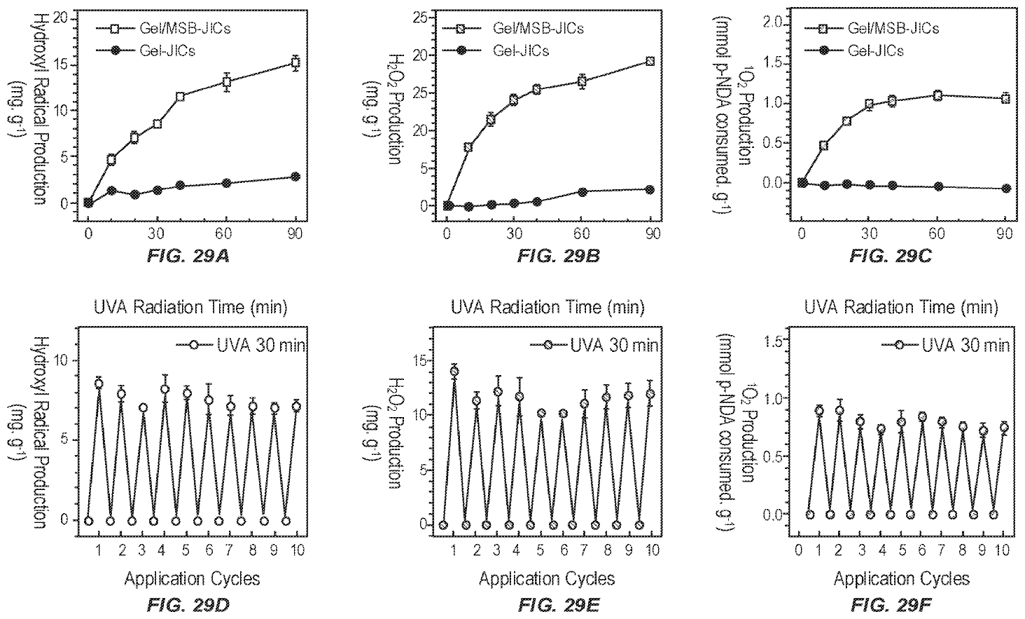

First, the generation of three ROS was detected under either UVA (365 nm) irradiation or D65 (300-830 nm) irradiation. From FIG. 29A-C, rapid generation of all three types of ROS in large quantities was observed on the Gel/MSB under UVA irradiation (365 nm), indicating the strong photo-activity of MSB on the Gel/MSB-JICs surface. Theoretically, the slope of ROS generation should be linear with irradiation time, assuming no MSB consumption. (See, Z. Zhang, N. Wisuthiphaet, N. Nitin, L. Wang, R. Kawakita, T. Jeoh, G. Sun, ACS Sustain Chem Eng 2021. DOI: 10.1021/acssuschemeng.1c0269). The detected decreasing generating rate of hydroxyl radical and singlet oxygen could be caused by the reduced amount of available p-NDA in the testing agent. Similar tests were conducted under the D65 (300-830 nm) irradiation. According to FIG. 23A and Zhang et al., UVA (365 nm) radiation is preferable for ROS generation by MSB, compared to daylight. However, considering the actual application, the D65 (300-830 nm) light source is closer to practice. (See, Z. Zhang, N. Wisuthiphaet, N. Nitin, L. Wang, R. Kawakita, T. Jeoh, G. Sun, ACS Sustain Chem Eng 2021. DOI: 10.1021/acssuschemeng.1c0269) As presented in FIG. 21(A-C), we can observe satisfactory ROS production under D65 (300-830 nm) irradiation.

Considering the reusability of JICs, cyclic tests on ROS production were also employed under both UVA and D65 irradiation. Each application cycle is simulated by immersing the Gel/MSB-JICs in excess water for 10 min to account for MSB leaving the Gel/MSB-JICs during the water rinsing step of an AFTC. FIG. 29D-F and FIG. 21D-F demonstrate that regardless of any variations in the production of the three types of ROS, the photo-activity of the Gel/MSB-JICs under both UVA and D65 irradiation was consistent across ten uses, with less than 20% of decay detected for all types of ROS. Consequently, the surface antimicrobial function should be consistent across the application cycles of Gel/MSB. Also, it should be noted that though an excessively high concentration of MSB may cause quenching concerns and lower the overall efficiency of ROS generation, enough MSB should be added at the beginning of the assembly for a promising and consistent microbial-resistant function through the lifetime of Gel/MSB.

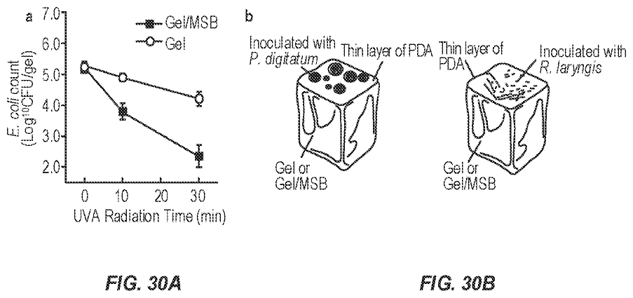

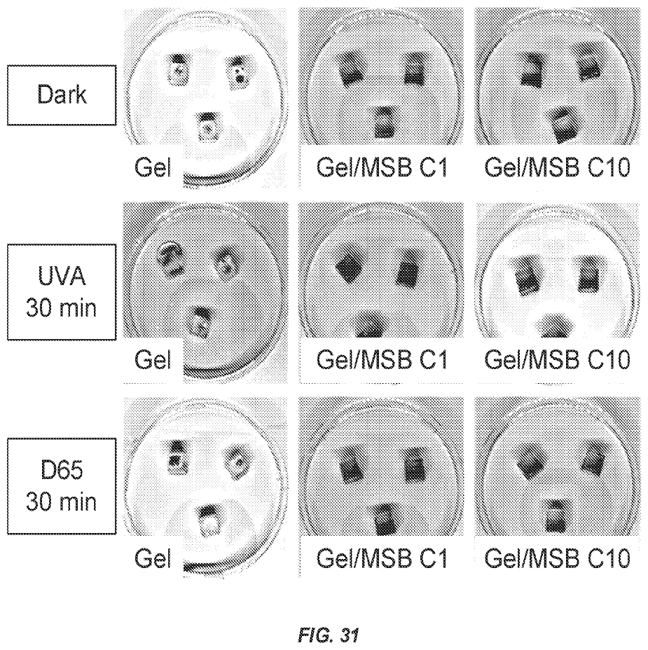

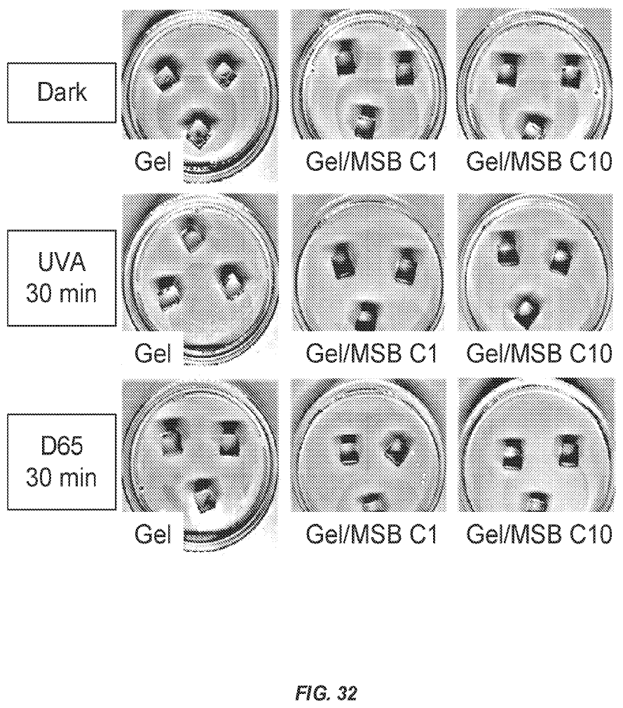

Three representative microbial organisms were selected to demonstrate the microbial-resistant performance of Gel/MSB-JICs: Escherichia co/i (generic E. coli LJH1247), a gram-negative bacterium; P. digitatum (P. digitatum isolate H3189), a commonly existing fungal pathogen; and Rhodotorula laryngis (R. laryngis 10-160), a yeast that survives the cold conditions on the continent of Antarctica. (See, J. I. Rovati, H. F. Pajot, L. Ruberto, W. M. Cormack, L. I. C. Figueroa, Yeast 2013, 30, 459.) These strains were selected because of their representation of prokaryotes and eukaryotes and microorganisms with a wide range of survival and growth temperatures (from below 0° C. to 37° C.). FIG. 30A and FIG. 21G show the photo-induced inactivation of E. coli LJH1247 by Gel-JICs and Gel/MSB-JICs under UVA (365 nm) or D65 (300-830 nm) photo-irradiation, respectively. For the Gel/MSB-JICs under UVA radiation, an average of 1.41 Log₁₀ CFU gel⁻¹ reduction was observed in 10 min, and 2.86 Log₁₀ CFU gel⁻¹ was observed in 30 min. Under D65 radiation, 0.48 Log₁₀ CFU gel⁻¹ reduction was observed after 10 min, and 1.10 Log₁₀ CFU·gel⁻¹ reduction was observed after 30 min. The bacterial reduction should have been caused mainly by the ROS generated by Gel/MSB-JICs under photo-irradiation rather than by the irradiation itself, compared to the result of Gel-JICs. ROS could inactivate microorganisms by oxidizing microbial cell walls, DNA, and biomolecules, including proteins and lipids. (See, E. Cabiscol, J. Tamarit, J. Ros, Int Microbiol Official J Span Soc Microbiol 2000, 3, 3; M. Tim, J Photochem Photobiology B Biology 2015, 150, 2.) The durability of the antibacterial performance of Gel/MSB-JICs was excellent after 10 cycles (C10), as shown in FIG. 21H. The antifungal and anti-yeast functions of the Gel/MSB-JICs are shown in FIG. 21I, J, FIG. 31I and FIG. 32. Since the development of fungi and yeast requires extra nutrients, a thin layer of potato dextrose agar (PDA) was supplemented on top of each JIC. The inoculated JICs were cultured in a dark box under ambient conditions with sufficient moisture for 18 days for P. digitatum H3189 and 10 days for R. laryngis 10-160. It should be noted that the JICs were still exposed to a small amount of daylight each day during observation and recording, which might lead to the generation of ROS and consequent antimicrobial effects over time. The ROS generated in an aerobic environment might also cause the oxidation of gelatin hydrogels, as visible color changes in Gel/MSB-JICs were observed after 10 or 18 days of preservation, as shown in FIG. 21I-J. The Gel/MSB-JICs showed apparent inhibition towards P. digitatum and R. laryngis with limited light exposure. The observed surface antimicrobial function of JICs with limited light exposure is favored for the longer lifetime of JICs, considering the dim light available in freezers or other shipping and storage conditions. Li et al. also reported antifungal properties of MSB in the dark, but the effect was determined by the developmental stage of the fungi and required high MSB concentrations. The optimum antifungal results of MSB against P. digitatum were observed when MSB was applied in combination with UVA or simulated sunlight exposure. (See, X. Li, L. Sheng, A. O. Sbodio, Z. Zhang, G. Sun, B. Blanco-Ulate, L. Wang, Food Control 2022, 135, 108807.)

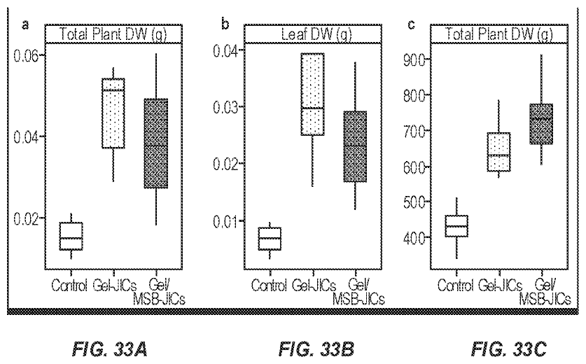

We established a plant growth experiment to test the compostability and impact of JICs when added to the potting soil. Tomato seedlings sown in soil with Gel-JICs and Gel/MSB-JICs presented significantly (P<0.05) higher values for several growth parameters when compared to control seedlings (FIG. 21K and FIG. 33). Plants grown in soils treated with Gel-JICs and Gel/MSB-JICs doubled the number of true leaves and had about six times more leaf area than the control. Leaf fresh and dry weights for both treatments were significantly greater than for the control, as well as for total fresh and dry weight (including leaves, stems, and roots). Plants grown in soil with gel-JICs or gel/MSB-JICs had a more robust root system, including multiple secondary roots and root hairs. These results proved the nitrogen-rich composition (Table S2) and full compostability of the protein-based JICs. Despite the crosslinking and antimicrobial function of the Gel/MSB-JICs, its biodegradability and compostability were not impacted; possibly due to the lack of light underground to activate the MSB activity or the high microbial load in the soil, which could outrange the upper limit of the MSB antimicrobial activity.

Method: Saturated Paste Extraction analyzed by ICP-
OES, NO₃—N by colormetric, Nitrogen by combustion

| | ppm in solution | | | | | | | |
|---|---|---|---|---|---|---|---|---|
| | ppm | ppm | ppm | ppm | ppm | ppm | ppm | ppm |
| Sample | Ca | K | Mg | P | Al | B | Cu | Fe |
| ID | Calcium | Potassium | Magnesium | Phosphorus | Aluminum | Boron | Copper | Iron |
| Soil | 173 | 100 | 55 | 26 | 0.8 | 0.1 | 0.2 | 1.2 |
| Control | | | | | | | | |
| Soil Gel | 161 | 101 | 52 | 24 | 0.4 | 0.1 | 0.2 | 0.9 |
| Soil | 191 | 99 | 60 | 22 | 0.2 | 0.1 | 0.3 | 0.4 |
| Gel/MSB | | | | | | | | |

ppm in solution

| | | | | ppm | ppm | |
|---|---|---|---|---|---|---|
| | ppm | ppm | ppm | SO₄—S | NO3—N | |
| Sample | Mn | Na | Zn | Sulfate- | Nitrate- | |
| ID | Manganese | Sodium | Zinc | Sulfur | Nitrogen | pH |
| Soil | 0.4 | 42 | 0.1 | 552 | 37.0 | 5.46 |
| Control | | | | | | |
| Soil Gel | 0.3 | 48 | 0.5 | 541 | 22.4 | 5.50 |
| Soil | 0.4 | 54 | 0.0 | 606 | 37.4 | 5.53 |
| Gel/MSB | | | | | | |

| | | | % | mmhos/cm | ppm |
|---|---|---|---|---|---|
| | % | % | OM | EC | SS |
| Sample | N | C | Organic | Electrical | Soluble |
| ID | Nitrogen | Carbon | Matter | Conductivity | Salts |
| Soil | 0.80 | 44.22 | 76.06 | 1.5 | 1042 |
| Control | | | | | |
| Soil Gel | 0.87 | 45.45 | 78.17 | 1.6 | 1085 |
| Soil | 0.92 | 47.06 | 80.94 | 1.7 | 1215 |
| Gel/MSB | | | | | |

With a long-enough time, both Gel and Gel/MSB can be naturally degraded, as shown in the soil test report. Besides, MSB was also reported to be functional in defending against pathogens on plants, explicitly protecting tomato leaves against fungi and enhancing plant immunity. (See, Y. S. Jo, H. B. Park, J. Y. Kim, S. M. Choi, D. S. Lee, D. H. Kim, Y. H. Lee, C. J. Park, Y. C. Jeun, J. K. Hong, Plant Pathology J 2021, 37, 204; A. A. Borges, A. Borges-Perez, M. Fernandez-Falcon, J Agr Food Chem 2003, 51, 5326).

### CONCLUSION

Here we developed and validated a novel type of robust, reusable, microbial-resistant, and compostable stationary cooling medium Gel/MSB-JICs. We conceptually proved the structural stabilizing effect of the chemical crosslinking and physical crosslinking and proposed the associated mechanisms. Future studies may be needed on hydrogel tuning strategies, further detailing the mechanisms and optimizing preparation conditions. We also demonstrated MSB as a novel biologically and environmentally friendly photo-crosslinking agent for gelatin hydrogels. MSB's photo-induced antimicrobial functions provided desired nonselective microbial inactivation with high stability and durability. Overall, the reinvention of a cooling medium replacing the regular ice and traditional PCMs can benefit the agriculture, food, pharmaceutical, and life sciences industries, as well as many other industries. Furthermore, the strategies to construct tunable hydrogels can be instructive for the future development of solvent-rich soft materials.

### EXPERIMENTAL SECTION

### Materials

Gelatin powder (Type A, 225 bloom food grade) was purchased from MP Biomedical, LLC (Solon, OH). Poly (vinyl alcohol) (PVA, Mn 85,000, hydrolyzed), menadione sodium bisulfite (MSB), L-histidine, sodium hydroxide, and ammonium molybdate (tetra-hydrate) were purchased from Sigma Aldrich (Milwaukee, WI). Potassium iodide was purchased from Fisher Scientific (Canada). Potassium hydrogen phthalate was purchased from Acros Organics (Carlsbad, CA). Flavin mononucleotide (riboflavin-5′-phosphate, dihydrate, FMN, electrophoresis grade) was purchased from Spectrum Chemical (Gardena, CA). Phosphate buffered saline (10×), Mini-PROTEAN TGX gels (4-15%), Precision Plus Protein Dual Xtra Standards, Laemmli sample buffer (2×), Tris/Glycine/SDS buffer (10×) and Coomassie G-250 stain were purchased from Bio-Rad Laboratories, Inc. (Hercules, CA). P-nitroso-N,N-dimethylaniline (p-NDA) were purchased from TCI America (Portland, OR). Potato dextrose agar (PDA), tryptic soy broth (TSB) and tryptic soy agar (TSA) were purchased from Becton, Dickinson and Company (Sparks, MD). Tomato (Solanum lycopersicum) cv. ‘Rutgers’ seeds and soil potting mix (Rei-earth and seedling mix, Sun Gro, Agawam, MA) was used for tomato cultivation. Milli-DI (Millipore Sigma, St. Louis, MO) water was used in the materials fabrication and tests.

### Preparation of Gel and Gel/MSB JICs and Freeze-Thaw Treatment

The detailed fabrication steps and freeze-thaw treatment for Gel and Gel/MSB are shown in FIG. 26. Two homogenous stock solutions, gelatin—water (30%) and MSB—water (75 mg·mL⁻¹), were prepared in advance. The hydrogel precursor solution for Gel was 10% gelatin, and the precursor solution for Gel/MSB was 10% gelatin mixed with 1% MSB, both of which were prepared by diluting and mixing the corresponding stock solutions at 40° C. The precursor solutions were distributed into the 10 mm×10 mm×10 mm cubic molds while warm, and both Gel and Gel/MSB were chilled at 4° C. overnight for gelation. The cubic gels were then removed from molds and treated with three fabrication freeze-thaw cycles (FFTCs). In each of the fabrication freeze-thaw cycles, JICs (both Gel and Gel/MSB) were first frozen at F_{f} (−196° C., in a liquid nitrogen bath) until the JIC temperatures were fully equilibrated at −196° C., then stored at −20° C. for 18 hours and thawed at T_{f} (4° C.) for 8 hours. After FFTCs, Gel and Gel/MSB were irradiated in a UVA crosslinking chamber (Spectrolinker XL-1000, Spectronics Corporation, Melville, NY) equipped with 5 UVA lamps (365 nm, 8 W, Spectronics Co., Melville, NY) on top of ice (to maintain the chamber temperature below 30° C.) with or without the protection of nitrogen gas for a specific amount of time. The distance between samples and the UVA lamps was 11 cm with a light intensity of 2,300 lux. The fabrication process of JICs was completed after the irradiation. JICs were either characterized directly or treated with application freeze-thaw cycles (AFTCs) and characterized. Each AFTC consisted of 18 hours of freezing at Fₐ (−20° C.), 6 hours of thawing at Tₐ (21° C.), and 10 min of immersion in Milli-DI water. All prepared samples were stored at 4° C. for preservation.

### Characterization of JICs

UV-Vis Absorbance. The UV-Vis absorbance curves of MSB solution and gelatin solution were obtained using a UV spectrophotometer (Evolution 600, Thermo) in the range of 200-600 nm. MSB (Sigma Aldrich, Milwaukee, WI) solutions at 40 ppm and 3000 ppm and gelatin (Type A, 225 bloom food grade, MP Biomedical, LLC, Solon, OH) solutions at 10 ppm were used for testing.

Computational Details. The MSB ion (net charge=−1) was analyzed in the computational analysis. Gelatin was analyzed with a representative tetrapeptide fragment of Proline (Pro)—Arginine (Arg)—Glycine (Gly)—Glutamic acid (Glu). Gelatin computational calculations were conducted using a Gaussian 09 ver. 08 computational software package. The optimization of excited-state MSB, representative ground-state gelatin polypeptide fragments, MSB radical, and various polypeptide radicals were performed using DFT-B3LYP/6-31G (+, d, p) level of theory in the polarizable continuum model of the integral equation formalism variant (IEFPCM) in an H₂O solvent system. Gibbs free energies of each component were computed by frequency calculations at the DFT-B3LYP/6-31G (+, d, p) level of theory in the IEFPCM-H₂O solvent system based on the optimized geometries. The changes in free energy (ΔG) of each reaction were calculated accordingly.

Sodium Dodecyl Sulfate-Polyacrylamide Gel Electrophoresis (SDS-PAGE). SDS-PAGE tests were performed in a similar manner as described in Zou et al. (See, J. Zou, N. Nguyen, M. Biers, G. Sun, ACS Sustain Chem Eng 2019, 7, 8117.) A 4%-15% Mini-PROTEAN TGX gel (Bio-Rad Laboratories, Inc., Hercules, CA) was used. Protein solutions were diluted to 0.1 μg·μL⁻¹ and mixed at a 1:1 ratio with Laemmli sample buffer (2×, Bio-Rad Laboratories, Inc., Hercules, CA), and heated for 8 min in a 90° C. water bath. In each well, 10 μL of prepared sample (protein content was 0.05 μg·μL⁻¹) were loaded. Precision Plus Protein Dual Xtra Standard (10 μL, Bio-Rad Laboratories, Inc., Hercules, CA) was loaded to the reference well. The gel was stained with Coomassie G-250 stain and destained overnight.

Viscosity Measurement. Viscosity tests were performed according to ASTM D446-12 in a similar manner described in Zou et al. (See, J. Zou, N. Nguyen, M. Biers, G. Sun, ACS Sustain Chem Eng 2019, 7, 8117; ASTM D446-12(2017), Standard Specifications and Operating Instructions for Glass Capillary Kinematic Viscometers.) A size-100 Kimax Cannon-Fenske Viscometer (Kimble, Rockwood, TN) was used in a 25° C. circulated water bath to test the time of sample or water used to pass the capillary tube. The relative viscosity of each sample was calculated according to equation (S1), where t is the time of sample solution passing the capillary tube in s, and t₀ is the time of Milli-DI water passing the capillary tube in unit of s.

$$Relative Viscosity = t / {t}_{0} \qquad Equation ( S1 )$$

Mechanical Tests. The static compression test was carried out using an Instron 5566 tester (Norwood, MA) with a 5 kN or ION static load cell, as described in the earlier studies. (See, J. Zou, L. Wang, G. Sun, ACS Sustain Chem Eng 2021, 9, 15365.) Specifically, sample sizes for the tests were 10 mm×10 mm×10 mm. The compressive rate was 1 mm·min⁻¹. Compressive strength at break and compressive modulus at break (CMB) were obtained. All the compressive tests were performed under 21° C. and 65% relative humidity with at least four replicates. The CMB is calculated according to as equation (S2), where CMB has a unit of kPa, σ is the compressive stress at break in kN, and ε is the compressive strain at break in m².

$$CMB = σ / ε \qquad Equation ( S2 )$$

Degree of Crosslinking. The degree of crosslinking was gravimetrically determined according to the methods proposed by Pulat et al. and equation (S3). Hydrogels were dried in a vacuum oven at 30° C. for 48 h (initial dried weight mₒ in mg) before immersion in water for 72 h extraction. (See, M. Pulat, G. O. Akalin, Artif Cells Nanomed Biotechnology 2012, 41, 145.) The extracted gels were dried again and tested for the final dried weight, m in mg.

$$Degree of Crosslinking = \frac{m}{{m}_{o}} \times 100 \% \qquad ( Equation S3 )$$

Latent Heat of Fusion. The latent heat of fusion of JICs was tested by a differential scanning calorimeter (DSC-60, Shimadzu Corporation, Pleasanton, CA) using a method described earlier. (See, J. Zou, L. Wang, G. Sun, ACS Sustain Chem Eng 2021, 9, 15357.) Supported by liquid nitrogen, the DSC tests were carried out in the temperature range of −20° C. to 10° C. with a 1° C. min⁻¹ heating rate under the protection of nitrogen flow. The latent heat of fusion of JICs at different application cycles was calculated via the integral of Heat (W·g⁻¹)—Time (s) curves at the solid-liquid phase transition peak of freezable water (near 0° C.). The values of the latent heat of fusion of JICs were reported with the integrated heat values normalized by the mass of JICs in J·g⁻¹.

Total water and freezable water content. The total water content of JICs at each application cycle was analyzed using thermal gravimetric analysis (TGA-50, Shimadzu Corporation, Pleasanton, CA). Detailed approaches in obtaining the total water and freezable water content were described in Zou et al. according to equation (S4) and equation (S5), where total water content and freezable water content are in %, w is the weight of JICs at 110° C. in g, w₀ is the initial weight of JICs under the ambient condition in g, and H is the fusion heat of JICs in J·g⁻¹. (See, J. Zou, L. Wang, G. Sun, ACS Sustain Chem Eng 2021, 9, 15365)

$$Total water content ( \% ) = \frac{{w}_{0} - w}{{w}_{0}} \times 100 \% \qquad Eq . ( 1 )$$

$$Freezable water content ( \% ) = ( \frac{H}{334.5} ) \div ( \frac{{w}_{0} - w}{{w}_{0}} ) \times 100 \% \qquad Eq . ( 2 )$$

Images Obtained by Using SEM and Dino-Lite Microscope. A Dino-Lite microscope (Dunwell Tech. Inc., Torrance, CA) was used to observe the morphology of the cross-sections of JICs. The internal fine structure of lyophilized JICs was observed using a Quattro environmental scanning electron microscope (ESEM, Thermo Fisher Scientific, USA). Before SEM imaging, JICs were carefully cut into small pieces with disposable scalpels, lyophilized using a Benchtop K lyophilizer (VirTis, Los Angeles, CA), and coated with a thin layer of gold.

Measurement of Hydroxyl Radicals. P-nitroso-N,N-dimethylaniline (p-NDA) was used to quantitively characterize the hydroxyl radical (OH) production on the surface of Gel/MSB as a selective radical scavenger towards OH. In this test, each cube (10 mm×10 mm×10 mm, around 1.0 g) of Gel/MSB was fully immersed in 20 mL p-NDA solution (10 mmol·L⁻¹) in 20 mL transparent glass vials. A UVA irradiation chamber (Spectrolinker XL-1000, Spectronics Corporation, Melville, NY) equipped with 5 UVA lamps (365 nm, 8 W, Spectronics Co., Melville, NY) and a daylight irradiation chamber (Spectrolinker XL-1500, Spectronics Co., Melville, NY) equipped with 6 D65 light tubes (300-830 nm, F15T8/D, 15 W, EiKO, Olathe, KS) were employed to provide UVA or D65 radiation. Glass vials with samples were placed on top of ice trays to maintain the inner temperature within each vial below 30° C. The distance between samples and lamps was 11 cm. The light intensity of photo-irradiation was 2,300 lux for UVA irradiation and 27,000 lux for D65 irradiation, which was tested using a lux meter (Dr. Meter, LX1330B). The amount of hydroxyl radical generated was calculated as twice of the consumed p-NDA (p_{H}, in mg·g⁻¹) using a standard curve. In this test, Gel was also tested in a similar manner to generate the reference curve.

Measurement of Hydrogen Peroxide. Hydrogen peroxide generation on the surface of JICs was characterized using an indirect quantification method, according to Si et al. (See, Y. Si, Z. Zhang, W. Wu, Q. Fu, K. Huang, N. Nitin, B. Ding, G. Sun, Sci Adv 2018, 4, 5931.) In a transparent glass vial, each cube (10 mm×10 mm×10 mm, around 1.0 g) of Gel/MSB was immersed in 10 mL of Milli-DI water and irradiated by either a UVA irradiation chamber or a daylight irradiation chamber on top of cooling ice. After irradiation, an aliquot of sample solution was vigorously mixed with reagent A and reagent B in a 1:1:1 ratio, forming the sample mixture. Here, reagent A was a homogenous mixture of potassium iodide (66 g·L⁻¹), sodium hydroxide (2 g·L⁻¹), and ammonium molybdate tetrahydrate (0.2 g·L⁻¹) in water, whereas reagent B was the solution of potassium hydrogen phthalate (20 g·L⁻¹). The UV absorbance of the sample mixtures was tested at 351 nm after maintenance in the dark for 5 min. The amount of generated H₂O₂ was calculated according to a standard curve.

Measurement of Singlet Oxygen. Singlet oxygen (¹O₂) production on the surface of Gel/MSB was characterized using a standard method. (See, T. Zoltan, F. Vargas, C. Izzo, Analytical Chemistry Insights 2007, 111; I. Karaljic, S. E. Mohsni, Photochemistry and Photobiology 1978, 557.) In each glass vial, one cube (10 mm×10 mm×10 mm, around 1.0 g) of Gel/MSB was fully immersed in 20 mL detecting solution consisting of p-NDA (10 mM) and L-Histidine (100 mM). The glass vials were radiated under either UVA or D65 light on top of the ice. The amounts of p-NDA consumed due to the generation of ¹O₂ (p₀, in mmol·g⁻¹) were calculated using equation S6, where p_{T} was the amount of total p-NDA consumed in mmol·g⁻¹, and p_{H} was the amount of p-NDA consumed due to the generation of hydroxyl radicals in mmol·g⁻¹.

$${p}_{0} = {p}_{T} - {p}_{H} \qquad Equation ( S6 )$$

Cooling Curves. The overall cooling efficiency of JICs was tested using a method described in Zou et al. (See, J. Zou, L. Wang, G. Sun, ACS Sustain Chem Eng 2021, 9, 15365.) PVA hydrogels (15%) photo-crosslinked by FMN (0.5%) in size of 30 mm×30 mm×20 mm were conditioned at 21° C. and used as cooled objects. Large JICs in the same sizes as cooled objects were prepared, conditioned at −20° C. and placed at the bottom of a temperature isolating device. A 4-channel hand-held data logger (Omega Engineering Inc., Stamford, CT) was attached to the top surface's central point of the cooled objects (PVA hydrogels) to record the temperature change across 60 min of cooling time.

Mass Transfer of MSB into Water and Gel. The mass transfer of MSB from Gel/MSB to water was tested by immersing 1 cube of Gel/MSB (10 mm×10 mm×10 mm, around 1.0 g) to 100 mL of Mill-DI water in an amber jar to avoid the impact of light. The amber jar was placed still in a 21° C. water bath to reduce the temperature disturbance across 12 hours. At each sampling time, 1 mL of solution was drawn after 20 s of mixing by a stir bar. The sampled solutions were tested by the UV spectrophotometer at 265 nm with or without additional dilution. The amount of MSB transferred into the water was calculated according a standard curve. The transferring of MSB from Gel/MSB to a water-rich solid substance was simulated by the MSB transferring from Gel/MSB to Gel (10% gelatin hydrogel). As shown in FIG. 20H, to simulate the occasions of cooling food by a coolant, a piece of Gel (representing food, 10 mm×10 mm×10 mm) was placed on top of a piece of Gel/MSB (10 mm×10 mm×10 mm) with good contact. The Gel-Gel/MSB stack was kept in a 20 mL amber vial to avoid external disturbance and water evaporation. After specific periods of time, Gel was picked out and washed in 50 mL of Milli-DI water for 48 h without shaking to avoid the collapse of Gel, while fully washing off the MSB transferred into Gel. The amount of MSB transferred from Gel/MSB to Gel was obtained by analyzing the washing solution of Gel in a manner similar to the study of Gel/MSB-water transfer.

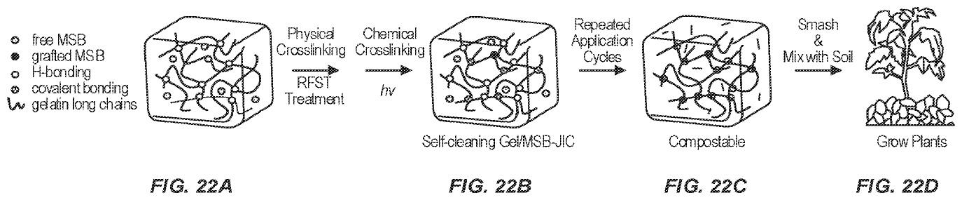

Antimicrobial Assays against E. coli, P. digitatum, and R. laryngis. To characterize the microbial-resistant function of JICs, a gram-negative bacterium (generic E. coli LJH1247), a species of fungi (P. digitatum isolate H3189), and a species of yeast (R. laryngis 10-160) were employed to represent the possible microbes existing in the service environment of JICs. In the antimicrobial tests against E. coli LJH1247, JICs (Gel/MSB or Gel) were inoculated by first immersing 1 cube (10 mm×10 mm×10 mm, around 1.0 g) of JIC into 10 mL of stock solution of E. coli (6.9 log CFU·mL⁻¹) for 1 min, draining the bacterial solution, and irradiating JICs under either UVA or D65 light, where JICs were placed in a Petri dish (without cover lid) on top of cooling ice to reduce the bacteria killed by heat. The surviving bacteria on the surface of JICs were recovered by rinsing JICs after irradiation with 10 mL of sterile Phosphate Buffered Saline (PBS) buffer and enumerated by plating onto plate count agar (method detection limit=2.0 log CFU gel¹). Since both P. digitatum H3189 and R. laryngis 10-160 require nutrients that neither Gel nor Gel/MSB contains, the photo-induced microbial-resistant function of Gel/MSB against both fungi and yeast was conducted by introducing an extra thin piece of potato dextrose agar (PDA) onto the surface of JICs, mimicking the extra nutrients JICs obtained from the complex service environment (sugar and essential minerals from fruits, vegetables, meat, or seafood), as shown in FIG. 22D. On top of the PDA, JICs were inoculated with 40 μL of either P. digitatum H3189 spore suspension (1×10⁶ spores·mL⁻¹) or R. laryngis 10-160 solution (1×10⁶ cell·m⁻¹). The inoculated JICs were cultured in mostly dark ambient conditions with a sufficient amount of moisture for 18 days for P. digitatum H3189 and 10 days for R. laryngis 10-160, respectively.

Soil Tests. The soil test was performed by the Soil Testing Laboratory at Auburn University (Auburn, AL). Potting soils (1) plain, (2) mixed with 5% Gel and (3) mixed with 5% Gel/MSB were prepared by fully mixing potting soil with or without the smashed JICs. Saturated paste extraction analysis of the potting soil was analyzed with ICP-OES, NO₃—N by colorimetric, nitrogen by combustion.

Tomato Cultivation. Tomato (Solanum lycopersicum) cv. ‘Rutgers’ seeds were placed on a filter paper in a Petri dish and wetted with sterile Milli-Q water. Then, seeds were placed in a germination chamber at 30° C. in darkness for five days. After the germination period, the tomato seedlings were sown in three soil mixtures: (1) Control: soil potting mix (Rei-earth and seedling mix, Sun Gro, Agawam, MA), (2) Soil+Gel-JICs: soil potting mix containing 5% Gel-JICs, and (3) Soil+Gel/MSB-JICs: soil potting mix containing 5% Gel/MSB-JICs. At least six tomato plants were sown in each soil mixture treatment. Plants were then grown at 20±2° C. and 60±10% relative humidity in a growth chamber with a 12 h photoperiod under a light intensity of 145 μmol m⁻²·s⁻¹. Plants were watered every three days with distilled water, and no fertilizers were applied. After 24 days, the tomato seedlings were harvested to analyze growth parameters. The total number of true leaves was counted. Fresh and dry weights for stems, leaves, and roots were measured separately using an analytical balance. Leaf area, root, and stem lengths were measured using the ImageJ software. (See, H. M. Easlon, A. J. Bloom, Appl Plant Sci 2014, 2, apps.1400033)

Statistical Methods. Statistical analyses were conducted using a one-way analysis of variance (ANOVA). All experiments were performed at least three times, and the results are presented as mean value±standard deviation.

Although the foregoing disclosure has been described in some detail by way of illustration and example for purpose of clarity of understanding, one of skill in the art will appreciate that certain changes and modifications within the spirit and scope of the disclosure may be practiced, e.g., within the scope of the appended claims. It should also be understood that aspects of the disclosure and portions of various recited embodiments and features can be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only and is not intended to limit the disclosure. In addition, each reference provided herein is incorporated by reference in its entirety for all purposes to the same extent as if each reference was individually incorporated by reference.

### REFERENCES

[1] Ndraha, N.; Hsiao, H. I.; Vlajic, J.; Yang, M. F.; Lin, H. T. V., Time-temperature abuse in the food cold chain: Review of issues, challenges, and recommendations. Food Control 2018, 89.
[2] Schirone, M.; Visciano, P.; Tofalo, R.; Suzzi, G. Editorial: Biological Hazards in Food. Front Microbiol 2017, 7, 2154.
[3] UCDA danger Zone: https://www.fsis.usda.gov/wps/portal/fsis/topics/food-safety-education/get-answers/food-safety-fact-sheets/safe-food-handling/danger-zone-40-f-140-f/CT_Index. Accessed March 2021.
[4] Adamashvili, N.; Chiara, F.; Fiore, M. Food Loss and Waste, a Global Responsibility?! Econ Agro-alimentare 2020, No. 3, 825-846.
[5] Wang, Y.; Yuan, Z. Enhancing Food Security and Environmental Sustainability: A Critical Review of Food Loss and Waste Management. Resour Environ Sustain 2021, 100023.
[6] Karunasagar, I.; Karunasagar, I. Challenges of Food Security—Need for Interdisciplinary Collaboration. Proc Food Sci 2016, 6, 31-33.
[7] Shafiee-Jood, M.; Cai, X. Reducing Food Loss and Waste to Enhance Food Security and Environmental Sustainability. Environ Sci Technol 2016, 50 (16), 8432-8443.
[8] Lin, T.; Wang, J. J.; Li, J. B.; Liao, C.; Pan, Y. J.; Zhao, and Y. Use of Acidic Electrolyzed Water Ice for Preserving the Quality of Shrimp. J Agric. Food Chem 2013, 36 (61), 8695-8702.
[9] Wang, J. J.; Lin, T.; Li, J. B.; Liao, C.; Pan, Y. J.; Zhao, Y. Effect of Acidic Electrolyzed Water Ice on Quality of Shrimp in Dark Condition. Food Control 2014, 35 (1), 207-212.
[10] Zhao, L.; Zhang, Z.; Wang, M.; Sun, J.; Li, H.; Malakar, P. K.; Liu, H.; Pan, Y.; Zhao, and Y. New Insights into the Changes of the Proteome and Microbiome of Shrimp (Litopenaeus Vannamei) Stored in Acidic Electrolyzed Water Ice. J. Agric. Food Chem. 2018, 19 (66), 4966-4976.
[11] Shin, J. H.; Chang, S.; Kang, D. H. Application of Antimicrobial Ice for Reduction of Foodborne Pathogens (Escherichia Coli O157:H7, Salmonella Typhimurium,
Listeria Monocytogenes) on the Surface of Fish. Journal of Applied Microbiology 2004, 97 (5), 916-922.
[12] Gun'ko, V. M.; Mikhalovsky, I. N. S. and S. V.; Mikhalovsky, S. V. Properties of Water Bound in Hydrogels. Gels 2017, 37 (3).
[13] Miller-Plathe, F. Different States of Water in Hydrogels? Macromolecules 1998, 31 (19), 6721-6723.
[14] Yoshida, H.; Hatakeyama, T.; Hatakeyama, H. Characterization of Water in Polysaccharide Hydrogels by DSC. Journal of Thermal Analysis 1992, 40, 483-489.
[15] Vlierberghe, S. V.; Dubruel, P.; Schacht, E. Biopolymer-Based Hydrogels As Scaffolds for Tissue Engineering Applications: A Review. Biomacromelecules 2011, 12, 1387-1408.
[16] Ahmed, E. M. Hydrogel: Preparation, Characterization, and Applications: A Review. J Adv Res 2015, 6 (2), 105-121.
[17] Rodriguez-Rodrigueza, R.; Espinosa-Andrewsb, H.; Velasquillo-Martinezc, C.; Garcia-Carvajal, Z. Y. Composite Hydrogels Based on Gelatin, Chitosan and Polyvinyl Alcohol to Biomedical Applications: A review. International Journal of Polymeric Materials and Polymeric Biomaterials 2020, 69, 1-20.
[18] Lozinsky, V. I.; Galaev, I. Yu.; Plieva, F. M.; Savina, I. N.; Jungvid, H.; Mattiasson, B. Polymeric Cryogels as Promising Materials of Biotechnological Interest. Trends 50 Biotechnol 2003, 21 (10), 445-451.
[19] Liu, Y.; Geever, L. M.; Kennedy, J. E.; Higginbotham, C. L.; Cahill, P. A.; McGuinness, G. B., Thermal behavior and mechanical properties of physically crosslinked PVA/Gelatin hydrogels. J Mech Behav Biomed Mater 2010, 3 (2), 203-9.
[20] Ricciardi, R.; Auriemma, F.; Gaillet, C.; De Rosa, C.; Laupretre, F., Investigation of the crystallinity of freeze/thaw poly(vinyl alcohol) hydrogels by different techniques. Macromolecules 2004, 37 (25), 9510-9516.
[21] Lozinsky, V. I.; Okay, O. Polymeric Cryogels. Springer 2014, 263, 49-101.
[22] Sriket, P.; Benjakul, S.; Visessanguan, W.; Kijroongrojana, K. Comparative Studies on the Effect of the Freeze-Thawing Process on the Physicochemical Properties and Microstructures of Black Tiger Shrimp (Penaeus Monodon) and White Shrimp (Penaeus Vannamei) Muscle. Food Chem 2007, 104 (1), 113-121.
[23] Su, G.; Ramaswamy, H. S.; Zhu, S.; Yu, Y.; Hu, F.; Xu, M. Thermal Characterization and Ice Crystal Analysis in Pressure Shift Freezing of Different Muscle (Shrimp and Porcine Liver) versus Conventional Freezing Method. Innov Food Sci Emerg 2014, 26, 40-50.
[24] Boonsumrej, S.; Chaiwanichsiri, S.; Tantratian, S.; Suzuki, T.; Takai, R. Effects of Freezing and Thawing on the Quality Changes of Tiger Shrimp (Penaeus Monodon) Frozen by Air-Blast and Cryogenic Freezing. J Food Eng 2007, 80 (1), 292-299.
[25] Apostolov, A. A.; Fakirov, S.; Vassileva, E.; Patil, R. D.; Mark, J. E. DSC and TGA Studies of the Behavior of Water in Native and Crosslinked Gelatin. Journal of Applied Polymer Science 1999, 71, 465-470.
[26] Morelle, X. P.; Illeperuma, W. R.; Tian, K.; Bai, R.; Suo, Z.; Vlassak, J. J. Highly Stretchable and Tough Hydrogels below Water Freezing Temperature. Adv Mater 2018, 30 (35), 1801541.
[27] Fu, M.; Liang, Y.; Lv, X.; Li, C.; Yang, Y. Y.; Yuan, P.; Ding, X. Recent Advances in Hydrogel-Based Anti-Infective Coatings. J Mater Sci Technol 2021, 85, 169-183.
[28] Adamashvili, N.; Chiara, F.; Fiore, M. Food Loss and Waste, a Global Responsibility?! Econ Agro-alimentare 2020, No. 3, 825-846.
[29] Boonsumrej, S.; Chaiwanichsiri, S.; Tantratian, S.; Suzuki, T.; Takai, R. Effects of Freezing and Thawing on the Quality Changes of Tiger Shrimp (Penaeus Monodon) Frozen by Air-Blast and Cryogenic Freezing. J Food Eng 2007, 80 (1), 292-299.
[30] Li, B.; Sun, D. W. Novel Methods for Rapid Freezing and Thawing of Foods—a Review. J Food Eng 2002, 54 (3), 175-182.
[31] Lin, T.; Wang, J. J.; Li, J. B.; Liao, C.; Pan, Y. J.; Zhao, and Y. Use of Acidic Electrolyzed Water Ice for Preserving the Quality of Shrimp. J. Agric. Food Chem 2013, 36 (61), 8695-8702.
[32] Lozinsky, V. I. Cryostructuring of Polymeric Systems. 55. Retrospective View on the More than 40 Years of Studies Performed in the A. N. Nesmeyanov Institute of Organoelement Compounds with Respect of the Cryostructuring Processes in Polymeric Systems. Gels 2020, 6 (3), 29.
[33] Lozinsky, V. I. Cryostructuring of Polymeric Systems. 50. Cryogels and Cryotropic Gel-Formation: Terms and Definitions. Gels (Basel, Switzerland) 2018, 4 (3), 77.
[34] Lozinsky, V. I.; Galaev, I. Yu.; Plieva, F. M.; Savina, I. N.; Jungvid, H.; Mattiasson, B. Polymeric Cryogels as Promising Materials of Biotechnological Interest. Trends Biotechnol 2003, 21 (10), 445-451.
[35] Ickes, L.; Welti, A.; Hoose, C.; Lohmann, U. Classical Nucleation Theory of Homogeneous Freezing of Water: Thermodynamic and Kinetic Parameters. Phys Chem Chem Phys 2014, 17 (8), 5514-5537.
[36] Polymeric Cryogels, Macroporous Gels with Remarkable Properties; Okay, O., Ed.; Springer, 2014.
[37] Tan, M.; Lin, Z.; Zu, Y.; Zhu, B.; Cheng, S. Effect of Multiple Freeze-Thaw Cycles on the Quality of Instant Sea Cucumber: Emphatically on Water Status of by LF-NMR and MRI. Food Res Int 2018, 109, 65-71.
[38] Karunasagar, I.; Karunasagar, I. Challenges of Food Security—Need for Interdisciplinary Collaboration. Proc Food Sci 2016, 6, 31-33.
[39] Li, D.; Zhu, Z.; Sun, D. W. Effects of Freezing on Cell Structure of Fresh Cellular Food Materials: A Review. Trends Food Sci Tech 2018, 75, 46-55.
[40] Ndraha, N.; Hsiao, H. I.; Vlajic, J.; Yang, M. F.; Lin, H. T. V., Time-temperature abuse in the food cold chain: Review of issues, challenges, and recommendations. Food Control 2018, 89.
[41] Petzold, G.; Aguilera, J. M. Ice Morphology: Fundamentals and Technological Applications in Foods. Food Biophys 2009, 4 (4), 378-396.
[42] Schirone, M.; Visciano, P.; Tofalo, R.; Suzzi, G. Editorial: Biological Hazards in Food. Front Microbiol 2017, 7, 2154.
[43] Shin, J. H.; Chang, S.; Kang, D. H. Application of Antimicrobial Ice for Reduction of Foodborne Pathogens (Escherichia Coli O157:H7, Salmonella Typhimurium, Listeria Monocytogenes) on the Surface of Fish. Journal of Applied Microbiology 2004, 97 (5), 916-922.
[44] Shafiee-Jood, M.; Cai, X. Reducing Food Loss and Waste to Enhance Food Security and Environmental Sustainability. Environ Sci Technol 2016, 50 (16), 8432-8443.
[45] Wang, J. J.; Lin, T.; Li, J. B.; Liao, C.; Pan, Y. J.; Zhao, Y. Effect of Acidic Electrolyzed Water Ice on Quality of Shrimp in Dark Condition. Food Control 2014, 35 (1), 207-212.
[46] Wang, Y.; Yuan, Z. Enhancing Food Security and Environmental Sustainability: A Critical Review of Food Loss and Waste Management. Resour Environ Sustain 2021, 100023.
[47] William, S., The science of freezing foods. USA: University of Minnesota Extension 2018. Available from: https://extension.umn.edu/preserving-and-preparing/science-freezing-foods, Accessed April 2021.
[48] UCDA danger Zone: https://www.fsis.usda.gov/wps/portal/fsis/topics/food-safety-education/get-answers/food-safety-fact-sheets/safe-food-handling/danger-zone-40-f-140-f/CT_Index. Accessed March 2021.
[49] Zhao, L.; Zhang, Z.; Wang, M.; Sun, J.; Li, H.; Malakar, P. K.; Liu, H.; Pan, Y.;
Zhao, and Y. New Insights into the Changes of the Proteome and Microbiome of Shrimp (Litopenaeus Vannamei) Stored in Acidic Electrolyzed Water Ice. J. Agric. Food Chem. 2018, 19 (66), 4966-4976.
[50] Zhang, M.; Li, F.; Diao, X.; Kong, B.; Xia, X. Moisture Migration, Microstructure Damage and Protein Structure Changes in Porcine Longissimus Muscle as Influenced by Multiple Freeze-Thaw Cycles. Meat Sci 2017, 133, 10-18.

It is to be understood that the above description is intended to be illustrative and not restrictive. Many embodiments will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references cited in this application, including patent applications, patents, and PCT publications, are incorporated herein by reference for all purposes.

1. A method for making a cross-linked jelly ice cube (JIC), the method comprising:
dissolving a biodegradable polymer in water to produce a homogenous solution;
injecting or pouring the homogenous solution into a mold to generate a shaped gel;
physically cross-linking the homogenous solution at a temperature between 0° C. to −200° C. in combination with either chemical or photo-induced cross-linking; and freezing the shaped gel to make a jelly ice cube (JIC).

2. The method of claim 1, wherein the biodegradable polymer is a plant-based biopolymer or animal-based biopolymer.

3. The method of claim 1, wherein the biopolymer is a member selected from the group consisting of collagen, gelatin, soy protein, whey protein, zein protein, elastin, laminin, fibrin, silk fibroin lysozyme, bovine serum albumin, ovalbumin, alginate, starch, cellulose, modified proteins, carbohydrates, and combinations thereof.

4. The method of claim 1, wherein the biopolymer is a protein.

5. The method of claim 3, wherein the biodegradable polymer is gelatin.

6. The method of claim 1, wherein the biodegradable polymer content of the JIC is between 1% to about 60% w/w.

7. The method of claim 1, wherein the biodegradable polymer content of the JIC is between 1% to about 20% w/w.

8. The method of claim 1, wherein the shaped gel undergoes freezing at a temperature between −200° C. to −5° C.

9. The method of claim 1, wherein the cross-linking occurs by a combination of chemical cross-linking, physical cross-linking, and photo induced cross-linking.

10. The method of claim 9, wherein the chemical cross-linking agent is a member selected from the group consisting of menadione sodium bisulfate (MSB), glutaraldehyde (GTA), 1-ethyl-3-(3-dimethylaminopropyl)carbodiimide (EDC), photosensitizers, water soluble vitamin, transglutaminase, genepin, sulfonates, malemide, polyethylene glycol dendrimeric systems, dendritic polymers, hyper-branched dendritic polymers, formaldehyde, enzymatic cross-linker, glycation, glyceraldehydes, cyanamide, diimide, diisocynate, dimethyl adipimidate, carbodiimide and N,N′-carbonyldiimidazole (CDI), N,N′-dicyclohexylcarbonylimide (DCC), N-ethoxycarbonyl-2-ethoxy-1,2-dihydroquinoline (EEDQ), 4-(4,6-dimethoxy-1,3,5-triazine)-4-methylmorpholium (DMT-MM), 2-benzotriazole-1,1,3,3-tetramethyluronium tetrafluoroborate (TBTU), 3,4-dihydro-3-hydroxy-4-oxo-1,2,3-benzotriazine (HODhbt), benzotriazol-1-oxy-tris-pyrrolidone-phosphonium hexafluorophosphate (PyBOP), benzotriazol-1-yl-oxy-tris-dimethylamino-phosphonium hexafluorophosphate (BOP), 1-ethyl-3-(3-dimethylaminopropyl) carbodiimide (EDC), and N-hydroxysuccinimide (NHS).

11. The method of claim 1, wherein the biodegradable polymer is cross-linked in two steps, which include a physically cross-linking and a photoinduced cross-linking.

12. The method of any one of claim 1, wherein the physically cross-linking is performed by one or more freeze-thaw cycles.

13. The method of claim 1, wherein the photoinduced cross-linking occurs by an ultra-violet (UV) radiation of thawed JIC.

14. The method of claim 13, wherein the photoinduced cross-linking occurs with UV light at 280-400 nm under an inert atmosphere.

15. The method of claim 1, wherein the cross-linking is performed while the biodegradable polymer is in a frozen state or a thawed state.

16. The method of claim 1, wherein the biodegradable polymer is dissolved in water at a temperature between about 10° C. to about 110° C.

17. The method of any one of claim 1, wherein the biodegradable polymer is dissolved in water at a temperature between 20° C. to about 70° C.

18. The jelly ice cube (JIC) made by the method of claim 1.

19. A jelly ice cube (JIC), the JIC comprising:
a cross-linked biodegradable polymer; and
wherein the compressive modulus at break (CMB) increases 1.5 to 10 times by crossing-linking the biodegradable polymer compared to the same JIC without cross-linking the biodegradable polymer.

20-31. (canceled)

32. A method for cooling an object using a jelly ice cube (JIC), the method comprising:
providing a chilled or frozen jelly ice cube (JIC), which JIC comprises a cross-linked biodegradable polymer, wherein the compressive modulus at break (CMB) increases 1.5 to 10 times by crossing-linking the biodegradable polymer compared to the same JIC without crosslinking the biodegradable polymer; and
contacting the object with the JIC.

37-42. (canceled)
